(19) United States
(12) Patent Application Publication
(10) Pub. No.: US 2004/0035910 A1
(43) Pub. Date: Feb. 26, 2004

(54) Low temperature fluxless brazing

(76) Inventors: Kostas F. Dockus, Cicero, IL (US); Brian E. Cheadle, Bramalea (CA); Robert H. Krueger, Spring Grove, IL (US); Feng Liang, Oakville (CA); Mark S. Kozdras, Fergus (CA)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 10/424,133

(22) Filed: Apr. 28, 2003

Related U.S. Application Data
(63) Continuation-in-part of application No. 09/990,507, filed on Nov. 21, 2001.
(63) Continuation-in-part of application No. 10/300,836, filed on Nov. 21, 2002.
(63) Continuation-in-part of application No. 10/300,837, filed on Nov. 21, 2002.

(51) Int. Cl. B23K 35/14

(52) U.S. Cl. 228/56.3

(57) ABSTRACT

A method of manufacturing an article of manufacture for use in a fluxless brazing process is disclosed. The method comprises the step of applying a braze-promoting layer including one or more metals selected from the group consisting of nickel, cobalt and iron, onto a bonding layer which comprises one or more metals selected from the group consisting of zinc, tin, lead, bismuth, nickel, antimony and thallium and which is disposed on a substrate including aluminum.

### CROSS-REFERENCE TO RELATED APPLICATION

This is a continuation-in-part of U.S. patent application Ser. No. 09/990,507, filed Nov. 21, 2001; Ser. No. 10/300,836, filed Nov. 21, 2002; and 10/300,837, filed Nov. 21, 2002, all applications are now pending, and all are incorporated herein by reference in their entireties.

### FIELD OF THE INVENTION

The present invention relates to improved methods and materials for fluxless brazing, including improved methods for substrate pre-treatment with special attention to application and use of bond promoting layers, improved methods for application and use of braze promoter, improved methods of application and use of braze modifiers, and improved methods for application and use of braze temperature modifiers. The invention further relates to articles of manufacture derived from the various processes, brazed products derived from the various processes and articles of manufacture, including the ability to join similar or dissimilar metals with the article of manufacture. The invention disclosed herein further relates to a methods of fluxless brazing of aluminum at low temperature (about 730-1130° F. or 388-610° C.), and to a family of brazing alloy compositions with suitably low melting temperature ranges. In particular, the present invention relates to methods and compositions which are particularly suited for use in the brazing of two or more aluminum parts together or in the joining of dissimilar metals or combinations thereof, using aluminum or zinc based filler metals.

### BACKGROUND OF THE INVENTION

Aluminum brazing is accomplished by heating with a torch or other localized heat source such, by salt dipping, or in a furnace. Furnace brazing can be performed in air using active salts such as zinc chloride, however preferred furnace brazing processes use protective atmospheres in combination with either fluxless braze promoters or non-corrosive fluxes. Various methods of brazing aluminum are known in the prior art. In the context of heat exchanger assemblies, which are characterized by thin aluminum components, brazing has heretofore commonly been effected in the prior art by furnace brazing, most commonly, by controlled atmosphere brazing (CAB) flux and vacuum brazing (VB). Sometimes furnace brazing is used to assemble one set of components then additional components are brazed afterwards using a second brazing operation that may use a localized heating method to avoid damage to the first brazed assembly. To facilitate brazing aluminum, filler metals are commercially available as (1) preforms of wire or shim stock, (2) a paste of flux and filler metal powder, or (3) a clad layer on brazing sheet composite.

Processes for brazing usually provide at least one mating surface having a specific bonding material, placing the mating surfaces in contact, and then applying a particular heating procedure to bring the assembly to a temperature range suitable to accomplish melting of the filler metals, and upon cooling, joining of the assembled components. Either a flux or a braze promoter is provided, typically in the filler metal, or applied to the filler metal surface, to permit disruption of surface oxides, and wetting of the members to be joined by the filler metal.

Various methods of bonding aluminum are known in the prior art. In the case of complex assemblies such as heat exchangers, where multiple, thin wall aluminum components are required to be sealingly joined with multiple braze bonds, furnace brazing processes have been most widely used. Because of the difficulty of post-braze removal of corrosive fluxes or salts, two general categories of furnace brazing have been most widely commercialized, ie, fluxless vacuum brazing (VB), and controlled atmosphere brazing (CAB) flux brazing.

In vacuum brazing, the parts to be brazed are provided with sufficient quantities of magnesium, normally present in the filler metal or in the aluminum or aluminum alloy components, such that, when brought to temperature in a brazing furnace under sufficient vacuum conditions, the magnesium becomes sufficiently volatile to disrupt the oxide layer present and permit the underlying aluminum alloy filler metal to flow together. While this technique provides for good brazing, it is essentially a discontinuous process, resultant from the need to apply a vacuum, and thus, is relatively expensive. It is also difficult to control, as it is very sensitive to oxidizing conditions in the furnace atmosphere, and demands that onerous standards of material cleanliness be maintained. Further, the evaporation of the magnesium leads to condensation in the brazing furnace, which requires frequent removal, thereby further adding to costs.

In controlled atmosphere brazing, the ability to braze does not result from mechanical disruption of the oxide but rather, from chemical modification of the oxide by a fluoride salt flux, typically potassium fluoraluminate, which is applied to the parts. As the name suggests, CAB brazing does not require that a vacuum be drawn, such that the process may readily be carried out on a continuous basis, most typically using an inert gas furnace. While this provides for some reduction in cost, this cost saving is partially offset by the necessity for integration of fluxing systems, many of which will suffer from variable flux loading. Moreover, after the flux has been applied, the flux can be susceptible to flaking, such that contamination of the article of manufacture can occur. The flux can also be difficult to apply, especially on internal joints and can cause problems in terms of furnace corrosion and cleanliness in the finished product. More importantly however, it has been found that the flux can lose activity when exposed to magnesium. Thus, this process is not suitable for brazing magnesium-enriched aluminum alloys. As magnesium is a commonly used alloying element in aluminum to improve, inter alia, strength, this reduces the attractiveness of CAB brazing.

Applications for brazing aluminum are not limited to heat exchangers, however heat exchangers require relatively complex assemblies of stacked plates or tubular members that require reliable, low cost joining of multiple joints. Some heat exchangers, for example oil coolers and air conditioning evaporators, require extensive internal joints that must be brazed, in concert with internal passageways that do not provide a source for particulate flux residues in the functional lubrication or refrigerant system. Recently, stacked assemblies of brazed metal plates are being considered as possible methods of assembly of fuel cell engines. Because of their structural similarity to plate-type heat exchangers, heat exchanger brazing technology is of significant interest. The joining of fuel cell plates requires reliable laminar type bonds (extended lap joints). However, fuel cell plates tend to be thin and have intricately formed, narrow fuel field channels which are easily clogged by flux or by excess filler metal flow. In addition, fuel cell systems can be particularly sensitive to ionic species contamination. Using prior art CAB processes, it has been difficult to satisfactorily braze fuel cell plates without internal flux contamination, and therefore CAB is unattractive, and the cost of vacuum brazing is prohibitive. As a consequence, fluxless brazing methods are of increased recent interest, for both heat exchanger and fuel cell engine applications.

A number of brazing processes disclosed in the prior art disclose utilize filler metal compositions based on aluminum, zinc and silicon. For example, U.S. Pat. No. 5,464,146 discloses the deposition of a thin film of aluminum eutectic forming material (Si, Al—Si or Al—Zn), by electron beam physical vapor deposition or conventional sputtering on at least one of the shapes to be brazed or joined. The assembly is then heated to a temperature between 1075 and 1105° F. in the presence of a suitable fluxing agent, to diffuse eutectic forming material into the aluminum and form a braze joint.

U.S. Pat. No. 5,072,789, describes an aluminum heat exchanger with an aluminum fin and tube joined primarily by a fillet of zinc prepared using a zinc chloride slurry or zinc wire sprayed coating, again in the presence of a suitable flux. U.S. Pat. No. 4,901,908 describes a process of forming a zinc or zinc-aluminum alloy on an aluminum surface by a spraying technique, which alloy has a melting point lower than that of the core. In U.S. Pat. No. 4,890,784, diffusion bonding of aluminum alloys is performed using a thin alloy interlayer of magnesium, copper or zinc placed between mating surfaces of the alloy members to be bonded.

U.S. Pat. No. 4,785,092 discloses an aluminum clad brazing material consisting of 4.5 to 13.5% Si, 0.005 to less than 0.1% Sr, and additionally one element from the group consisting of 0.3 to 3.0% magnesium, 2.3 to 4.7% copper, and 9.3 to 10.7% zinc with the balance being aluminum. This alloy is useful for brazing in vacuum or inert atmospheres from 1040 to 1112° F.

U.S. Pat. No. 3,703,763 describes forming a zinc bonding material using molten zinc to bond foamed aluminum with sheet aluminum.

In U.S. Pat. No. 5,422,191, an aluminum brazing alloy is described which can be used in either vacuum brazing or CAB brazing processes. The brazing alloy is clad with an aluminum alloy containing about 0.01 to 0.30% by weight lithium and 4 to 18% by weight silicon.

U.S. Pat. Nos. 5,232,788, and 5,100,048, describe an aluminum brazing method using silicon metal powder with a brazing flux such as potassium fluoroaluminate. The preferred metal component of the coating mixture is silicon, but other metals such as zinc, copper or nickel may be used.

A process for joining aluminum is described in U.S. Pat. No. 5,044,546 for putting zinc on aluminum using a zinc immersion bath followed by cadmium plating and then heating in a vacuum to form a braze joint.

Another vacuum brazing process is found in U.S. Pat. No. 5,069,980 using two clad alloys comprising silicon and a small amount of magnesium. Other elements in the cladding may be at least one of the following from a group consisting of Pb, Sn, Ni, Cu, Zn, Be, Li, and Ge.

Another method of joining aluminum members is described in U.S. Pat. No. 5,316,206 where aluminum is coated with zinc or a 5% aluminum-zinc alloy by dipping into the molten alloy bath. Following preassembly and applying a flux material, the aluminum members were heated to an elevated temperature in a furnace to form braze joints.

In a prior art method of fluxless aluminum brazing, the aluminum parts being joined required plating with a braze-promoting layer typically comprising nickel and/or cobalt. The braze-promoting layer was applied by a variety of methods, including plating in alkaline plating media, conventional electroless deposition from a hypophosphite solution. Alternatively, U.S. Pat. Nos. 3,970,237, 4,028,200, 3,553,825 and 3,482,305 describe plating baths for electroless and electrolytic plating of bond-promoting metals such as nickel, nickel-lead, cobalt, cobalt-lead or cobalt-nickel-lead onto aluminum alloy surfaces.

Presently there are several known fluxless brazing methods, as described in U.S. Pat. Nos. 3,332,517, 3,321,828 and many of the patents discussed above, which can be applied to brazing of aluminum alloys having a liquidus temperature somewhat above that of the presently available commercial Al—Si based filler metals (ie sufficiently above 1070 to 1175° F.). Unfortunately, many aluminum casting alloys including die castings, and some high strength heat treatable (2xxx or 7xxx) alloys have a liquidus and solidus temperature range below or very similar to those of the commercial brazing alloys, and therefore are not suitable for the present brazing processes. Also, as discussed, some of the prior art brazing methods are sensitive to Mg concentrations above threshold amounts, which may limit their applicability to brazing 5xxx or some 6xxx aluminum materials.

Therefore, there is a continued need for brazing processes and brazing products which are useful for brazing at low temperature in the absence of a flux.

An alternative method of brazing aluminum is described in U.S. Pat. No. 3,482,305. In this method, a braze-promoting metal of cobalt, iron, or, more preferably, nickel, is coated on a part to be brazed, in a manner more fully described in U.S. Pat. No. 4,028,200. If properly applied, the nickel reacts exothermically with the underlying aluminum-silicon alloy, thereby presumably disrupting the aluminum oxide layer, and permitting the underlying aluminum metal to flow together and join. Vacuum conditions are not required, such that this method overcomes the limitations of VB. Further, as this method does not require a CAB-type fluoride flux, it is suitable for utilization with magnesium-enriched aluminum alloys, such as are beneficially utilized in heat exchanger construction, and thus, overcomes the drawbacks of CAB. As additional benefits, this process has utility in association with a wide variety of aluminum alloys. However, the bath described in U.S. Pat. No. 4,028,200 provides for relatively slow plating; and has a relatively limited useful life, thereby resulting in significant cost.

Other mechanisms are known in the plating industry as being capable of providing a deposit of nickel upon aluminum. One very popular electroplating bath is the Watts bath, which is known to have some utility in plating decorative nickel on aluminum substrates, provided a surface pretreatment is first carried out. Preferably, a zincate layer is first applied, followed by a thin copper plate (eg. Rochelle-type copper cyanide strike solution) or a thin nickel plate (eg. Neutral nickel strike, nickel glycolate strike), followed by the Watts bath. However, these preplate steps add cost, and in the case of copper, have deleterious environmental aspects, resultant from the use of cyanide. Copper has a further disadvantage in that it can negatively affect the corrosion resistance of aluminum products. Although it is possible to plate nickel directly on the zincate layer, the Watts bath is difficult to control in these circumstances, such that satisfactory adhesion or coverage of nickel is not always obtained. Further, addition of lead to the Watts bath reduces its plating rate, yet further limiting the attractiveness of the Watts bath, given the known benefits associated with the inclusion of lead in the nickel deposit.

### SUMMARY OF THE INVENTION

According to one aspect, the invention comprises a method of manufacturing an article of manufacture for use in a fluxless brazing process, the method including the step of applying a braze-promoting layer or layers including one or more metals selected from the group consisting of nickel, cobalt and iron, onto a bonding layer which includes one or more metals selected from the group consisting of zinc, tin, lead, bismuth, nickel, antimony and thallium and which is disposed on a substrate comprising aluminum, the junction of the bonding layer and substrate defining a target surface of the substrate.

According to another aspect, the invention comprises a method of manufacturing an article of manufacture for use in an improved fluxless brazing process, the method including the step of plating a braze-promoting layer including one or more metals selected from the group consisting of nickel and cobalt, onto a substrate including aluminum, the junction of the braze-promoting layer and the substrate defining a target surface of the substrate, wherein the application of the braze-promoting layer and/or the bonding layer is preceded by or concurrent with mechanical abrasion of the substrate such that the target surface defines a plurality of reentrant edges.

According to a further aspect, the invention comprises a method of manufacturing an article of manufacture for use in a fluxless brazing process, the method including the step of electroplating a braze-promoting layer including one or more metals selected from the group consisting of nickel or cobalt, onto a substrate including aluminum, wherein the electroplating is carried out in an aqueous bath having a pH of from about 2 to 7 and including, in solution, said one or more metals.

According to a further aspect, the invention comprises a method of manufacturing an article of manufacture for use in a fluxless brazing process, the method including the step of electroplating a braze-promoting layer including one or more metals selected from the group consisting of nickel or cobalt, onto a substrate including aluminum, wherein the electroplating is carried out in an aqueous bath having a pH of from about 5 to 7 and including, in solution, said one or more metals.

According to a yet further aspect, the invention comprises a method of manufacturing an article of manufacture for use in a fluxless brazing process, the method including the step of plating a braze-promoting layer including nickel onto a substrate including aluminum, wherein the plating is carried out in an aqueous bath consisting of an aqueous solution of: from about 3 to about 20 weight percent of nickel sulfate; from about 3 to about 10 weight percent of nickel chloride; from about 6 to about 30 weight percent of a buffering salt selected from the group consisting of sodium citrate and sodium gluconate; from about 0.005 to about 1.0 weight percent of a lead salt selected from the group consisting of lead acetate and lead citrate;and ammonium, wherein the bath has a pH value in the range of about 3 to 12 and has a mole ratio of nickel:citrate:ammonium in solution of about 1:0.5 to 1.5:1 to 6.

According to yet another aspect, the invention comprises a method of manufacturing an article of manufacture for use in a fluxless brazing process, the method including the step of plating a braze-promoting layer including nickel onto a substrate including aluminum, wherein the electroplating is carried out in an aqueous bath consisting of an aqueous solution of nickel, citrate and ammonium, wherein the plating bath has a pH value in the range of about 2 to 12 and has a mole ratio of nickel:citrate:ammonium in solution of about 1:0.05 to 1.5:0.05 to 6.

According to yet another aspect, the invention comprises a method of manufacturing an article of manufacture for use in a fluxless brazing process, the method including the step of plating a braze-promoting layer including nickel onto a substrate including aluminum, wherein the electroplating is carried out in an aqueous bath consisting of an aqueous solution of nickel, citrate and ammonium, wherein the plating bath has a pH value in the range of about 5 to 12 and has a mole ratio of nickel:citrate:ammonium in solution of about 1:0.5 to 1.5: 1 to 6.

According to still yet another aspect, the invention comprises an article of manufacture for use in an improved fluxless brazing process, including a substrate including aluminum; a bonding layer on the substrate which comprises one or more metals selected from the group consisting of zinc, tin, lead, bismuth, nickel, antimony and thallium; and a braze-promoting layer on the bonding layer including one or more metals selected from the group consisting of nickel, cobalt and iron.

Other advantages, features and characteristics of the present invention, will become more apparent upon consideration of the following detailed description with reference to the accompanying drawings, the latter of which is briefly described hereinbelow.

A method of manufacturing a brazing sheet product, comprising the steps of: plating a layer comprising nickel onto a surface of a sheet comprising a core sheet and a clad layer on the core sheet, the clad layer being made of an aluminium alloy containing silicon in an amount in the range 2 to 18% by weight and said surface being a surface of the clad layer, and pretreating said surface before the plating step, wherein the pretreating comprises applying a bonding layer comprising zinc or tin on said surface.

A brazing sheet product comprising a core sheet (1), a clad layer (2) on said core sheet (1) made of an aluminium alloy containing silicon in an amount in the range 2 to 18% by weight, a layer (3) comprising nickel on the outer surface of said clad layer, and a layer (4) comprising zinc or tin as a bonding layer between said outer surface of said clad layer and said layer comprising nickel.

A method of manufacturing an assembly of brazed components, comprising the steps of: (a) forming said components of which at least one is made from brazing sheet product according to the invention; (b) assembling the components into the assembly; (c) brazing the assembly under a vacuum or in an inert atmosphere in the absence of a brazing-flux at elevated temperature for a period long enough for melting and spreading of the clad layer; (d) cooling the brazed assembly.

A method of manufacturing an Al or Al alloy workpiece comprising the steps of (a) providing an Al or Al alloy workpiece, (b) pre-treating the outersurface of the Al or Al alloy workpiece, and (c) plating a metal layer comprising nickel onto said outersurface of the Al or Al alloy workpiece, wherein during step (c) said metal layer comprising nickel is deposited by plating both nickel and bismuth using an aqueous bath having a pH in the range of 2.5 to 10, and comprising a nickel-ion concentration in a range of 10 to 100 g/l, a bismuth-ion concentration in the range of 0.01 to 10 g/l, a citrate-ion concentration in the range of 40 to 150 g/l, a gluconate-ion concentration in the range of 2 to 80 g/l, a chloride- or fluoride-ion concentration in the range of 1 to 50 g/l.

An aqueous bath for the electrodeposition of a layer of nickel and bismuth on an Al or Al alloy workpiece, having a pH in the range of 2.5 to 10, and comprising a nickel-ion concentration in a range of 10 to 100 g/l, a bismuth-ion concentration in the range of 0.01 to 10 g/l, a citrate-ion concentration in the range of 50 to 150 g/l, a gluconate-ion concentration in the range of 2 to 80 g/l, a chloride- or fluoride-ion concentration in the range of 1 to 50 g/l.

An assembly of components joined by brazing, at least one said components being an Al or Al alloy workpiece produced by the method in accordance with the invention.

Method of manufacturing an assembly of brazed components, comprising the steps of: (a) shaping parts of which at least one is made from an Al or Al alloy workpiece obtained by the method according to the invention; (b) assembling the parts into the assembly; (c) brazing the assembly in an inert atmosphere in the absence of a brazing-flux at elevated temperature for a period long enough for melting and spreading of the molten filler; (d) cooling the brazed assembly to below 100° C.

Brazing sheet product comprising: a core sheet (1) made of an aluminium alloy; an aluminium clad layer (2) cladding at least one of the surfaces of said core sheet; a layer (3) comprising nickel on the outersurface of one or both said aluminium clad layer or layers (2); and a layer (4) comprising zinc or tin as a bonding layer between said outersurface of said aluminium clad layer or layers and said layer (3) comprising nickel; wherein said aluminium clad layer (2) is made of an alloy which comprises, in weight percent:

Si 2 to 18

Mg up to 8.0

Zn up to 5.0

Cu up to 5.0

Mn up to 0.30

In up to 0.30

Fe up to 0.80

Sr up to 0.20

at least one element selected from the group consisting of:

Bi 0.01 to 1.0

Pb 0.01 to 1.0

Li 0.01 to 1.0

Sb 0.01 to 1.0

impurities each up to 0.05, total impurities up to 0.20, balance aluminium.

A method of manufacturing an assembly of brazed components, comprising the sequential process steps of: (a) forming said components of which at least one is made from brazing sheet product according to the invention; (b) assembling the components into an assembly; (c) brazing the assembly under a vacuum or in an inert atmosphere in the absence of a brazing-flux at elevated temperature for a period long enough for melting and spreading of the clad layer; and (d) cooling the brazed assembly.

A method of use of an aluminium clad alloy in a brazing sheet comprising: forming components of which at least one is made from brazing sheet product according to the invention into an assembly; and brazing the assembly.

A method of use of an aluminium clad alloy comprising forming an assembly from components of which at least one is made from brazing sheet product according to the invention; and brazing the assembly in an inert atmosphere in the absence of a brazing-flux material.

A brazing sheet product comprising: a core sheet (1) made of an aluminum alloy; an aluminum alloy clad layer (2) cladding on at least one of the surfaces of said core sheet; and a layer (3) comprising nickel on the outersurface of one or both said clad layer or layers (2); wherein the brazing sheet product is devoid of a layer comprising zinc or tin as a bonding layer between said outersurface of said aluminum alloy clad layer or layers (2) and said layer comprising nickel (3), and the aluminum clad alloy layer comprises, in weight percent:

Si 2 to 18

Mg up to 8.0

Zn up to 5.0

Cu up to 5.0

Mn up to 0.30

In up to 0.30

Fe up to 0.80

Sr up to 0.20

at least one element selected from the group consisting of:

Bi 0.01 to 1.0

Pb 0.01 to 1.0

Li 0.01 to 1.0

Sb 0.01 to 1.0

An assembly of components comprising at least one brazing sheet product according to the invention joined by brazing to another component.

A method of manufacturing an assembly of brazed components, comprising the sequential process steps of: (a) forming said components of which at least one is made from brazing sheet product according to the invention; (b) assembling the components into an assembly; (c) brazing the assembly under a vacuum or in an inert atmosphere in the absence of a brazing-flux at elevated temperature for a period long enough for melting and spreading of the clad layer; (d) cooling the brazed assembly.

A method of using an aluminum clad alloy in brazing sheet product according to the invention comprising brazing an assembly comprising said aluminum clad alloy.

A method of using an aluminum clad alloy according to the invention comprising brazing an assembly comprising said aluminum clad alloy in an inert atmosphere brazing process in the absence of a brazing-flux.

A method of manufacturing an assembly of components joined by brazing, comprising the steps of: (i) forming said components of which at least one is made from a multi-layered brazing sheet product, the multi-layered brazing sheet product comprising a core sheet (a) having on at least one surface of said core sheet (a) an aluminium clad layer (b), the aluminium clad layer (b) being made of an aluminium alloy comprising silicon in an amount in the range of 2 to 18% by weight, a layer (c) comprising nickel on an outer surface of said aluminium clad layer, and a layer (d) comprising zinc or tin as a bonding layer between said outer surface of said aluminium clad layer (b) and said layer (c) comprising nickel; (ii) forming at least one other component of a metal dissimilar to the core sheet of the multi-layered brazing sheet product and selected from the group consisting of titanium, plated titanium, coated titanium, bronze, brass, stainless steel, plated stainless steel, coated stainless steel, nickel, nickel alloy, low-carbon steel, plated low-carbon steel, coated low-carbon steel, high-strength steel, coated high-strength steel, and plated high-strength steel; (iii) assembling the respective components into an assembly such that the layer (c) comprising nickel of the multi-layered brazing sheet product faces in part or in whole the at least one other component of a metal dissimilar to the core sheet of the multi-layered brazing sheet product; (iv) brazing the assembly under a vacuum or in an inert atmosphere in the absence of a brazing-flux at elevated temperature for a period long enough for melting and spreading of the aluminium clad layer (b) and all layers exterior thereto; (v) cooling the brazed assembly.

Method of manufacturing an assembly of components joined by brazing, comprising the steps of: (i) forming said components of which at least one is made from a multi-layered brazing sheet product, the multi-layered brazing sheet product comprising a core sheet (a) having on at least one surface of said core sheet an aluminium clad layer (b), the aluminium clad layer being made of an aluminium alloy comprising silicon in an amount in the range of 2 to 18% by weight, and a layer (c) on the outer surface of said aluminium clad layer, the layer (c) comprising nickel and further at least bismuth in a range of at most 5% by weight; (ii) forming at least one other component of a metal dissimilar to the core sheet of the multi-layered brazing sheet product and selected from the group consisting of titanium, plated titanium, coated titanium, bronze, brass, stainless steel, plated stainless steel, coated stainless steel, nickel, nickel alloy, low-carbon steel, plated low-carbon steel, coated low-carbon steel, high-strength steel, coated high-strength steel, and plated high-strength steel; (iii) assembling the respective components into an assembly such that the layer (c) comprising nickel of the multi-layered brazing sheet faces in part or in whole the at least one other component of a metal dissimilar to the core sheet of the multi-layered brazing sheet product; (iv) brazing the assembly under a vacuum or in an inert atmosphere in the absence of a brazing-flux at elevated temperature for a period long enough for melting and spreading of the aluminium clad layer (b) and all layers exterior thereto; (v) cooling the brazed assembly.

A rigid composite metal panel comprising at least two parallel metal members, selected from the group consisting of metal plate and metal sheet, secured to the peaks and troughs of a corrugated aluminium stiffener sheet arranged between said parallel metal members, wherein the corrugated aluminium stiffener sheet is made from an aluminium brazing sheet product comprising a core sheet made of an aluminium alloy having on at least one surface of said core sheet clad an aluminium alloy clad layer, the aluminium alloy clad layer being made of an aluminium alloy comprising silicon in an amount in the range of 2 to 18% by weight, and a layer comprising nickel on an outer surface of said aluminium alloy clad layer.

A rigid metal composite panel comprising at least two parallel metal members, selected from the group consisting of metal plate and metal sheet, secured to aluminium stiffener sheet having a honeycomb structure arranged between said parallel metal members, wherein the aluminium stiffener sheet is made from an aluminium brazing sheet product comprising a core sheet made of an aluminium alloy having on at least one surface of said core sheet clad an aluminium alloy clad layer, the aluminium alloy clad layer being made of an aluminium alloy comprising silicon in an amount in the range of 2 to 18% by weight and a layer comprising nickel on an outer surface of said aluminium alloy clad layer.

A method of manufacturing a rigid composite metal panel, comprising the steps of: (a) providing parts, the parts comprising at least two parallel metal members selected from the group consisting of metal plate and metal sheet, and a corrugated aluminium stiffener sheet, wherein the corrugated aluminium stiffener sheet is made from an aluminium brazing sheet product comprising a core sheet made of an aluminium alloy having on at least one surface of said core sheet clad an aluminium alloy clad layer, the aluminium alloy clad layer being made of an aluminium alloy comprising silicon in an amount in the range of 2 to 18% by weight, and a layer comprising nickel on an outer surface of said aluminium alloy clad layer; (b) assembling the parts into an assembly such that the aluminium stiffener sheet is arranged between the parallel metal members; (c) joining the assembly into a rigid composite metal panel by heating the assembly under a vacuum or in an inert atmosphere in the absence of a brazing-flux material at elevated temperature of less than 600° C. for a period long enough for melting and spreading of the molten filler to form a joint between each parallel metal member and the corrugated aluminium stiffener sheet; (d) cooling of the joined composite metal panel.

A method of manufacturing a rigid composite metal panel, comprising the steps of: (a) providing parts, the parts comprising at least two parallel metal members selected from the group consisting of metal plate and metal sheet, and an aluminium stiffener sheet having a honeycomb structure arranged between said parallel metal members, wherein the aluminium stiffener sheet is made from an aluminium brazing sheet product comprising a core sheet made of an aluminium alloy having on at least one surface of said core sheet clad an aluminium alloy clad layer, the aluminium alloy clad layer being made of an aluminium alloy comprising silicon in an amount in the range of 2 to 18% by weight and a layer comprising nickel on an outer surface of said aluminium alloy clad layer; (b) assembling the parts into an assembly such that the aluminium stiffener sheet is arranged between the parallel metal members; (c) joining the assembly into a rigid composite metal panel by heating the assembly under a vacuum or in an inert atmosphere in the absence of a brazing-flux material at elevated temperature of less than 600° C. for a period long enough for melting and spreading of the molten filler to form a joint between each parallel metal member and the corrugated aluminium stiffener sheet; (d) cooling of the joined composite metal panel.

A method of manufacturing a rigid composite metal panel, comprising the steps of: (a) providing parts, the parts comprising at least two parallel metal members selected from the group consisting of metal plate and metal sheet, and a corrugated aluminium stiffener sheet, wherein the corrugated aluminium stiffener sheet is made from an aluminium brazing sheet product and said aluminium brazing sheet product comprises: a core sheet made of an aluminium alloy having on at least one surface of said core sheet clad an aluminium alloy clad layer, said aluminium alloy clad layer being made of an aluminium alloy comprising silicon in an amount in the range of 2 to 18% by weight, a layer comprising nickel on an outer surface of said aluminium alloy clad layer, and a separately deposited metal layer on one side of said layer comprising nickel, wherein said separately deposited metal layer comprises a metal such that taken together said aluminium alloy clad layer and all layers of the aluminium brazing sheet product exterior thereto form a metal filler having a liquidus temperature in the range of 490 to 570° C.; (b) assembling the parts into an assembly such that the aluminium stiffener sheet is arranged between the parallel metal members; (c) joining the assembly into a rigid composite metal panel by heating the assembly under a vacuum or in an inert atmosphere in the absence of a brazing-flux material at elevated temperature of less than 600° C. for a period long enough for melting and spreading of the molten filler to form a joint between each parallel metal member and the corrugated aluminium stiffener sheet; (d) cooling of the joined composite metal panel.

An aluminium brazing product comprising: a base substrate (1) of an aluminium alloy comprising silicon in an amount in the range of 2 to 18% by weight, a layer (2) comprising nickel on at least one outer surface of the base substrate (1), and a separately deposited layer (3) on one side of said layer (2) comprising nickel, said separately deposited layer (3) comprising a metal such that taken together said aluminium base substrate (1) and all layers of said aluminium brazing product exterior to said aluminium base substrate (1) form a metal filler having a liquidus temperature in the range of 490 to 570° C.

An aluminium brazing sheet comprising: said aluminium brazing product according to claim 1 and a core sheet (4) made of an aluminium alloy, wherein on at least one surface of said core sheet (4) is coupled the aluminium brazing product, said aluminium base substrate (1) being an aluminium clad layer, and said aluminium substrate (1) being made of said aluminium alloy comprising silicon in the amount in the range of 2 to 18% by weight, said layer (2) comprising nickel being on an outer surface of said aluminium clad layer, said clad layer (1) being between said core sheet (4) and said layer (2) comprising nickel, said separately deposited layer (3) being on one side of said layer (2) comprising nickel, and said separately deposited layer (3) comprising said metal such that taken together said aluminium clad layer (1) and all layers of the aluminium brazing product exterior to the aluminium clad layer (1) form a metal filler having a liquidus temperature in the range of 490 to 570° C.

A method of manufacturing the aluminium brazing product according to the invention, comprising depositing said layer (2) comprising nickel by electroplating both nickel and bismuth using an aqueous bath comprising a nickel-ion concentration in a range of 10 to 100 g/l and a bismuth-ion concentration in the range of 0.01 to 10 g/l.

A method of manufacturing an assembly of brazed components, comprising the steps of: (a) shaping parts of which at least one is made from said brazing sheet according to the invention; (b) assembling the parts into the assembly; (c) brazing the assembly under a vacuum or in an inert atmosphere in the absence of a brazing-flux at elevated temperature for a period long enough for melting and spreading of the molten filler; (d) cooling the brazed assembly.

A method of joining two structural elements comprising contacting the two structural elements, welding together the two structural elements in a welding operation to form a weld joint, and melting aluminium brazing product according to the invention in the form of an aluminium alloy wire or an aluminium alloy rod as filler metal at the weld joint during the welding operation.

In one aspect, the present invention provides a brazing product for low temperature, fluxless brazing, comprising: (a) a temperature modifier layer comprised of at least 50% of a metal selected from the group comprising zinc, aluminum and copper; and (b) a braze promoting layer comprising one or more metals selected from the group comprising nickel and cobalt; wherein, during brazing, the temperature modifier layer and the braze-promoting layer form a filler metal having a liquidus temperature in the range from about 730 to 1130° f.

In another aspect, the present invention provides a brazing product for low temperature, fluxless brazing, comprising: (a) a temperature modifier layer comprised of at least 50% of a metal selected from the group comprising zinc, aluminum and copper; and (b) a braze promoting layer comprising one or more metals selected from the group comprising nickel, cobalt and iron; wherein, during brazing, the temperature modifier layer and the braze-promoting layer and perhaps the substrate interact to form a filler.

### BRIEF DESCRIPTION OF THE DRAWINGS

FIG. 1 shows schematically a brazing sheet in accordance with the prior art;

FIG. 2 shows schematically a brazing product according to a first preferred embodiment of the present invention, including a core layer;

FIG. 3 shows schematically a brazing product in accordance with a second preferred embodiment of the present invention, not having a core layer;

FIG. 4 is an SEM image of the surface of a brazing sheet subsequent to brush cleaning and nickel plating;

FIG. 5 is a magnified view of FIG. 4;

FIG. 6 is an sem image of the surface of a brazing sheet subsequent to nickel plating in the absence of brush cleaning;

FIG. 7 is a brazing sheet according to an alternate preferred embodiment of the present invention;

FIG. 8 is an SEM image of the surface of a brazing sheet subsequent to nickel plating in the presence of brush cleaning;

FIG. 9 is a braze joint formed between an Ivadized steel fitting and nickel plated brazing sheet;

FIG. 10 is a braze joint formed between a roll bonded Feran sheet and nickel plated brazing sheet; and

FIG. 11 is a braze joint formed between nickel plated titanium mesh and nickel plated brazing sheet.

FIG. 12 is a schematic illustration of a preferred brazing preform according to the invention;

FIG. 13 is a schematic illustration of a preferred brazing sheet according to the invention in which a temperature modifier layer is applied by hot dipping, arc spraying, thermal spraying, low temperature kinetic energy metallization or HVLP (high velocity low pressure) coating methods;

FIG. 14 is a schematic illustration of a preferred brazing sheet according to the invention in which a temperature modifier layer is applied by roll bonding;

FIG. 15 is a schematic illustration of a preferred brazing sheet according to the invention in which a temperature modifier layer is applied by electroplating; and

FIG. 16 is a schematic illustration of a preferred brazing sheet according to the invention in which a temperature modifier layer is applied by CVD or PVD.

### DETAILED DESCRIPTION OF PREFERRED EMBODIMENTS

As indicated earlier, the invention comprises improved methods for bonding aluminum based upon the teachings set out in U.S. Pat. Nos. 3,970,237 and 4,028,200, wherein it is taught that nickel and aluminum undergo an exothermic reaction at brazing temperatures which permits brazing to occur. Cobalt and iron are also taught to be suitable substituents, in whole or in part, for nickel in this process, and that lead and/or bismuth are useful braze modifiers, also referred to as “wetting agents” or “surface tension modifiers” in the prior art.

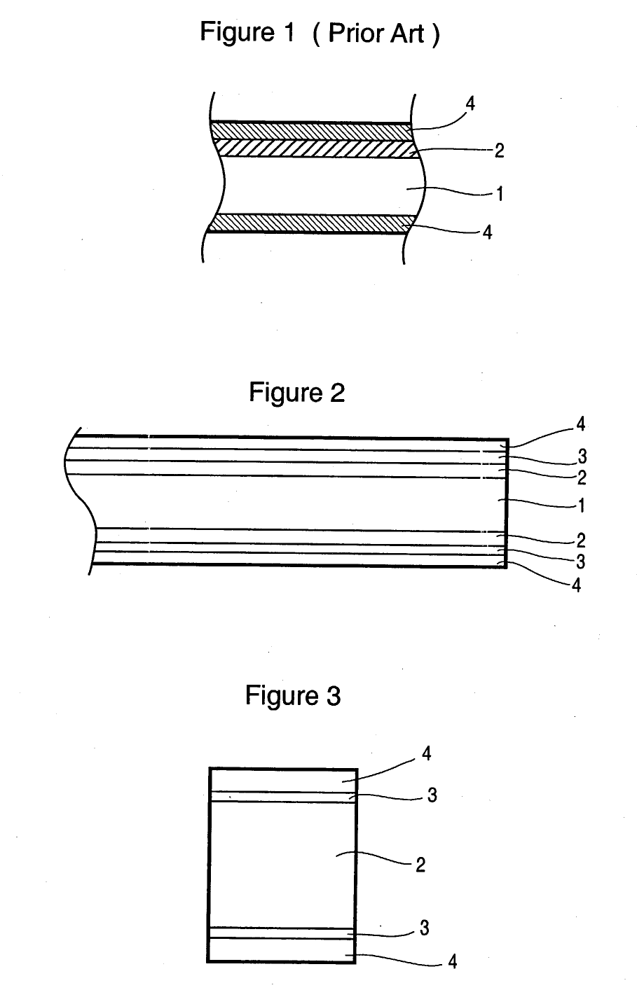

FIG. 1 schematically shows a brazing sheet in accordance with the prior art as would be obtained by the process disclosed in U.S. Pat. Nos. 3,970,237 and 4,028,200. The brazing sheet product consists of a core layer 1 clad on one or both sides with a cladding layer 2 comprising an aluminum-based brazing alloy. On top of the cladding layer 2 is applied a thin nickel-based braze-promoting layer 4, preferably a nickel-lead layer, by means of electroplating.

FIG. 2 schematically shows a brazing product in accordance with a first preferred embodiment of the present invention. The brazing product according to the first preferred embodiment comprises a core layer 1 clad on one or both sides with a cladding layer 2 comprised of an aluminum-based brazing alloy, with a nickel-based braze-promoting layer 4 being applied on top of the cladding layer 2. Between the cladding layer 2 and the braze-promoting layer 4 is applied a bonding layer 3 which forms an effective bond between the cladding layer 2 and the braze-promoting layer 4. Although FIG. 2 shows layers 2, 3 and 4 on both sides of the core layer 1, it will be immediately apparent to the skilled person that they may also be applied on only one side of the brazing product.

The brazing product shown in FIG. 2 is representative of various articles of manufacture. For example, the brazing product of FIG. 2 may preferably comprise a brazing sheet which can be formed into a useful shape and brazed with one or more objects comprised of similar or dissimilar metals. In the alternative, the brazing product may comprise a brazing preform which may be interposed between similar or dissimilar metal components for subsequent brazing, and which may be in the form of a wire, rod, sheet, or shim. For example, the preform may be interposed between aluminum parts formed of unclad aluminum, for subsequent brazing. When heated to a sufficiently high temperature for a sufficient period of time, the cladding layer 2, bonding layer 3 and braze-promoting layer 4 are melted to form a filler metal which forms the braze joint between the parts being joined by brazing.

FIG. 3 schematically shows a brazing product in accordance with a second preferred embodiment of the present invention in which the core layer 1 is omitted. In the embodiment of FIG. 3, a substrate comprised of an aluminum-based brazing alloy is interposed between bonding layers 3 and nickel-based braze-promoting layers 4. The brazing product according to the second preferred embodiment is particularly suitable for use as a brazing preform, and may be in the form of a wire, rod, sheet or shim.

The method according to the invention includes the step of conditioning the surface of an aluminum substrate so as to improve its ability to receive a braze-promoting layer of a metal such as nickel or cobalt, which metals are known to be difficult to plate directly on aluminum in a manner which preserves their ability to undergo exothermic reaction as discussed above.

Core Layer

As mentioned above, the aluminum substrate may include a core layer. The core layer has a melting point high enough that it does not melt during the brazing operation, and is preferably formed from aluminum or an aluminum alloy. In some preferred embodiments the core sheet also comprises magnesium to increase amongst others the strength of the core layer. The core may preferably contain magnesium in a range of up to about 8%, more preferably in a range of up to about 5.0 wt. %. The amount of magnesium in the alloy is highly variable, depending on the intended application of the brazing product, and may be at or below 0.05% for AA3003 alloy. In some applications, magnesium contents of about 0.5 to 5.0 wt. %, 0.2 to 5%, 0.5 to 2.5% or 0.2 to 2.0% may also be preferred.

Further alloying elements may be added to the core such as, but not limited to, Cu, Zn, Bi, V, Fe, Zr, Ag, Si, Ni, Co, Pb, Ti, Zr and Mn in suitable ranges. For example, the core may contain V in the range of 0.02 to 0.4% by weight to improve the corrosion resistance of the core alloy. Unless specifically indicated to the contrary, all percentages expressed herein are weight percentages.

Preferred aluminum alloys for use in the core layer are Aluminum Association AA3000-series alloys, with 3003 alloy and 3005 alloy being commonly employed as core materials in brazing products. The core materials of the brazing products according to the invention may also comprise other, less conventional, alloys such as Aluminum Association AA5000, AA6000 and AA7000-series alloys, depending on the application of the brazing product. For example, low-zinc content 7000-series braze sheets are used for high strength bracket applications.

Rather than being formed from aluminum or an aluminum alloy, the core may instead comprise titanium, titanium alloys, bronze, brass, copper, high strength steel, low carbon steel, stainless steel, nickel or nickel alloy steel. Some examples of stainless steels are as follows: stainless steel grades with 0.01 to 0.35% by weight of carbon and 11 to 27% by weight of Cr, as defined by the international standard steel numbers, like ferritic grades, for example ASTM 409, 410S, 430; martensitic grades, for example ASTM 420; duplex grades, for example ASTM 329, S31803; austenitic grades, for example ASTM 301, 304, 304L, 321, 316L; and heat and creep resisting grades, for example ASTM 309S, 304H. High strength steel typically has yield strengths in the range of 550 to 1100 MPa, tensile strength in the range of 585 to 1170 MPa, and an elongation in the range of 1 to 8. Among stainless steels, austenitic are preferred.

The core sheet has a thickness typically in a range of at most 5 mm, more preferably in the ranges of 0.1 to 2.5 mm, 0.1 to 2.0 mm or 0.2 to 2 mm.

Cladding Layer

The cladding forms part of the filler metal and therefore has a melting point below that of the core layer and the metal parts being joined by brazing. As mentioned above, the cladding layer preferably comprises an aluminum-based brazing alloy, and may preferably be applied to the core layer by roll bonding, cladding, Physical Vapor Deposition (PVD), Chemical Vapor Deposition (CVD), semi-continuous or continuous casting, spray forming or spray coating.

The aluminum-based brazing alloy of the cladding layer preferably comprises aluminum in combination with one or more alloying agents selected from the group comprising silicon, zinc, magnesium, and combinations thereof, such as aluminum-silicon, aluminum-silicon-magnesium, aluminum-silicon-zinc and aluminum-silicon-magnesium-zinc. The cladding may also include other alloying elements selected from the group comprising bismuth, lead, tin, nickel, beryllium, germanium, lithium, antimony, thallium, copper, manganese, indium, iron, zirconium, sodium, calcium and strontium. In one preferred embodiment of the invention, the cladding comprises an aluminum brazing alloy having the following composition (in weight percent):

Si: 2to 18

Mg: up to 8.0

Zn: up to 5.0

Cu: up to 5.0

Mn: up to 0.30

In: up to 0.30

Fe: up to 0.80

Sr: up to 0.20

At least one element selected from the group consisting of:

Bi: 0.01 to 1.0

Pb: 0.01 to 1.0

Li: 0.01 to 1.0

Sb: 0.01 to 1.0

Impurities each up to 0.05, total impurities up to 0.20, balance aluminum.

Typically, the magnesium level in the clad layer does not exceed 2.0 wt. %, and is preferably in the range of about 0.1 to 2.0 wt. % or about 0.2 to 2.0 wt. %, when magnesium is present essentially only as a braze modifier.

In one preferred embodiment, the bismuth content of the aluminum clad layer has an upper limit of 0.5%. A suitable lower limit for the bismuth content is 0.01% and more preferably 0.05%.

In another preferred embodiment, the lithium content of the aluminum clad layer has an upper limit of 0.5%. A suitable range for the lithium content is 0.01 to 0.3%, depending on the application method and the metallurgy of the cladding layer.

In another preferred embodiment, the antimony content of the aluminum clad layer has an upper limit of 0.5%. A suitable range for the antimony content is 0.01 to 0.3%.

In another preferred embodiment, the aluminum clad layer comprises SI in the range of 2 to 18%, and preferably 5 to 14% or 7 to 18%, and further comprises magnesium in the range of up to 8.0%, preferably up to 6% and more preferably up to 5.0%. Depending on the application, magnesium may be present in the range of 0.5 to 8.0%, 0.1 to 5%, 0.2 to 5%, 0.5 to 5%, 0.5 to 2.5% or 0.05 to 3%. Further alloying elements may be added such as, but not limited to, Cu, Zn and Sr in suitable ranges. For example, zinc may be added in an amount of up to 5%, or in the range from 0.5 to 3.0%.

In another preferred embodiment, the aluminum clad layer comprises SI in the range of 2 to 18%, and preferably 7 to 18%, and further comprises zinc in the range of up to 5%. Preferably the zinc is in the range of 0.5 to 3%. Further alloying elements may be added such as, but not limited to, Mg and Cu in suitable ranges.

In another preferred embodiment, the aluminum clad layer comprises Si in the range of 2 to 18%, and preferably 7 to 18%, and further comprises copper in the range of up to 5%. Preferably the copper is in the range of 3.2 to 4.5%. Further alloying elements may be added such as, but not limited to, Mg and Zn in suitable ranges.

In some preferred embodiments, the aluminum clad layer may contain indium in a range of up to 0.30% as an alloying element to reach a more electronegative corrosion potential of the aluminum clad alloy as compared to the aluminum core alloy. Indium has been found to be much more effective in reducing the corrosion potential of the alloy as compared to zinc additions.

In some preferred embodiments, the aluminum clad layer may contain manganese and/or zirconium as impurity elements in a range of up to 0.30%, preferably up to 0.10% and more preferably up to 0.05%. It may also be preferred in some embodiments of the invention to have up to 0.50% manganese in the cladding layer.

In some preferred embodiments, the aluminum clad layer may contain iron as an impurity element in a range of up to 0.8%, and preferably in a range of up to 0.4%.

In some preferred embodiments, the aluminum clad layer may contain strontium in a range of up to 0.20% in order to modify the silicon present in the clad layer during the solidification when casting the clad alloy. A more preferred maximum for the strontium addition is up to 0.05%.

As mentioned above; the aluminum clad layer preferably comprises at least one or more elements selected from the group consisting of bismuth, lead, lithium and antimony, each in a range of 0.01 to 1.0%, and the combination of two or more of these elements does preferably not exceed 1.0%, and that magnesium may be present in a range of up to 2.0%, for example in the ranges 0.1 to 2.0% or 0.2 to 2.0%. The combination of magnesium with one or more other elements from this group does preferably not exceed 2.5%. In another preferred embodiment, the clad layer comprises one or more elements selected from the group comprising bismuth, lead, lithium and antimony, each in a range of 0.01 to 1.0%, and the combination of these elements preferably does not exceed 2.5%.

While magnesium may be present in the aluminum clad layer in amounts up to 8.0%, preferred ranges have been set out above to enhance amongst others the mechanical properties of the aluminum clad layer. It has also been found that magnesium in a range of up to 2.0% may also act as a braze modifier, and may reduce or eliminate the need to incorporate a conventional braze modifier such as bismuth, lead, lithium and antimony in the clad layer. Preferably the magnesium level in the clad layer does not exceed 2.0% when it is present essentially as a braze modifier in combination with a lead-free braze-promoting layer.

In accordance with the invention, it has been found that the braze-promoting layer itself does not need to comprise lead as an alloying addition. Good results can also be obtained if one or more elements of the group Bi, Pb, Li, Sb and Mg are added in the given ranges to the aluminum clad layer itself. In particular, the inventors have found that there is some synergistic benefit of the combination of magnesium in the cladding, with a nickel, nickel-lead or nickel-bismuth braze-promoting layer. As an example, adding lead to the aluminum clad layer has the advantage that the composition of the plating bath becomes less complex, which is a major achievement in itself, whereas the alloying addition to the cladding is very simple when manufacturing the clad layer. As a result the electroplated nickel layer applied may essentially consist of nickel and unavoidable impurities. From an operational and environmental point of view, bismuth is preferred over lead as an alloying element in the aluminum clad layer.

For brazing applications, the most preferred aluminum alloys for use in the cladding layer are Aluminum Association AA4000-series alloys, with 4045 and 4047 being particularly preferred alloys. Other alloys such as AA3000, AA6000 and AA7000-series alloys, may be useful where it is desired to provide a cladding having other properties such as corrosion resistance.

The thickness of the clad layer preferably ranges from about 2 to about 20% of the total thickness of the brazing product, eg. a brazing sheet in accordance with FIG. 2, which typically has a thickness of about 0.5 mm. Thus, the total thickness of the clad layer preferably ranges from about 10 microns to about 100 microns, more typically in the range of 40 to 80 microns, for example about 50 microns. in the range of 40 to 80 microns, for example about 50 microns. Where the brazing product comprises a sheet or shim preform without a core layer, as in FIG. 3, it is preferably comprised of an AA4000-series alloy having a gauge in the range of up to about 3 mm, preferably in the range of about 0.4 to 2 mm.

The clad layer may preferably be coupled to the core via one or more intermediate layers (also referred to herein as “interlayers”), which may comprise aluminum or aluminum alloy, copper or copper alloy, zinc or zinc alloy.

Bonding Layer

The bonding layer also forms part of the filler metal, and forms an effective bond between the aluminum substrate and the braze-promoting layer comprising nickel, the bond remaining effective during subsequent deformation of the brazing sheet, for example by bending. The bonding layer may preferably be applied to the substrate by immersion plating, direct plating or by electroplating.

The bonding layer preferably comprises one or more metals selected from the group comprising zinc, tin, lead, bismuth, nickel, antimony, magnesium, lithium and thallium. It is believed that the bonding layer works in three ways. First, because the treatments used to apply the bonding layers, such as zincate and stannate treatments, are caustic and/or involve displacement, they “condition” the aluminum surface for brazing. That is, the zincate and stannate thin or re-structure the native aluminum oxide, to make it more amenable to brazing. This re-structured aluminum surface is then encapsulated with zinc (etc). Second, the bonding layer provides preferred nucleation sites for subsequent Ni deposition. Third, it resists the acidity of acidic Ni plating baths, thereby avoiding aluminum corrosion or contamination of the plated deposit, and to avoid poisoning or degrading the bath by dissolution effects.

The bonding layer may preferably be comprised of pure or substantially pure zinc, tin, lead or bismuth, or may be primarily zinc, tin, lead or bismuth (e.g. at least 50 weight %). Minor amounts of these or other elements may be present, as discussed in more detail below. Typically, such elements are present at less than 10%, more usually less than 5% by weight, and possibly less than 1%.

In some preferred embodiments, the bonding layer is comprised primarily of zinc or tin in combination with one or more additional elements selected from the group comprising bismuth, lead, lithium and antimony. The amount of the additional element or elements in total may be up to 50%, but preferably is less than 25%, e.g. In the range 1 to 25%.

As a practical matter, even impurity levels of elements such as lead and bismuth can be sufficient to have an positive effects on brazing, but the amounts of these elements are preferably controlled in continuous processes such that they are no longer considered impurities.

In one preferred embodiment, bismuth is present in a zinc or tin-based bonding layer in an amount of up to 10% to improve the wetting action during brazing.

The thickness of the bonding layer is preferably up to about 0.5 microns, more preferably up to about 0.3 microns, and most preferably in the range of 0.01 to 0.15 microns or 0.02 to 0.15 microns, with 0.03 microns being an example of a particularly preferred thickness.

As mentioned above, the bonding layer may be applied to the substrate by immersion plating. For example, where the bonding layer is zinc or tin-based, it is preferably applied by an immersion zincate or stannate treatment.

The zincate immersion bath may preferably comprise an alkaline solution comprising about 20 to 100 g/l zinc oxide and up to about 500 g/l sodium hydroxide. In some preferred embodiments, the amount of zinc oxide in the zincate bath may be in the range of about 40 to 50 g/l. In some preferred embodiments, the bath may contain about 400 to 500 g/l sodium hydroxide or about 60 to 250 g/l sodium hydroxide, with amounts of about 100 to 120 g/l being typical. A number of commercially available zincate baths can be used, for example Chemtec (tradename) 024202, also known as the Bondal process, and Chemtec (tradename) 24195, also known as a cyanide-free Bondal process.

Typical alkaline stannate solutions comprise 5 to 300 g/l sodium or potassium stannate and sodium hydroxide.

Preferably, the duration of the immersion plating treatment is in the range of about 1 to 300 seconds, more preferably about 10 to 60 seconds, and typically about 30 seconds. The temperature of the immersion plating bath is preferably in the range of from about 10 to 50° C., more preferably in the range of about 15 to 30° C. The immersion plating treatment is typically conducted at ambient temperature.

In one preferred embodiment of the invention, the application of the bonding layer is preceded by, or concurrent with, mechanical abrasion of the substrate, preferably, by brush cleaning the surface using commercially available flap brushes comprising nylon fibres impregnated with suitable ceramic particulates, or stainless steel brushes, such that the target surface defines a plurality of reentrant edges. It has been found by the inventors that brush cleaning the substrate significantly increases the rate of the immersion plating step.

The application of a bonding layer to the substrate is merely one of a number of “pretreatments” which can be used to promote adhesion of the braze-promoting layer and the underlying substrate. The adhesion of the braze-promoting layer to the aluminum substrate, for example the cladding of a brazing sheet product, may be improved by pre-treating the outer surface of the substrate on which the braze-promoting layer is being deposited. The pre-treatment preferably comprises a preliminary cleaning step during which the surface is made free from grease, oil, buffing compounds, rolling lubricants or slitting oils. This can be accomplished in many ways, for example by vapor degreasing, solvent washing, solvent emulsion cleaning, or by mild etching. Following, or instead of, the preliminary cleaning step, the surface of the substrate is pretreated by one or more of the following.

(a) acid desmutting in a solution comprising nitric acid (typically 25 to 50%), optionally in combination with a fluoride and/or chromic acid and/or sulfuric acid. Suitable sources for the fluoride can be, for example, hydrofluoric acid or ammonium bifluoride, see also e.g. “the surface treatment and finishing of aluminum and its alloys”, by s. Wernick et al., asm international, 5th edition, 1987, vol.1, pp.181 to 182.

(b) mechanical preparation such as polishing, abrasion, brushing or grit blasting. It is known, for example, to apply brushing while the surface is in contact with a lower alcohol, such as for example isopropanol, see e.g. Also U.S. Pat. No. 4,388,159.

(c) alkaline etching, see e.g. “the surface treatment and finishing of aluminum and its alloys”, by s. Wernick et al., asm international, 5th edition, 1987, vol.1, pp.191 to 203.

(d) aqueous detergent cleaning.

(e) anodic oxidation, see e.g. “the surface treatment and finishing of aluminum and its alloys”, by s. Wernick et al., asm international, 5th edition, 1987, vol.2, pp.1006 ff.

(f) electrograining or electrolytic cleaning.

(g) pre-treatments described for example in U.S. Pat. Nos. 4,741,811, 5,245,847 and 5,643,434.

(h) immersion processes such as the zincate and stannate immersion treatments described above. Also see “the surface treatment and finishing of aluminum and its alloys”, by s. Wernick et al., asm international, 5th edition, 1987, vol.2, chapter 14 and 15.

By the use of any of pretreatments (a) to (g) listed above, it may be possible to eliminate the bonding layer and directly apply the braze-promoting layer to the underlying substrate, usually an aluminum alloy brazing alloy.

Braze-Promoting Layer

The braze-promoting reacts or dissolves at brazing temperatures, and is incorporated in the filler metal together with the cladding layer and the optional bonding layer. In theory, the braze-promoting layer could be applied by electroplating, electroless plating, roll bonding, thermal spraying, plasma spraying, chemical vapor deposition (CVD), physical vapor deposition (PVD) or other techniques for depositing metal or metal alloys from a gas or vapour phase, although some of these methods would be impractical or difficult to control. Electroplating is the most preferred method for applying the braze-promoting layer according to the present invention.

The braze-promoting layer is comprised of one or more metals selected from the group comprising nickel, cobalt and iron. Preferably, the braze-promoting layer is nickel-based or cobalt-based. More preferably, the braze-promoting layer is nickel-based, and may preferably comprise pure nickel or nickel in combination with one or more alloying elements and/or impurities. Where the braze-promoting layer is nickel-based, it may preferably contain one or more alloying elements or impurities selected from the group comprising cobalt, iron, lead, bismuth, magnesium, lithium, antimony and thallium. Specific examples of nickel-based braze-promoting layers are nickel, nickel-bismuth, nickel-lead, nickel-cobalt, nickel-bismuth-cobalt, nickel-lead-cobalt, nickel-lead-bismuth, nickel-bismuth-antimony, etc.

In some preferred embodiment of a nickel-based braze-promoting layer, lead or bismuth is present in an amount of up to about 10%, preferably up to about 5%, and more preferably up to about 3%, although lower amounts and even trace amounts of these elements may also have a beneficial effect. For example, amounts of lead or bismuth as low as up to about 1.0%, about 0.01 to 1.0%, or about 0.01 to 0.05% may be beneficial.

Within the commercially available methods of applying braze-promoting layers, it may not be possible to directly apply reactive metals such as magnesium and lithium in unalloyed form in the braze-promoting layer, and it may be more practical to include them in one or more of the other layers making up the filler metal. However, it is preferred that they be present somewhere in the layers making up the filler metal so that they are available to assist in brazing. This being said, magnesium may preferably be present in the braze-promoting layer in an amount of from about 0.05 to 3.0%, and lithium may preferably be present in an amount of from about 0.01 to 0.5%.

In another preferred embodiment of a nickel-based braze-promoting layer, thallium is present in an amount of from 0.01 to 1.0%, although the use of thallium is preferably avoided due to its toxicity.

Where the clad layer comprises one or more wetting agents selected from the group comprising bismuth, lead, lithium, antimony or thallium in the amounts described above with reference to the clad layer, the incorporation of these elements into the braze-promoting layer can be partly or completely avoided. For example, where the cladding contains a wetting agent, bismuth and lead are either completely eliminated from the braze-promoting layer or their concentrations are reduced to no more than 0.01%, provided that the amounts of Bi and Pb are sufficiently controlled in practice to maintain consistent brazeability.

The thickness of the braze-promoting layer is preferably up to about 2.0 microns, more preferably up to about 1.0 microns, and even more preferably up to about 0.5 microns, and most preferably about 0.05 to 0.5 microns. A preferred minimum thickness of the braze-promoting layer is about 0.25 to 0.30 microns.

As mentioned above, the braze-promoting layer is preferably applied by electroplating. In one preferred embodiment of the invention, electroplating of the braze-promoting layer is conducted under the following conditions:

(a) electroplating bath temperature 20 to 70° C., preferably 20 to 30° C.;

(b) electroplating bath pH 4.0 to 12.0, more preferably pH 7.0 to 12.0, for example pH 10.0 to 12.0 and pH 10.5;

(c) current density of 0.1 to 15.0 A/dm², preferably 0.1 to 10.0 A/dm², and more preferably 0.5 to 4.0 A/dm²;

(d) plating time 1 to 300 s, preferably 30 to 120 s, for example 100 s;

(e) bath composition comprising nickel sulfate and/or nickel chloride, sodium citrate, lead acetate and ammonium hydroxide.

The preferred bath composition set out above preferably includes 0 to 300 g/l nickel sulfate, more preferably 3 to 200 g/l nickel sulfate, even more preferably about 50 g/l to 70 g/l nickel sulfate.

The preferred bath composition set out above preferably includes 0 to 225 g/l nickel chloride, more preferably 10 to 100 g/l nickel chloride, even more preferably about 50 g/l nickel chloride.

The preferred bath composition set out above preferably includes 50 to 300 g/l sodium citrate, more preferably 60 to 300 g/l sodium citrate, even more preferably about 100 g/l sodium citrate, although 30 g/l sodium citrate is preferred in some embodiments. Sodium gluconate may be used instead or in combination with the sodium citrate, preferably up to 300 g/l, more preferably 60 to 300 g/l, even more preferably about 150 g/l.

The preferred bath composition set out above preferably includes 5 to 325 ml/l ammonium hydroxide (calculated as 30% ammonium hydroxide solution), more preferably 5 to 150 ml/l ammonium hydroxide, even more preferably about 75 ml/l ammonium hydroxide.

Where the braze-promoting layer contains lead, the preferred bath composition set out above preferably includes 0.05 to 10.0 g/l lead acetate, preferably 1.0 g/l lead acetate. As an alternative for the lead acetate, lead citrate may be used in an amount of 0.05 to 5 g/l, or about 0.05 to 1%, more preferably about 1.0 g/l.

Where the braze-promoting layer contains bismuth, the preferred bath composition set out above preferably includes about 0.05 to 5 g/l bismuth lactate, more preferably about 1.0 g/l bismuth lactate.

Where the braze-promoting layer contains cobalt, for example where the braze-promoting layer comprises nickel-cobalt or nickel-lead-cobalt, the preferred bath composition set out above may further comprise cobalt chloride in the range of 10 to 100 g/l, preferably 50 g/l.

In another preferred embodiment of the invention, the braze-promoting layer is applied by electroplating in an electroplating bath having a pH of about 8.1; and a bath composition comprising about 70 g/l nickel sulfate, 30 g/l nickel chloride, 120 g/l sodium citrate, 20 g/l sodium acetate, 15 g/l ammonium sulfate, 1 g/l lead acetate, and 30 ml/l ammonium hydroxide (calculated as 30% ammonium hydroxide solution).

In another preferred embodiment of the invention, the braze-promoting layer is applied by electroplating in an electroplating bath having a pH about 7.8; and bath composition including about 70 g/l nickel sulfate, 30 g/l nickel chloride, 120 g/l sodium citrate, 20 g/l sodium acetate, 50 g/l ammonium chloride, 1 g/l lead acetate, and 30 ml/l ammonium hydroxide (calculated as 30% ammonium hydroxide solution).

In another preferred embodiment of the invention, the braze-promoting layer is applied by electroplating in an electroplating bath having a pH about 7.6; and bath composition including about 150 g/l nickel chloride, 200 g/l sodium citrate, 20 g/l ammonium chloride, 1 g/l lead acetate, and 30 ml/l sodium hydroxide (calculated as 25% sodium hydroxide solution), and optionally including about 66 g/l sodium gluconate.

In another preferred embodiment of the invention, the braze-promoting layer is applied by electroplating in an electroplating bath having a pH about 7.6; and bath composition including about 150 g/l nickel chloride, 200 g/l sodium citrate, 20 g/l ammonium chloride, 1 g/l lead acetate, and 30 ml/l sodium hydroxide (calculated as 25% sodium hydroxide solution).

In another preferred embodiment of the invention, the braze-promoting layer is applied by electroplating in an electroplating bath having a pH about 6.4; and (b) bath composition including about 155 g/l nickel chloride, 1 g/l lead acetate, 154 g/l edta and 93 ml/l ammonium hydroxide (calculated as 30% ammonium hydroxide solution).

In another preferrred embodiment of the invention, the braze-promoting layer is electroplated onto the substrate using a plating bath which is effective over a broad pH range of from about 3 to 12, more preferably from about 5 to 12, and which has the following composition:

(a) from about 3 to about 20% nickel sulfate;

(b) from about 3 to about 10% nickel chloride;

(c) from about 6 to about 30% of a buffering salt selected from the group comprising sodium citrate and sodium gluconate;

(d) from about 0.005 to about 1.0% of a lead salt selected from the group consisting of lead acetate and lead citrate; and

(e) ammonium, wherein the mole ratio of nickel:citrate:ammonium in the plating bath is about 1:0.5 to 1.5:1 to 6.

It will be appreciated that the lead salt may be eliminated or replaced by a suitable amount of a salt of another metal, such as bismuth, depending on the desired composition of the braze-promoting layer.

Alternatively, the braze-promoting layer is electroplated onto the substrate using an acidic plating solution. The following are preferred acidic plating conditions according to one embodiment of the invention:

(a) electroplating bath temperature 20 to 70° C., preferably 40 to 60° C. or ambient temperature;

(b) electroplating bath pH in the range of about 3 to 5, preferably about 4 to 5, more preferably about 4.8 to 5.2;

(c) current density of 0.1 to 10.0 A/dm², preferably 0.5 to 5.0 A/dm²;

(d) plating time 1 to 300 seconds, preferably 20 to 100 seconds;

(e) bath composition comprising nickel sulfate, nickel chloride and boric acid.

The preferred acidic bath composition set out above includes up to 400 g/l nickel sulfate, preferably up to 300 g/l nickel sulfate; more preferably 5 to 400 g/l nickel sulfate, even more preferably 240 to 300 g/l nickel sulfate, although amounts of about 70 g/l are suitable in some bath compositions.

The preferred acidic bath composition set out above includes 10 to 100 g/l nickel chloride, preferably 30 to 60 g/l nickel chloride, more preferably 40 to 60 g/l nickel chloride.

The preferred acidic bath composition set out above includes 5 to 100 g/l boric acid, preferably 25 to 40 g/l boric acid.

In another preferred embodiment of the invention, the braze-promoting layer is applied under acidic conditions as follows:

(a) electroplating bath temperature 25 to 30EC;

(b) electroplating bath pH in the range of 3.2 to 6.2, controlled with sulfuric, acetic or hydrochloric acid;

(c) current density of 50 mA/cm²;

(d) plating time 1 to 300 seconds; and

(e) bath composition including about 100 g/l nickel chloride, 5 to 150 g/l sodium citrate, 1 g/l lead acetate and 5 to 100 g/l ammonium chloride, and optionally comprising about 30 g/l boric acid.

Alternatively, following application of the bonding layer according to the method of the invention, the nickel-based braze-promoting layer may be applied by electroplating in an acid solution comprising an alkylsulfonic acid electrolyte, preferably methanesulfonic acid.

Alternatively, following application of the bonding layer according to the method of the invention, the nickel-based braze-promoting layer is applied by electroplating in a sulfamate solution or, for example, in a lead sulfamate solution where the braze-promoting layer contains lead. Typically the sulfamate solution comprises 50 to 500 g/l nickel sulfamate, 0.05 to 30 g/l lead sulfamate, 15 to 50 g/l boric acid, and optional wetting agents. Bath temperatures are in the range of 20 to 70° C.

Alternatively, following application of the bonding layer according to the method of the invention, the nickel-based braze-promoting layer is applied by electroplating in a fluoborate or, for example, in a lead fluoborate (Pb(BF₄)₂) solution where the braze-promoting layer contains lead. Typically nickel fluoborate is present in the range 50 to 500 g/l, optionally lead fluoborate in the range of 0.5 to 30.0 g/l, and further optionally fluoboric acid in the range 1 to 50 g/l, boric acid 15 to 50 g/l, and further optionally a wetting agent. Bath temperatures are in the range of 20 to 80° C., and preferably 40 to 70° C. An advantage is that this solution, like some others here described, does not require the use of ammonium hydroxide.

Alternatively, following the application of the bonding layer according to the method of the invention, a nickel-lead braze-promoting layer is applied by electroplating in a bath comprising 50 to 500 g/l nickel acetate, 0.05 to 30 g/l lead acetate, 15 to 50 g/l boric acid, up to 200 ml/l glycolic acid (70%), 20 to 100 g/l sodium acetate, and optionally wetting agents.

According to another preferred embodiment of the invention, a nickel-bismuth braze-promoting layer is applied under the following conditions:

(a) electroplating bath pH in the range of 2.5 to 10;

(b) electroplating bath nickel ion concentration in a range of 10 to 100 g/l, and preferably in a range of 20 to 70 g/l;

(c) electroplating bath bismuth ion concentration in the range of 0.01 to 10 g/l, and preferably in the range of 0.02 to 5 g/l;

(d) electroplating bath citrate ion concentration in the range of 40 to 150 g/l, and preferably in the range of 80 to 110 g/l;

(e) electroplating bath gluconate ion concentration in the range of 2 to 80 g/l, and preferably in the range of 4 to 50 g/l;

(f) electroplating bath chloride or fluoride ion concentration in the range of 1 to 50 g/l, and preferably in the range of 1 to 30 g/l.

The nickel ion concentration in the electroplating bath can be provided via the addition of nickel chloride, nickel fluoborate, nickel sulfamate, nickel acetate or nickel sulfate, with nickel sulfate (NiSO₄.6H₂O) being preferred. At a too high level of nickel salt in the aqueous bath there is the risk of the crystallization of the salt in the solution, which might damage a continuous process. At too low levels the resultant bath becomes uneconomical due to too long plating times and low current density.

The bismuth ion concentration in the electroplating bath can be provided in various ways, preferably via the addition of one or more compounds from the group comprising bismuth carbonate (Bi₂(CO₃)₃), bismuth oxide (Bi₂O₃), bismuth citrate (BiC₆H₅O₇) and bismuth chloride (BiCl₃). Optionally some sodium hydroxide may be added also to regulate the pH of the aqueous bath. By using bismuth carbonate or bismuth oxide in the presence of nickel a suitable plating bath has been obtained which is stable at a very wide pH range. At too high levels of bi ion concentration in the aqueous bath the resultant deposit has a undesired high bi concentration. Preferably the bi concentration in the resultant ni-bi layer on the brazing sheet product is not more than 5 percent by weight, and preferably not more than 3 percent by weight. At too low levels the resultant bath becomes uneconomical due to too long plating times and low current density.

In yet another preferred embodiment, the bath for electroplating the braze-promoting layer has the following composition:

(a) nickel sulfate in a range of 45 to 450 g/l, and preferably 90 to 315 g/l;

(b) chloride ion concentration in a range of 1 to 50 g/l, and preferably 1 to 30 g/l;

(c) sodium citrate in a range of 55 to 180 g/l, and preferably 110 to 150 g/l;

(d) sodium gluconate in range of 2 to 90 g/l, and preferably 5 to 55 g/l;

(e) ammonium sulfate in a range up to 270 g/l; and

(f) bismuth oxide in a range of 0.02 to 22 g/l, and preferably 0.05 to 11 g/l, or bismuth carbonate in a range of 0.03 to 29 g/l, and preferably 0.06 to 14 g/l.

The addition of an ion from the group comprising chloride and fluoride is required for inducing anode corrosion. A suitable source of chloride ion is nickel chloride (NiCl₂.6H₂O) in a range of up to 415 g/l, and preferably in a range up to 250 g/l.

(H⁺) or (OH⁻) can be added to regulate the pH in a range of 2.5 to 10. The use of ammonium hydroxide should preferably be avoided in view of the generation of ammonia fumes.

Optionally for reducing stress in the braze-promoting layer, an ammonium ion concentration in a range up to 40 g/l, and preferably in range of 1 to 25 g/l, or a triethanolamine ion concentration in a range of up to 40 g/l, or combinations thereof, or other equivalent components may be added to the electroplating bath. Any soluble ammonium salt can be used as a source of NH₄⁺.

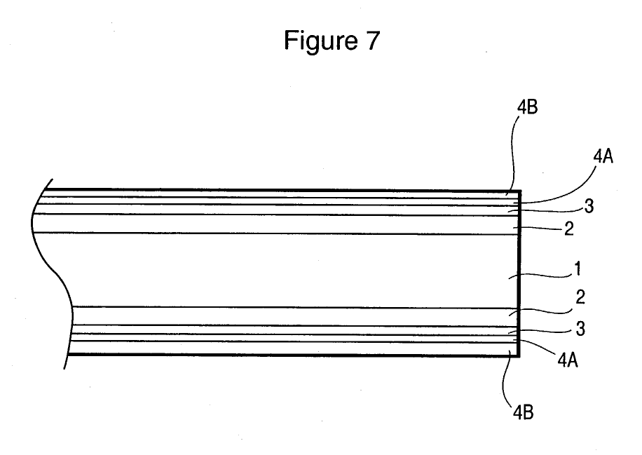

Another preferred brazing product according to the invention includes two successively applied nickel-containing layers, either on top of a bonding layer or directly onto the underlying substrate. As described in the previous examples, it is possible to utilize a bonding layer of lead or bismuth, and a braze-promoting layer of nickel. In this case, the bonding layer serves the dual purpose of facilitating adherence, and acting as a wetting agent. It is also possible to codeposit nickel and lead or bismuth as a bonding layer, and then follow that deposit by nickel, again, for similar purpose. A preferable variation, illustrated schematically in FIG. 7, involves the use of a zinc (or tin) bonding layer 3, followed by a duplex layer which comprises an inner layer 4a including nickel and lead or nickel and bismuth and an outer layer 4b including nickel. By this variation, the bonding layer provides a good surface for nucleation for the following layers; the inner layer provides a desirable wetting agent, with nickel; and the outer layer provides the desirable braze-promoting metal, nickel, which can be applied in a high build bath without the need to accomodate lead, which as previously discussed, can complicate bath chemistry. Indeed, the “inner” and “outer” layers may preferably be reversed, such that the wetting agent is coated last, for example to avoid the potential for cross-contamination.

Filler Metal

As mentioned above, the filler metal melts during the brazing operation and is comprised of the cladding, optional bonding layer, and the braze-promoting layer. A certain amount of alloying with the core material or with an interlayer can also be expected. Normally the interlayer and the core material are aluminum-based, and thus dilute the melt somewhat with aluminum.

The filler metal as a whole preferably contains one or more of the following elements in the following amounts:

Bi 0.01 to 0.5%, preferably 0.05 to 0.5%

Mg 0.05 to 3.0%, preferably 0.05 to 2.0% or 0.2 to 2.0%

Pb 0.01 to 1.0%

Li 0.01 to 0.5%

Sb 0.01 to 0.5%, preferably 0.05 to 0.5%

Th 0.01 to 1.0%

Zinc may also preferably be present in the filler metal.

Additional Layers

It will be appreciated that further metal layers may be provided on top of the braze-promoting layer to improve certain properties of the brazing product according to the invention, including corrosion characteristics. This is discussed in greater detail below in the context of low temperature brazing.

Formation of Brazed Assemblies

The present invention is also directed to assemblies of components joined by brazing, and to methods of manufacturing such assemblies, wherein at least one of the components comprises a brazing product according to the present invention. The brazing product may preferably comprise a brazing sheet, a brazing preform, or a brazeable object formed from a brazing sheet or a brazing preform according to the present invention. A preferred brazeable object may comprise a component of a heat exchanger or a fuel cell, for example a heat exchanger plate, and the brazed assembly may preferably comprise a heat exchanger or fuel cell.

Brazing sheets to be incorporated into an assembly according to the invention preferably have a structure as shown in FIG. 2. Brazeable objects may be formed from such brazing sheets, for example by bending, stamping or roll forming.

In the normal course, it will be most economical to coat the braze-promoting layer, and if necessary, the bonding layer, upon brazing sheet in a continuous process using brazing sheet in roll form. Alternatively, it is contemplated that one or more of such coating steps could follow after the brazing sheet has been formed into objects to be rendered brazeable. This might be useful, for example, in circumstances wherein drastic mechanical deformation of the brazing sheet was required to form a part, and it was critical that a braze joint could be produced at the exact point of deformation; in such circumstances, a risk of delamination or cracking of the plating so as to increase the risk of oxidation of the coatings at the deformation point may exist, and so as to avoid the need to stress the performance characteristics of the process to ensure good adhesion even through such drastic deformation, it might be more economical to simply carry out the coating steps thereafter. It is also conceivable that the coating step could follow forming in circumstances wherein the additional materials handling costs (ie of coating each individual part as compared to continuous roll coating) were outweighed by the cost savings to be gained through reductions in coating material utilization, for example, in circumstances wherein by virtue of the shape of the parts, a great amount of waste metal is produced during stamping (which waste metal would otherwise have needlessly been coated).

Brazing preforms to be incorporated into an assembly according to the invention preferably have the structure shown in FIG. 2 or 3, and may be in the form of a wire, rod, sheet or shim provided with an optional bonding layer and/or a braze-promoting layer.

In one preferred embodiment, the brazing product comprises a brazing sheet, and the method for manufacturing a brazed assembly according to the invention comprises the steps of:

(a) shaping or forming parts of which at least one is made from the brazing sheet product of the invention as set out above;

(b) assembling the parts into the assembly;

(c) brazing the assembly under a vacuum or in an inert atmosphere in the absence of a brazing flux at elevated temperature for a period long enough for melting and spreading of the clad layer and all layers exterior thereto;

(d) cooling the brazed assembly.

Preferably, the non-oxidizing atmosphere is comprised of an inert gas, and preferably dry nitrogen.

Preferably, the brazed assembly is cooled during step (e) to a temperature less than 100° C. The cooling rate may be in the range of typical brazing furnace cooling rates. A typical cooling rate is at least 10° C./min or more.

Depending on the material, and particularly the aluminum alloy present in the core sheet, the process may include the further processing step (e) of aging the brazed and cooled assembly in order to optimize its mechanical and corrosion properties. The cooling rate of the brazed product may need to be adjusted to enable aging, i.e. faster cooling rates, as defined by furnace design and process particulars, may be necessary. Alternatively, aging may be achieved naturally or by a heat treatment.

In another preferred embodiment, the brazing product comprises a brazing perform in the form of a wire, rod, sheet or shim which is interposed between parts for subsequent brazing.

In yet another preferred embodiment, the brazing product comprises a brazing perform in the form of a wire or rod which is used in a method of welding together two or more structural elements. A weld joint is formed between the structural elements by melting a brazing perform according to the invention so as to form a filler metal at the weld joint during the welding operation.

In yet another preferred embodiment, the invention provides a method of manufacturing an assembly of brazed components in which at least two components of the assembly are dissimilar to each other, one of the components being a brazing product according to the invention. For example, dissimilar metals which may be joined to a brazing product according to the invention include aluminized metals such as aluminized or aluminum-coated steel; titanium; titanium alloys; plated titanium; coated titanium such as nickel coated titanium; copper and copper alloys such as bronze and brass; steels such as stainless steel, plated stainless steel, coated stainless steel, low carbon steel, plated low carbon steel, coated low carbon steel, high strength steel, coated high strength steel, plated high strength steel; nickel, nickel alloy and nickel alloy steel. The plated titanium and steels listed above may preferably be plated by copper or, in the case of titanium, by nickel, nickel-lead, nickel-bismuth, etc.

Some examples of stainless steels are as follows: stainless steel grades with 0.01 to 0.35% by weight of carbon and 11 to 27% by weight of Cr, as defined by the international standard steel numbers, like ferritic grades, for example ASTM 409, 410S, 430; martensitic grades, for example ASTM 420; duplex grades, for example ASTM 329, S31803; austenitic grades, for example ASTM 301, 304, 304L, 321, 316L; and heat and creep resisting grades, for example ASTM 309S, 304H. High strength steel typically has yield strengths in the range of 550 to 1100 MPa, tensile strength in the range of 585 to 1170 MPa, and an elongation in the range of 1 to 8. Among stainless steels, austenitic are preferred.

In another preferred embodiment, the brazing product according to the invention may be brazed to a dissimilar aluminum alloy, including any of the alloys mentioned above. In particular, the brazing product according to the invention can be brazed to free-machining versions of 6061 alloy known as 6062 which has deliberate additions of both Pb and Bi in amounts of about 0.4 to 0.7% each.

In one preferred embodiment, the present invention provides a method of manufacturing an assembly of components joined by brazing, comprising the steps of:

(i) forming said components of which at least one is made from a multi-layered brazing sheet product, said multi-layered brazing sheet product comprising a core sheet (a) having on at least one surface of said core sheet an aluminum clad layer (b), the aluminum clad layer being made of an aluminum alloy comprising silicon in an amount in the range of 2 to 18% by weight, preferably in the range of 5 to 14% by weight, a layer (c) comprising nickel on the outer surface of said aluminum clad layer, and a layer (d) comprising zinc or tin as a bonding layer between said outer surface of said aluminum clad layer and said layer comprising nickel;

(ii) forming at least one other component of a metal dissimilar to the core sheet of the multi-layered brazing sheet product and selected from the group consisting of titanium, titanium alloy, plated titanium, coated titanium, bronze, brass, stainless steel, plated stainless steel, coated stainless steel, nickel, nickel alloy, low carbon steel, plated low carbon steel, coated low carbon steel, high strength steel, coated high strength steel, and plated high strength steel;

(iii) assembling the respective components into an assembly such that the layer (c) comprising nickel of the multi-layered brazing sheet product faces in part or in whole the at least one other component of a metal dissimilar to the core sheet of the multi-layered brazing sheet product;

(iv) brazing the assembly under a vacuum or preferably in an inert atmosphere in the absence of a brazing flux at elevated temperature for a period long enough for melting and spreading of the aluminum clad layer and all layers exterior thereto;

(v) cooling the brazed assembly. The cooling rate may be in the range of typical brazing furnace cooling rates. Typical cooling rates are cooling rates of at least 10° C./min or more, and preferably of 40° C./min or more.

The method allows for the design and manufacture of brazed assemblies in which, for example a component made of titanium or plated or coated titanium, e.g. copper-plated, nickel-plated, nickel-lead-plated or nickel-bismuth-plated titanium, is bonded by means of brazing to one side of the multi-layered brazing sheet component having on both sides a layer (d) comprising nickel, which layer may be kept essentially lead-free, and whereby on the other side of the multi-layered brazing sheet a component made of plated or coated stainless steel or aluminum is bonded by means of brazing. The bonding achieved by means of brazing is reliable and has sufficient strength.

The method also allows for the design and manufacture of brazed assemblies in which a brazing sheet or brazing perform according to the invention is used to braze aluminum to aluminum or any aluminized metal; nickel coated titanium or steel to aluminum or to any aluminized metal; or nickel coated titanium or steel to nickel coated titanium or steel, by interposing the brazing sheet or brazing perform between the dissimilar metals.

As mentioned above, the brazing sheet products according to the invention can be shaped into parts used for heat exchangers and fuel cells, for example, the brazing sheet according to the invention can be used to prepare or assemble complex structures such as cans, prismatic cans, container, cells, or other parts used for heat exchangers of fuel cells.

In another preferred embodiment of the invention, the brazing sheet according to the invention can be used to prepare a composite rigid metal panel comprising at least two parallel metal plates and/or sheets secured to a stiffening panel. Preferably, the stiffening panel is made from a brazing sheet product according to the invention, and the parallel metal plates or sheets may be the same or dissimilar from each other an/or the stiffener panel.

The stiffener panel may preferably have a corrugated or honeycomb structure. The corrugations in the panel can be formed by roll forming, for example. The corrugated sheet can have v-shaped peaks and troughs, modified v-shaped with flattened peaks and troughs, or the peaks and troughs may have a dovetail shape or a curved shape. The honeycomb structure is preferably formed from two or more corrugated stiffener panels with flat peaks and troughs whereby the peak of one sheet is brazed to the trough of an adjacent sheet. The honeycomb structure will preferably be brazed in the same brazing operation as that which bonds the stiffener panel to the parallel metal plates or sheets. Furthermore, the use of the brazing sheet according to the invention for the manufacture of composite metal panels allows for a honeycomb core having various numbers of various density honeycomb portions, due to variations in densities or other cell sizes.

One preferred rigid metal panel according to the invention comprises a corrugated brazing sheet according to the invention which has the form of a turbulator sheet such as those used in the manufacture of heat exchangers. A preferred distance between corrugations (peaks) is about 20 mm, and a preferred height of the corrugations is about 8.5 mm.

Another preferred rigid metal panel according to the invention comprises a corrugated brazing sheet according to the invention which comprises a formed sheet having a plurality of cup-like cavities, which cup-like cavities are aligned in essentially parallel rows and whereby in alternating parallel rows the openings of the cup-like cavities are facing opposite directions. The tip surfaces of the cup-like cavities form the peaks or alternatively the troughs of the corrugated stiffener sheet, and the tip surfaces are joined by brazing to the parallel metal plates or sheets. The tip surfaces may be flattened in order to increase the contact surface area with the parallel metal plates or sheets, and thereby increasing the strength of the joint after brazing. The cup-like cavities may have several forms, such as circular, cylindrical, spherical or cone-shaped. Corrugated stiffener sheet of this type allows for the design and manufacture of composite metal panels with improved stiffness in multiple directions. Corrugated stiffener sheets having this structure are known in the art and are applied as heat shields in cars and trucks. In one preferred embodiment, the distance between adjacent cup-like cavities in the same row is about 10 to 30 mm, and the depth of the cup-like cavities is about 25 mm.

Brazing Products for “Low Temperature” Brazing

In another preferred embodiment, the invention provides brazing products, i.e. Brazing sheets and brazing preforms, which have a liquidus temperature below 570° C. Brazing, by definition, employs filler metal having a liquidus temperature above 450° C. and below the solidus of the base metal. Therefore, the low temperature brazing products according to the invention have a liquidus temperature in the range from above about 450° C. to below about 570° C., more preferably from about 490 to 570° C., and even more preferably from about 510 to 550° C.

At these temperatures, it is possible to braze alloys which are difficult or impossible to braze at conventional brazing temperatures, for example AA5000-series aluminum alloys having a magnesium content of up to about 6%, such as AA5052, AA5056, AA5083 and AA5059. The brazing product according to this embodiment of the invention may be applied in both vacuum brazing and fluxless brazing under controlled atmosphere conditions, but fluxless CAB is preferred.

The low temperature brazing products according to the invention comprise a brazing product according to the invention having a nickel-based braze-promoting layer, and separately deposited on one side of the braze-promoting layer is a metal layer comprising a metal which provides the filler with a liquidus temperature of about 490 to 570° C., and preferably about 510 to 550° C.

The separately deposited metal may be applied on top of the braze-promoting layer or underneath the braze-promoting layer, between the braze-promoting layer and the bonding layer, or between the braze-promoting layer and the substrate where the brazing product does not include a bonding layer. Preferably, the separately deposited metal layer is applied on top of the braze-promoting layer.

In one preferred embodiment, the separately deposited metal layer comprises copper or a copper-based alloy, and more preferably the layer comprises at least 60% by weight copper. Suitable copper-based alloys are brass and bronze. Preferably, the separately deposited metal layer has a thickness of at most 10 microns, more preferably at most 7 microns, and even more preferably has a thickness of about 4 microns.

Copper has been found to significantly reduce the liquidus temperature of the resultant metal filler. However, further metal layers may be applied in addition to the copper or copper-based layer. Such further layers may preferably be comprised of zinc or tin.

The layer comprising copper or copper-based alloy is preferably deposited by electroplating, but could instead be deposited by other techniques such as thermal spraying, plasma spraying, CVD, PVD or other known techniques for depositing metals or metal alloys from a gas or vapor phase.

One preferred low temperature brazing product according to the invention is characterized in that the filler metal, comprising the cladding layer and all layers exterior thereto, has a composition comprising at least, by weight percent:

(a) si in the range of 5 to 10%, preferably 7 to 10%;

(b) Cu in the range of 12 to 25%, preferably 12 to 18%;

(c) Bi in the range of at most 0.25%, preferably 0.02 to 0.25%;

(d) Ni in the range of 0.05 to 4%, preferably 0.05 to 3.0%;

(e) Zn in the range of at most 20%, preferably at most 10%, more preferably at most 0.25%, even more preferably at most 0.15%;

(f) Sn in the range of at most 5%; and

(g) Mg in the range of at most 5%;

the balance comprising aluminum and impurities.

A typical impurity element is iron present in the aluminum clad layer, which may be present in a range of up to about 0.8%. Other alloying elements or impurities may also be present in the filler metal, typically including the elements listed above which may be included as alloying elements or impurities in the cladding layer.

The filler metal composition described above has a liquidus temperature in the range of about 510 to 550° C.

A separately deposited metal layer comprising copper or copper alloy may preferably be deposited by electroplating the copper or copper alloy using an aqueous alkaline copper cyanide-based plating bath, which is operational in a wide pH range, and can be used on industrial scale plating lines using a high current density. The following is a preferred alkaline copper cyanide-based plating bath composition:

(a) copper phosphate in a range of 5 to 200 g/l, and preferably 20 to 150 g/l, with copper pyrophosphate being a preferred salt;

(b) potassium pyrophosphate in a range of 50 to 700 g/l, and preferably 150 to 400 g/l;

(c) optionally, citric acid in a range of 2 to 50 g/l, and preferably 4 to 25 g/l; and

(d) optionally (OH⁻) can be added to regulate the pH in a range of 7 to 11.

The plating bath temperature is preferably in the range of about 30 to 70° C., and more preferably in the range of about 40 to 65° C. In this temperature range the ion mobility increases and there is no need to cool the plating bath to compensate for the heat generation during plating.

The following is another preferred alkaline cyanide plating bath composition according to the invention:

(a) about 110 g/l copper (I) cyanide;

(b) about 140 g/l sodium cyanide; and

(c) about 90 g/l sodium carbonate;

at a current density of about 3 A/dm² and a temperature of about 50° C.

A further zinc layer may be electroplated on top of the copper or copper alloy layer using a conventional zinc sulfate plating bath.

A further tin layer may be electroplated on top of the copper or copper alloy layer using an aqueous tin electroplating solution, which may preferably comprise about 26.1 g.l sn2+ions, 15.5 g/l total fe, 5.2 g/l sulfate and 210 g/l phenol sulfonic acid.

One particularly preferred low temperature brazing product according to this embodiment of the invention comprises a sheet or shim preform without a core layer, as in FIG. 3, which is preferably comprised of an AA4000-series alloy having a gauge in the range of up to about 3 mm, preferably in the range of about 0.4 to 2 mm.

In another preferred embodiment, the low temperature brazing product can be incorporated as a stiffener sheet in a composite metal panel as described above. The parallel metal plates or sheets of the composite panel can be made from aluminum alloys, such as but not limited to, from the AA3000-series alloys frequently used in conventional brazing operations, but also from for brazing more aluminum alloys which are not normally brazed, such as alloys from the AA5000-series having magnesium as an essential alloying element in a range of at most 6 weight percent, and also aluminum alloys from the AA6000-series. The composite metal panel may: also be formed in a single brazing cycle from different metal combinations, for example one or more of the parallel metal sheets or plates may be comprised on one of the dissimilar metals listed above. In one preferred example, one parallel metal sheet or plate is made from copper plated stainless steel and the other parallel metal sheet or plate is made from low carbon steel, with the stiffener comprising a low temperature brazing sheet according to the invention.

In a further aspect of the invention, there is provided a method of manufacturing rigid composite metal panels as set out above. The method of manufacturing the rigid composite metal panel, includes the steps of:

(a) providing parts of at least two parallel metal plates and/or sheets and a corrugated aluminum stiffener sheet which is made from low temperature aluminum brazing sheet product of the invention set out above;

(b) assembling the parts into an assembly such that the aluminum stiffener sheet is arranged between the parallel metal plates and/or sheets;

(c) joining the assembly into a rigid composite metal panel by heating the assembly under a vacuum or in an inert atmosphere in the absence of a brazing flux material at elevated temperature of less than 600° C. for a period long enough for melting and spreading of the molten filler to form a joint between each of the parallel metal plates and/or sheets and the corrugated aluminum stiffener sheet; and

(d) cooling of the joined composite metal panel.

In above method, fluxless CAB brazing is preferred.

### EXAMPLES

The invention encompasses a novel plating process which provides for a functional braze-promoting layer. As one aspect, whereas U.S. Pat. No. 4,208,200 contemplates usefulness only in alkaline conditions [pH 7-12], with resultant production of offensive ammonia vapors, the bath of the present invention may be utilized also in acid conditions [pH 5-7], wherein ammonia vapors are reduced. So as to avoid corrosion of the aluminum substrate, and improve adhesion of the braze-promoting layer, a preplate (ie of zinc, tin, lead, bismuth, etc.) is advantageously provided in acid conditions. The preplate may be provided, but is not necessary, in alkaline conditions. The process is characterized by an aqueous bath comprising, in solution, one or more of nickel, iron and cobalt, along with acetates and gluconates. As one aspect, the bath is characterized by a pH range, as aforesaid, between 5-7. As another aspect, citrate and ammonium are provided in solution, and the mole ratio of nickel:citrate:ammonium in solution is about 1:0.5-1.5:1-6, which provides significant improvements in plating rates and bath life over the process described in U.S. Pat. No. 4,208,200. Preferred embodiments of the above bath are characterized in table 1, wherein same are identified as solutions 1-6. It will also be shown that the mole ratios of nickel:citrate:ammonium in solution can further extend to approximately 1:0.05-1.5:0.05-6

For the purpose of understanding table 1, it should be understood that the values for bath life indicated were obtained using an accelerated life span test method. The method utilizes a nickel anode and aluminum cathode in a beaker containing 500-1000 ml of plating solution. Plating tests were run continuously using a stirred 800 ml plating solution for about 8 hours per day. Periodically small samples were plated for about 1 minute and then brazed in a furnace under nitrogen atmosphere at 1120° F. for 1 minute. Plating of nickel-lead on the aluminum continued each day until either a precipitate formed or a green gel formed on the anode.

TABLE 1
Solutions

| | U.S. Pat. No. | | | | | | |
|---|---|---|---|---|---|---|---|
| Formula (grams/liter) | 4,028,200 | 1 | 2 | 3 | 4 | 5 | 6 |
| NiSO₄.6H₂O | 70 | 70 | 70 | | | | |
| NiCl₂.6H₂O | 30 | 30 | 30 | 155 | 150 | 155 | 155 |
| Na₃ Citrate.2H₂O | 120 | 120 | 120 | 110 | 200 | 110 | |
| Na Acetate.3H₂O | | 20 | 20 | | | | |
| (NH₄)₂SO₄ | | 15 | | | | | |
| NH₄Cl | | | 50 | 100 | 20 | 100 | |
| NH₄OH (ml 29%) | 30 | 30 | 30 | 146 | | 146 | [symbol] |
| Lead Acetate | 1 | 1 | 1 | 1 | 1 | 1 | 1 |
| NaOH (ml 25%) | | | | | 30 | | 93 |
| EDTA | | | | | | | 154 |
| Na Gluconate | | | | | | 66 | |
| Solution pH | 8.1 | 8.1 | 7.8 | 7.8 | 7.6 | 7.8 | 6.4 |
| Bath Life (hours) | 4 | 12 | 50 | 95 | 50 | 187 | 100 |
| Plating Current mA/cm² | 20 | 20 | 30 | 80 | 30 | 80 | |

As will be evident from a review of table 1, each of the baths 1-6 provide significant improvements, either in deposition rate or bath life, or both, as compared to the bath described in U.S. Pat. No. 4,028,200. The chemical compositional limits identified in this patent have been shown to be limiting. Particularly, higher levels of acetate or chloride can be used than the respective limits of 10 g/l and 100 g/l described. In addition, edta and gluconate have been shown to be advantageous as lead and nickel complexing agents, and bath complexing agents. Further, solutions not containing citrate have been shown to be effective.

Without intending to be bound by theory, it is speculated that the improvements relate to preferred ratios of the components in the bath which provide for an equilibrium condition that is conducive to plating reactions, and less favourable to degradation of the bath. Particularly, it is believed that the baths of the present invention provide quantities of citrate sufficient to permit ready complexing of nickel dissolved from the anode, so as to substantially avoid passivation of the anode and precipitation of the newly dissolved nickel ions. Hydroxyl and sulfate ions are particularly deleterious in this regard since they carry a negative charge and are attracted by the anode. Plating efficiency and bath life are adversely affected by anode passivation. It should be noted that chlorides break down the passive layers and depolarize the anodes. Previously it was shown that citrate can be replaced by other strong complexing agents for nickel, however, there is some degradation in plating performance resulting from the tendency for such complexing agents to bind the nickel too tightly to participate in the plating reaction. It is also believed that the baths of the present invention provide quantities of ammonia sufficient to permit ready complexing of the nickel presented to the cathode. Ammoniacal nickel carries a positive charge due to the neutral charge of the ammonia molecule, regardless of the complex number. The positive charge of the ammoniacal nickel allows free and rapid transfer of the nickel to the negatively charged electrode surface. Ammonia then plays a second and crucial role of buffering the electrode surface as it is discharged from the complexed nickel molecule. The release of ammonia in part can form a gaseous phase which tends to detach and scrub the surface, especially of hydrogen gas bubbles, allowing rapid reintroduction of complexed nickel to the surface. As well, ammonia buffers the surface environ such that hydroxyl ions generated through parasitic evolution of hydrogen cannot affect the quality of the nickel deposit. Recall that an abundance of hydroxyl ions can cause irreversible precipition of the nickel species, resulting in decreased bath life, and codeposition of a hydrated nickel species that can adversely affect braze quality. It is well known that complexing agents are used to increase the solubility of a plated species. The strong complexing ability of citrate and ammonia for nickel increases and stabilizes the high nickel contents in the bath. However, it is further believed that the baths of the present invention present nickel bath formulations with citrate and ammonia that allow for suitably rapid transfer of complexing species from citrate, which predominates in the anodic boundary layer, to ammonia, which predominates in the cathodic boundary layer. The transfer occurs spontaneously in the bulk solution as the chemical system drives towards equilibrium. If the kinetics of the swapping reaction are rate-limiting the bath could suffer degradation. Alkaline baths suffer slightly due to the presence of dissolved gaseous ammonia which can volatize into the local air stream. The hazardous fumes can cause irritation and burning of mucous membranes and therefore require specialized containment and exhaust systems. Addition of a wetting agent including, but not limited to, lead, significantly improves the plating and brazing reactions in alkaline or mildly acidic solutions, and the brazing reactions in deposits obtained from more acid solutions. In alkaline or mildly acid solutions, lead is added as a soluble acetate species but is strongly complexed by citrate. The citrate stabilizes the lead ion in the bulk solution, presents the lead to the cathodic surface and effectively buffers the lead from precipitation with low solubility anions including, and predominantly, hydroxyl ion, as well as sulfate and chloride species during plating. The preferential plating of lead, bismuth, etc. Or the purposeful deposition of lead nickel as a prestrike can increase the nucleation of nickel and therefore increase the coverage. This has far reaching implications allowing for decreased nickel consumption and an enhancement of braze quality and joint durability.

As per the work of Dockus in U.S. Pat. No. 4,028,200, it is known that the thickness of the braze-promoting layer is preferably about 0.1 to about 2.5% of the total thickness of the combination of the clad layer and the braze-promoting layer, for thin gauges such as those used commonly in heat exchanger construction [0.4 mm-0.75 mm]. If the amount of braze-promoter, such as nickel is deficient, the exothermic reaction will release insufficient heat to disrupt the oxide layer; if the amount is too large, it will react with the aluminum to form an excessive amount of aluminide compound, which is deleterious to bond formation and particularly, quality.

It has heretofore been understood that, provided uniform coverage was obtained, the thinnest zincate deposit possible was advantageous. However, such teachings were in the context of the plating of decorative nickel, and not in the context of braze-promoting nickel. It has been found, for bonding of a braze-promoting layer according to the present invention, the bonding layer should have a thickness of not more than 1 μm, preferably not more than 0.3 μm, and the braze-promoting layer should have a thickness of not more than 2.0 μm, preferably not more than 1.0 μm, again, for clad aluminum of the gauges generally utilized in the construction of heat exchangers.

It has also been found advantageous to incorporate certain alloying elements into the core or clad or bonding or braze-promoting layers, preferably in the core and/or cladding, as follows:

Th in the range 0.01 to 1.0% by weight

Bi in the range 0.01 to 1.0% by weight

Mg in the range 0.05 to 3.0% by weight

Li in the range 0.01 to 0.5% by weight

Pb in the range 0.01 to 1.0% by weight

Sn in the range 0.01 to 1.0% by weight

Sb in the range 0.01 to 1.0% by weight

As previously indicated, Th, Bi, Sn, Sb and Pb are wetting agents, which improve the quality of the braze joint when incorporated in the cladding, or in the bonding layer or braze-promoting layer as taught herein. Mg and Li are known to enhance the braze and may be readily alloyed in the brazing sheet. Mg is of specific interest in the nickel braze reaction due to the probable volatization, even at approximately atmospheric pressures, and resultant enhanced disintegration of the oxide layer during or close in timing to the nickel reaction. The nickel will tend to delay oxidation or relase of the Mg through the aluminum oxide on the braze alloy surface until the point of reaction. The nickel reaction tends to occur quickly at the instance of first melting of the clad surface, especially due to the heat generated in the localized exothermic reaction of nickel and aluminum. If residual sites of poorly broken oxides persist, the Mg volatization can additionally and compoundly break down these persistent oxides resulting in improved joint formation. Li is known to reduce to the surface tension of molten aluminum which may beneficially affect the braze reaction and subsequent fillet formation during nickel reaction and Mg volatization.

Indeed, testing has established that, in brazing sheet incorporating a nickel-lead braze-promoting layer as per the present invention, the intentional incorporation of about 0.15-0.2 wt. % Mg in the cladding resulted in a 50-70° F. drop in the threshold temperature necessary to achieve satisfactory brazing. Incorporation of about 0.05% lithium resulted in a further 60-80° F. decrease. Further to these observations, brazing of coupons and formed plates yielded excellent braze results with the lithium or magnesium containing clads even when the magnesium reached levels approaching 2%.

It should be noted that the example baths were formulated with hydrated salts, where applicable, as follows;

nickel chloride hexahydrate, NiCl₂. 6H₂O

nickel sulfate hexahydrate, NiSO₄.6H₂O

sodium citrate dihydrate, C₆H₅Na₃O₇.2H₂O

sodium acetate trihydrate, C₂H₃NaO₂.3H₂O

lead acetate trihydrate, C₄H₆O₄Pb. 3H₂O

Other non-hydrated species in the example baths include but are not limited to;

ammonium sulfate, (NH₄)₂SO₄

ammonium hydroxide, NH₄OH

sodium gluconate, C₆H₁₁NaO₇

stannous chloride, SnCl₂

antimony oxide, SbO₃

sodium hydroxide, NaOH

bismuth chloride, BiCl₃

bismuth trioxide, Bi₂O₃

The present invention provides new methods for fluxless brazing at low temperature, and a family of brazing products for use with this method having filler metal compositions with lowered melting temperatures, which products exhibit improved wetting and brazing characteristics when joining components comprised of similar of dissimilar metals.

Brazing at lower temperature than conventional brazing processes provides a number of advantages. For example, lower temperature brazing can be used to enable improved secondary brazing processes, including secondary furnace brazing, which may be used to increase brazed product design flexibility. Reduced braze temperatures can be further exploited to reduce gauge thickness of component parts, especially aluminum parts, since the degree of thermal diffusion and erosion of the component substrate by the liquid filler metal will be decreased. Lower temperatures will provide easier control of the brazing process and make the brazing process more versatile and more economical. Further, the addition of self-fluxing alloying metals such as nickel and lead or bismuth, to a filler metal composition braze promoting layer improves the filler metal wetting and spreading properties, thus permitting brazing under less demanding inert atmosphere or vacuum conditions. Successful fluxless brazing has been obtained in all brazing tests without fail, with the temperature range of the new filler metals about 250° f. lower than the generally accepted flow temperatures of commercial aluminum-silicon alloys and, as such, is a significant improvement in aluminum brazing technology.

The novel brazing products according to the invention comprise brazing alloys which form a filler metal during brazing, the filler metal having a liquidus temperature in the range of about 730 to 1130° F. (388 to 610° C.), more preferably 750 to 1050° C. (400 to 570° C.), typically from about 790 to 1050° F. (420 to 570° C). Preferably, the brazing products according to the invention include one or more temperature modification layers, at least one of which is an aluminum-based layer (at least 50 weight percent aluminum), a zinc-based layer (at least 50 weight percent zinc), or a copper-based layer (at least 50 weight percent copper). The temperature modifier layer optionally combines with other layers in the brazing alloy to form a filler metal having a liquidus temperature in the range of about 730 to 1130° F. Preferably, the filler metal comprises one or more of zinc, aluminum, copper, silicon, magnesium, antimony and nickel in amounts such that the filler metal has a liquidus temperature in the range of about 730 to 1130° F. Even more preferably, the filler metal comprises zinc, zinc-nickel, zinc-antimony, zinc-aluminum, aluminum-zinc, aluminum-zinc-silicon, aluminum-silicon-magnesium, aluminum-zinc-silicon-magnesium, aluminum-silicon-copper-magnesium, aluminum-silicon-zinc-copper, or aluminum-silicon-copper-magnesium having a liquidus temperature in the range of about 730 to 1130° F.

In combination with the temperature modifier layer, there may preferably be applied one or more additional layers selected from braze-promoting layers, bonding layers, barrier layers, and additional temperature modifier layers. The locations and compositions of these additional layers will be described in detail below.

The brazing products according to the invention exhibit excellent wetting and brazing characteristics without the need for a flux, when joining two or more components comprised of similar or dissimilar metals. For example, the brazing products according to the invention may be used to join components comprising aluminum to other aluminum-based components or to components comprised of dissimilar metals. For example, the invention permits fluxless brazing of aluminum castings, including die castings, and aluminum alloys which are not readily brazeable by conventional means, such as 2xxx, 5xxx, 6xxx or 7xxx-series alloys. Certain aluminum alloys, notably 2xxx, 6xxx and 7xxx-series alloys brazed according to this invention can be heat treated after brazing, to increase strength. aluminum (previously considered to be unbrazeable); copper and copper alloy substrates; and, with suitable coatings, dissimilar metal combinations, including those disclosed in the applicants' co-pending application Ser. No. 10/300,836, filed Nov. 21, 2002 entitled “Improvements in Fluxless Brazing”.

The brazing method according to the invention is suitable for continuous, inert gas furnace brazing, or for secondary-operation brazing using a protective shielding gas and any suitable heating source, and can be used to produce a range of industrial products, including aluminum heat exchangers or similar stacked assemblies such as metallic plates for fuel cell engines. It is anticipated that this brazing method and layered filler metal compositions, can also be used as wire or preform filler metals for shielded arc welding or brazing.

The brazing products according to the invention are exemplified by the following structures:

Braze Preform

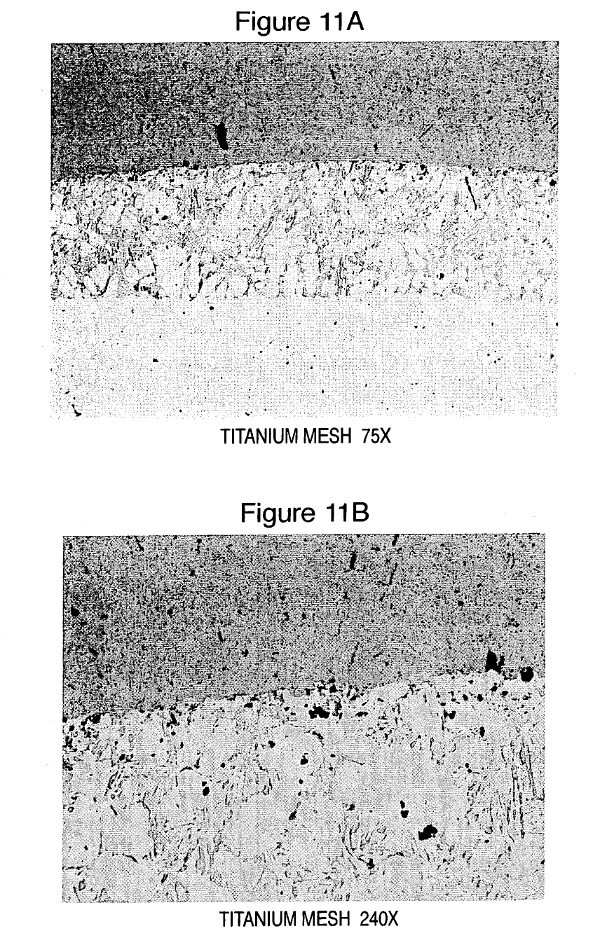

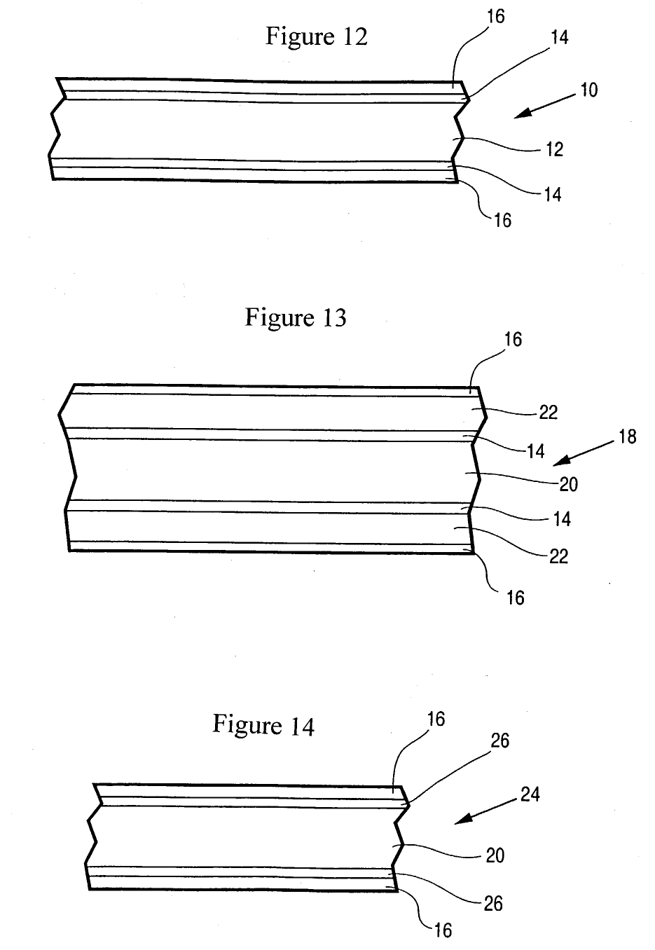

FIG. 12 comprises a schematic diagram illustrating the layers making up a preferred structure of a brazing preform 10 according to the invention. Preform 10 comprises a central temperature modifier layer 12, optional bonding layers 14 on both sides of the temperature modifier 12, and braze-promoting layers 16 on top of the bonding layers 14. The preform 10 is preferably in the form of a sheet, foil, shim, wire or rod which is interposed between two similar or dissimilar metal components to form an assembly. When the assembly is heated to a temperature in the range from about 730 to 1130° F. for a sufficient period of time, the entire preform melts to form a filler metal which brazes the components together. Thus, the preform 10 is consumed during the brazing process. Although less preferred, it is possible to apply the bonding layer 14 and braze-promoting layer 16 to only one side of the temperature modifier 12.

The temperature modifier layer 12 is either zinc-based, aluminum-based or copper-based and has a liquidus temperature of about 730 to 1130° F. Most preferably, the temperature modifier layer is comprised of zinc; zinc and nickel; zinc and antimony aluminum and zinc; aluminum, aluminum and silicon; zinc and silicon; aluminum, silicon and magnesium, or aluminum, zinc, silicon and magnesium, in relative amounts such that the temperature modifier layer having a liquidus temperature in the range of about 730 to 1130° F. Most preferably, the temperature modifier layer 12 of preform 10 comprises zinc, zinc-nickel, zinc-aluminum, aluminum-zinc, aluminum-zinc-silicon, aluminum-silicon-magnesium, or aluminum-zinc-silicon-magnesium having a liquidus temperature in the range of about 730 to 1130° F.

The temperature modifier layer may also include an optional melt depressant such as magnesium or copper and may also include an optional braze modifier selected from bismuth, lead, antimony, thallium, lithium and strontium.

It is to be understood that a bonding layer 14 is optional and is preferably applied where the temperature modifier layer 12 is aluminum-based and/or where it is desired to electroplate a nickel-based braze-promoting layer 16 under acidic conditions. Where the temperature modifier layer is zinc-based, a bonding layer is typically not required. This being said, the bonding layer preferably has a composition as described in the applicants' co-pending application Ser. No. 10/300,836, filed Nov. 21, 2002 entitled “Improvements in Fluxless Brazing”, incorporated herein by reference in its entirety, and preferably comprises one or more metals selected from the group comprising zinc, tin, lead, bismuth, nickel, antimony, magnesium, lithium and thallium. For example, the bonding layer may preferably be comprised of pure or substantially pure zinc, tin, lead or bismuth, or may be primarily zinc, tin, lead or bismuth (e.g. at least 50 weight %). Minor amounts of these or other elements may be present, as discussed in more detail below. Typically, such elements are present at less than 10%, more usually less than 5% by weight, and possibly less than 1%.

In some preferred embodiments, the bonding layer is comprised primarily of zinc or tin in combination with one or more braze modifier elements selected from the group comprising bismuth, lead, lithium and antimony. The total amount of the braze modifiers may be up to 50%, but preferably is less than 25%, e.g. in the range 1 to 25%. As a practical matter, even impurity levels of braze modifiers such as lead and bismuth can be sufficient to have an positive effects on brazing, but the amounts of these elements are preferably controlled in continuous processes such that they are no longer considered impurities.

In some preferred embodiments of the invention, the bonding layer comprises a very thin zincate or stannate pretreatment; thin electroless nickel, bismuth, lead, nickel-lead or nickel-bismuth pretreatment; or a combination of zincate/stannate bonding layer with a copper plated, or sequential copper/nickel plated barrier coating, as preconditioning steps for subsequent fast zinc electroplating. This preconditioning permits the use of acid zinc plating baths, which have practical and environmental advantages over traditional cyanide alkaline copper baths.

The thickness of the bonding layer is preferably up to about 0.5 microns, more preferably up to about 0.3 microns, and most preferably in the range of 0.01 to 0.15 microns or 0.02 to 0.15 microns, with 0.03 microns being an example of a particularly preferred thickness. The bonding layer may be applied to the substrate by immersion plating, with or without mechanical abrasion, using the plating bath compositions described in the applicants' co-pending application Ser. No. 10/300,836, filed Nov. 21, 2002 entitled “Improvements in Fluxless Brazing”. Furthermore, it will be appreciated that the application of a bonding layer to the substrate is merely one of a number of “pretreatments” which can be used to promote adhesion of the braze-promoting layer and the underlying substrate, and that it may be possible to replace the bonding layer by, or use it in combination with, any of the alternate pretreatments disclosed in the applicants' co-pending application Ser. No. 10/300,836, filed Nov. 21, 2002 entitled “Improvements in Fluxless Brazing”.

Suitable braze-promoting layers 16 for use in preform 10 include those described in the applicants' co-pending application Ser. No. 10/300,836, filed Nov. 21, 2002 entitled “Improvements in Fluxless Brazing”. For example, the braze-promoting layer preferably comprises one or more metals selected from the group comprising nickel, cobalt and iron. More preferably, the braze-promoting layer is nickel-based, and may preferably comprise pure nickel or nickel in combination with one or more alloying elements and/or impurities selected from the group comprising cobalt, iron, lead, bismuth, magnesium, lithium, antimony and thallium. Preferred braze modifiers include bismuth, lead, antimony and thallium. Specific examples of nickel-based braze-promoting layers are nickel, nickel-bismuth, nickel-lead, nickel-cobalt, nickel-bismuth-cobalt, nickel-lead-cobalt, nickel-lead-bismuth, nickel-bismuth-antimony, etc.

In some preferred embodiment of a nickel-based braze-promoting layer, lead or bismuth is present in an amount of up to about 10%, preferably up to about 5%, and more preferably up to about 3%, although lower amounts and even trace amounts of these elements may also have a beneficial effect. For example, amounts of lead or bismuth as low as up to about 1.0%, about 0.01 to 1.0%, or about 0.01 to 0.05% may be beneficial.

The braze-promoting layer may be applied by electroplating, electroless plating, roll bonding, thermal spraying, plasma spraying, chemical vapor deposition (CVD), physical vapor deposition (PVD) or other techniques for depositing metal or metal alloys from a gas or vapour phase, although some of these methods would be impractical or difficult to control. Electroplating using the conditions and plating baths disclosed in the applicants' co-pending application Ser. No. 10/300,836, filed Nov. 21, 2002 entitled “Improvements in Fluxless Brazing” is the most preferred method for applying the braze-promoting layer 16 to preform 10.

For aluminum alloy material systems, the thickness of the braze-promoting layer is preferably up to about 2.0 microns, more preferably up to about 1.0 microns, and even more preferably up to about 0.5 microns, and most preferably about 0.05 to 0.5 microns. A preferred minimum thickness of the braze-promoting layer is about 0.25 to 0.30 microns. For alternate filler metal systems, notably zinc or copper-based systems, increased maximum thickness levels for the braze promoter layers may be tolerable.

The preform 10 may preferably include an additional temperature modifier layer (not shown), preferably a copper-based layer applied between the bonding layer 14 and the braze-promoting layer 16.

Brazing Sheet with Temperature Modifier Layer Applied by Hot Dipping, Arc Spraying, Thermal Spraying, Low Temperature Kinetic Energy Metallization or HVLP (High Velocity Low Pressure) Coating Methods

A preferred structure of this type of brazing sheet 18 is schematically illustrated in FIG. 13, and comprises a central core layer 20, optional bonding layers 14 on both sides of the core 20, temperature modifier layers 22 on top of the bonding layers, and braze-promoting layers 16 on top of the temperature modifier layers 22. The brazing sheet is preferably incorporated into an assembly, either in the form of a sheet or a shaped object, and is brazed to one or more other components in the assembly, the other components either comprising similar or dissimilar metals. When the assembly is heated to a temperature in the range from about 730 to 1130° F. for a sufficient period of time, the bonding layers 14, temperature modifier layer 22 and the braze-promoting layers 16 melt and are incorporated into the filler metal which brazes the components together. Although less preferred, it is possible to apply a bonding layer 14, temperature modifier layer 22 and braze-promoting layer 16 to only one side of the core layer 20.

The bonding layers 14 and braze-promoting layers 16 preferably have the compositions described above. Furthermore, it is to be understood that the bonding layers 14 are optional and the most preferred bonding layers 14 are those described above which are zinc-based or nickel-based. The temperature modifier layer may preferably have a composition as described above in the context of temperature modifier layer 12 of preform 10.

The core layer has a melting point high enough that it does not melt during the brazing operation, and is preferably formed from aluminum or an aluminum alloy. In some preferred embodiments the core sheet also comprises magnesium to increase amongst others the strength of the core layer. The core may preferably contain magnesium in a range of up to about 8%, more preferably in a range of up to about 5.0%, and even more preferably up to about 2.0%. The amount of magnesium in the alloy is highly variable, depending on the intended application of the brazing product, and may be at or below 0.05% for AA3003 alloy.

Further alloying elements may be added to the core such as, but not limited to, Cu, Zn, Bi, V, Fe, Zr, Ag, Si, Ni, Co, Pb, Ti, Zr and Mn in suitable ranges.

Preferred aluminum alloys for use in the core layer include conventional aluminum alloys employed in brazing such as AA3000-series alloys. Alternatively, the core materials may instead comprise other, less conventional, alloys such as AA2000, AA5000, AA6000, AA7000 and AA8000-series alloys, due to the fact that the present invention permits brazing at relatively low temperatures; and that diffusion migration of potentially deleterious elements from these higher alloyed core materials into the braze filler metal system, can be mitigated by a combination of lower braze temperatures, and the use of suitable barrier layers, or interlayers.

Rather than being formed from aluminum or an aluminum alloy, the core may instead comprise titanium, titanium alloys, copper, bronze or brass or other copper alloys, high strength steel, low carbon steel, stainless steel, nickel or nickel alloy steel, or coated versions of these, and including the materials specifically disclosed in the applicants' co-pending application Ser. No. 10/300,836, filed Nov. 21, 2002 entitled “Improvements in Fluxless Brazing”

For typical heat exchanger applications, the core sheet has a thickness typically in a range of at most 5 mm, more preferably in the ranges of 0.1 to 2.5 mm, 0.1 to 2.0 mm or 0.2 to 2 mm.

Preferably, the brazing sheet according to this embodiment also comprises a thin, transient barrier coating (not shown) applied at the interface between the core layer 20 and the bonding layer 14, or at the interface between the core layer 20 and the temperature modifier layer 22 where the bonding layer 14 is not present. It is believed that the barrier coating acts to temporarily restrict diffusion of the low melting filler material (comprising layers 16, 22 and optionally 14) into the core layer 20 during brazing, to avoid loss of eutectic-forming elements and to increase the efficacy and efficiency of the applied filler metal coating.

The barrier coating may preferably be the same as that of preform 10, or may be comprised of nickel, nickel-lead or nickel-bismuth and is applied to the core layer 20 or the bonding layer 14 prior to coating with the low-melting temperature modifier. Barrier coatings comprising copper, copper-lead or copper-bismuth may also be preferred in some embodiments, either in addition to, or in substitution for, the nickel-based barrier coating. The barrier coating can preferably be applied by electroless or electrolytic plating.

Brazing Sheet with Roll Bonded Cladding

FIG. 14 illustrates a preferred structure of a brazing sheet 24 having a roll bonded cladding layer 26 applied directly on the core layer 22 (which may have been produced by casting), the cladding layer 26 being comprised of a temperature modifier. A braze-promoting layer 16 as described above is applied on top of the cladding layer 26. The brazing sheet 24 is preferably incorporated into an assembly, either in the form of a sheet or a shaped object, and is brazed to one or more other components in the assembly, the other components comprising either similar or dissimilar metals. When the assembly is heated to a temperature in the range of about 730 to 1130° F. for a sufficient period of time, the low-melting cladding layer 26 and the braze-promoting layer 16 melt and are incorporated into the filler metal, thereby brazing the components together. Although less preferred, it is possible to apply cladding layer 26 and braze-promoting layer 16 to only one side of the core layer 20.

The cladding layer comprises a temperature modifying metal or alloy, preferably the same as the temperature modifier 12 of perform 10, within the limits of rolling mill processibility.

The braze-promoting layer 16 is as described above with reference to the preform, and the core 20 is as described above with reference to the brazing sheet having a temperature modifier layer applied by hot dipping, etc.

In an alternate, related embodiment, the roll-bonded cladding layer 26 simply comprises an aluminum-silicon brazing alloy and a temperature modifier layer comprising zinc is applied on top of the cladding, typically by electroplating. This structure can be obtained merely by plating zinc onto commercially available aluminum brazing sheets which may have a 3xxx-series core alloy and a 4xxx-series cladding alloy.

Core Sheet with Electroplated Temperature Modifier Layer

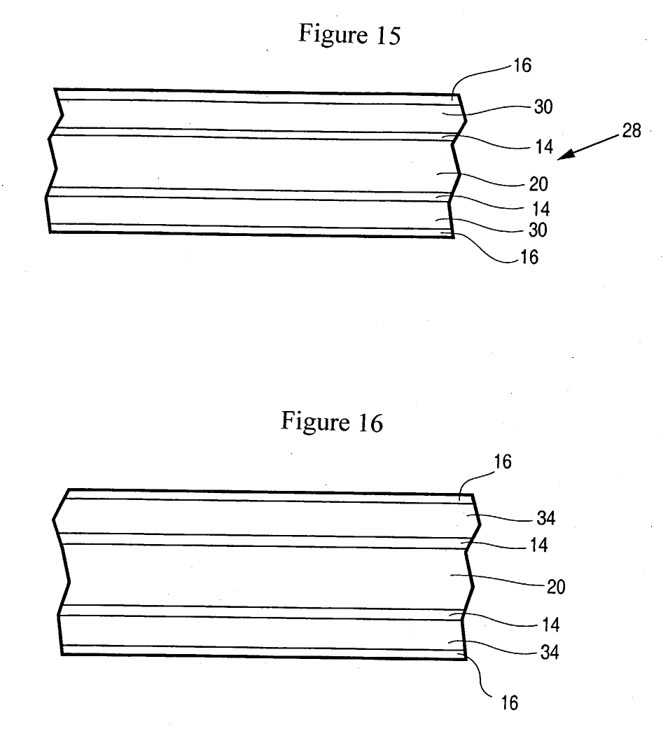

A preferred structure of this type of brazing sheet 28 is schematically illustrated in FIG. 15, and is similar to the structure shown in FIG. 2. The brazing sheet 28 may preferably comprise a central core layer 20, optional bonding layers 14 on both sides of the core 20, electroplated temperature modifier layers 30 on top of the bonding layers 14, and braze-promoting layers 16 on top of the bonding layers 14. The brazing sheet 28 is preferably incorporated into an assembly, either in the form of a sheet or a shaped object, and is brazed to one or more other components in the assembly, the other components either comprising similar or dissimilar metals. When the assembly is heated to a temperature in the range from about 730 to 1130° F. for a sufficient period of time, the bonding layers 14, temperature modifier layer 30 and the braze-promoting layers 16 melt, and the contacted surfaces of the core or interlayer materials and are incorporated into the filler metal which brazes the components together. Although less preferred, it is possible to apply a bonding layer 14, temperature modifier layer 30 and braze-promoting layer 16 to only one side of the core layer 20.

The bonding layers 14 and braze-promoting layers 16 preferably have the compositions described above, and it is to be appreciated that the bonding layers 14 are optional. Where a bonding layer is present, it preferably comprises a very thin zincate or stannate pretreatment, or a thin electroless nickel, nickel-lead or nickel-bismuth pretreatment, as a pretreatment for subsequent fast zinc electroplating. Electroplating solutions utilized in the plating of the braze promoting layers include solutions of nickel sulfate, nickel chloride, sodium citrate, sodium gluconate, sodium acetate, ammonium chloride, ammonium sulfate, ammonium hydroxide and lead acetate as described in U.S. Pat. No. 4,028,200 and as described in the applicants' co-pending application Ser. No. 10/300,836, entitled “Improvements in Fluxless Brazing”, filed on Nov. 21, 2002.

The temperature modifier layer 30 is either zinc-based, aluminum-based or copper-based and has a liquidus temperature of about 730 to 1130° F. Most preferably, the temperature modifier layer 30 is comprised of zinc; zinc and nickel; aluminum and zinc; aluminum, zinc and silicon; aluminum, silicon and magnesium, or aluminum, zinc, silicon and magnesium, in relative amounts such that the temperature modifier layer has a liquidus temperature in the range of about 730 to 1130° F. Most preferably, the temperature modifier layer 30 of brazing sheet 28 comprises zinc, zinc-nickel, zinc-aluminum, aluminum-zinc, aluminum-zinc-silicon, aluminum-silicon-magnesium, or aluminum-zinc-silicon-magnesium having a liquidus temperature in the range of about 730 to 1130° F., eg clad brazing sheet with an aluminum-silicon cladding, the filler metal being deposited on the aluminum-silicon eutectic.

The core layer has a melting point high enough that it does not melt during the brazing operation, and has a composition as described above with reference to core layer 20 of brazing sheet 18 shown in FIG. 13. Most preferably, the core layer 20 of brazing sheet 28 formed from aluminum or an aluminum alloy.

As in the brazing sheet 18 shown in FIG. 13, the brazing sheet 28 may also be provided with a thin, transient barrier coating (not shown) applied at the interface between the core layer 20 and the bonding layer 14, or at the interface between the core layer 20 and the temperature modifier layer 30 where the bonding layer 14 is not present.

The barrier coating is preferably comprised of nickel, nickel-lead or nickel-bismuth and is applied to the core layer 20 or the bonding layer 14 prior to coating with the low-melting temperature modifier. Barrier coatings comprising copper, copper-lead or copper-bismuth may also be preferred in some embodiments, either in addition to, or in substitution for, the nickel-based barrier coating. The barrier coating can preferably be applied by electroless or electrolytic plating.

It may also be preferred in this embodiment to provide a copper-based, preferably copper or copper-tin, layer either directly under or on top of the braze-promoting layer 16. In this case, copper likely behaves more like a temperature modifier than a barrier layer, except perhaps with respect to the facing surface of another contacting member to be brazed.

Brazing Sheet with Temperature Modifier Layer Applied by CVD or PVD

The preferred structure of this type of brazing sheet 32 is schematically illustrated in FIG. 16, and comprises a central core layer 20, optional bonding layers 14 on both sides of the core 20, CVD or PVD-deposited temperature modifier layers 34 on top of the bonding layers 14, and braze-promoting layers 16 on top of the temperature modifier layers 34. The brazing sheet is preferably incorporated into an assembly, either in the form of a sheet or a shaped object, and is brazed to one or more other components in the assembly, the other components either comprising similar or dissimilar metals. When the assembly is heated to a temperature in the range from about 730 to 1130° F. for a sufficient period of time, the bonding layers 14, temperature modifier layer 34 and the braze-promoting layers 16 melt and are incorporated into the filler metal which brazes the components together. Although less preferred, it is possible to apply a bonding layer 14, temperature modifier layer 34 and braze-promoting layer 16 to only one side of the core layer 20.

The bonding layers 14 and braze-promoting layers 16 preferably have the compositions described above. Furthermore, it is to be understood that the bonding layers 14 are optional and the most preferred bonding layers 14 are those described above which are zinc-based or nickel-based. The temperature modifier layer may preferably have a composition as described above in the context of temperature modifier layer 12 of preform 10.

The core layer has a melting point high enough that it does not melt during the brazing operation, and has a composition as described above with reference to core layer 20 of brazing sheet 18 shown in FIG. 13. Most preferably, the core layer 20 of brazing sheet 28 formed from aluminum or an aluminum alloy.

As with brazing sheets 18 and 28 described above, the brazing sheet 32 according to this embodiment may also be provided with a thin, transient barrier coating (not shown) applied at the interface between the core layer 20 and the bonding layer 14, or at the interface between the core layer 20 and the temperature modifier layer 34 where the bonding layer 14 is not present.

The barrier coating is preferably comprised of nickel, nickel-lead or nickel-bismuth and is applied to the core layer 20 or the bonding layer 14 prior to coating with the low-melting temperature modifier. Barrier coatings comprising copper, copper-lead or copper-bismuth may also be preferred in some embodiments, either in addition to, or in substitution for, the nickel-based barrier coating. The barrier coating can preferably be applied by electroless or electrolytic plating.

Powder Metal Compositions

A further embodiment of the invention exploits the use of powder metal compositions including zinc, aluminum, silicon, nickel and braze modifiers, for example the compositions may include zinc, zinc-aluminum, zinc-silicon, zinc-aluminum-silicon in combination with nickel powders, with or without braze modifiers as described above. Preferably the nickel and braze modifier are added together as nickel-lead or nickel-bismuth powders.

The powder metal mixtures can be applied to an aluminum-containing substrate as a coating, using a suitable binder, by roll compaction into the substrate surface, or as a perform, to form selective or continuous, brazeable coatings. The substrate may comprise aluminum or an aluminum alloy, and may comprise a brazing sheet with an aluminum-silicon cladding. In terms of binders, after exhaustive tests of binders normally used for brazing pastes, including those used for CAB brazing, all of which tend to leave black residues on brazing, or degraded brazing, the inventors have found that particularly effective binders are polymeric binders, preferably propylene carbonate binders, and even more preferably such polymers in the form of aqueous emulsions. One preferred binder is QPAC-40™ from PAC Polymers.

In one specific example, a mixture prepared from a slurry of 90 mg zinc powder, 10 mg nickel powder, 160 mg water, and 40 mg of QPAC emulsion, was successfully brazed with 3003 aluminum.

In the powder coating or roll compaction embodiment, the substrate surface may preferably be pre-conditioned by suitable cleaning pretreatment, or by application of a bonding layer, for example by a zincate or stannate treatment, or by application of a thin pre-coating comprised of nickel, bismuth, lead, nickel-lead, nickel-bismuth, zinc-bismuth, zinc-lead, tin bismuth or tin-lead. For roll compaction application of powder coatings, to high strength alloys such as 2024 aluminum, it may be preferred to use an aluminum clad version of the alloy, ie where the 2024 material is clad with a surface layer of soft, nearly pure aluminum.

An important point in all of these embodiments is that in addition to the objective of achieving a desired low melting filler metal system for the purpose of joining, there is generally inherent dissolution, and alloying together with the filler metal, of the surface layers of the substrate material. Accordingly, by appropriate selection of the filler metal system, it will be appreciated that it may be possible to deliberately adjust the surface alloy composition of the as-brazed material. For example, deliberate use of zinc filler metal systems may be used to enrich the surfaces of an aluminum-brazed product with zinc, for the purposes of sacrificial corrosion protection, or to achieve surface hardening characteristics.

### Example 1

0.020″ brazing sheet [H₃₁₉₀ core, clad on both sides with H4450 aluminum 10% silicon 0.15% magnesium] was mechanically brushed, tap water rinsed and nickel-lead plated in a bath including 155 g/l NiCl₂. 6H₂O, 108.6 g/l sodium citrate, 100 g/l NH₄Cl, 140 ml NH₄OH [29% solution], 1 g/l lead acetate [pH 7.8]. Coupons sectioned from the sheet were brazed. An excellent braze was observed.

### Example 2

0.020″ brazing sheet [Ravenswood K320 core, clad on both sides with CA43 clad, AA4045 plus 0.015% lithium] was caustic cleaned, tap water rinsed and nickel-lead plated in a bath including 70 g/l NiSO₄.6H₂O, 30 g/l NiCl₂.6H₂O, 120 g/l sodium citrate, 20 g/l sodium acetate, 15 g/l (NH₄)₂SO₄, 1.2 g/l lead acetate [pH 8.2, by 18 be NH₄OH] at 25 mA/cm² for 120 seconds. An excellent braze was observed.

### Example 3

0.020″ brazing sheet [Ravenswood K326 core, clad on both sides with CA28 clad, AA4343 plus 0.04% lithium] was caustic cleaned, tap water rinsed and nickel-lead plated in a bath including 70 g/l NiSO₄.6H₂O, 30 g/l NiCl₂.6H₂O, 120 g/l sodium citrate, 20 g/l sodium acetate, 15 g/l (NH₄)₂SO₄, 1.2 g/l lead acetate [pH 8.2, by 18 be NH₄OH] at 25 mA/cm² for 120 seconds. An excellent braze was observed.

### Example 4

0.0236″ brazing sheet [K324 core, clad on both sides with aluminum 12% silicon, 1.75% magnesium] was caustic cleaned, tap water rinsed and nickel-lead plated in a 35° C. alkaline bath including 70 g/l NiSO₄.6H₂O, 30 g/l NiCl₂.6H₂O, 120 g/l sodium citrate, 20 g/l sodium acetate, 15 g/l (NH₄)₂SO₄, 1.2 g/l lead acetate [pH 8.2, by 18 be NH₄OH] at 25 mA/cm² for 120 seconds. Components for a transmission oil cooler were stamped, assembled and brazed. An excellent braze was observed.

In the event that corrosion properties of the clad layer are desired to be modified, it is contemplated that the clad layer may contain by weight zinc in an amount in the range of up to about 5%. Manganese or other functional alloying ingredients may also be included in the clad layer as typical in commercial brazing sheet.

Braze tests were carried out to demonstrate the foregoing. In each test, braze quality was determined by placing the flat, cut end of an AA3003 O-temper aluminum tube [0.65″ ID×0.75″ OD, cut to 0.5″ length and ground flat] on a 2″×3″ coupon of No. 12 brazing sheet [total thickness 0.020″, core 3003 aluminum, clad on both sides with nominal 10% ie 0.002″ AA4343 aluminum (7.5% nominal silicon)] and heating the arrangement in a preheated furnace in a flowing nitrogen atmosphere to 1100° F. for a dwell time of less than 1 minute at maximum temperature. Braze quality was recorded as excellent, good, fair or poor, based on visual attribute data such as fillet size, wetting characteristics, surface appearance, lustre, etc.

### Example 5

The coupon was caustic cleaned for 45 seconds, tap water rinsed, deoxidized in Oakite 125 for 10 seconds, tap water rinsed and nickel-lead plated in a bath including 70 g/l NiSO₄.6H₂O, 35 g/l NiCl₂. 6H₂O, 120 g/l sodium citrate, 50 g/l NH₄Cl, 45 ml NH₄OH [29% solution], 2 g/l lead acetate [pH 7.6] at 75 mA/cm² for 45 seconds. An excellent braze was observed.

### Example 6

The coupon was caustic cleaned for 45 seconds, tap water rinsed, deoxidized in Oakite 125 for 10 seconds, tap water rinsed and nickel-tin plated in a bath including 70 g/l NiSO₄.6H₂O, 30 g/l NiCl₂. 6H₂O, 120 g/l sodium citrate, 50 g/l NH₄Cl, 40 g/l sodium acetate, 20 ml NH₄OH [29% solution], 1 g/l SnCl₂ [pH 7.3] at 75 mA/cm² for 40 seconds. An excellent braze was observed.

### Example 7

The coupon was caustic cleaned for 45 seconds, tap water rinsed, deoxidized in Oakite 125 for 10 seconds, tap water rinsed and nickel-antimony plated in a bath including 70 g/l NiSO₄.6H₂O, 30 g/l NiCl₂. 6H₂O, 120 g/l sodium citrate, 50 g/l NH₄Cl, 20 g/l sodium acetate, 30 ml NH₄OH [29% solution], 1 g/l SbO₃. A poor braze was observed.

### Example 8

The coupon was caustic cleaned for 45 seconds, tap water rinsed, deoxidized in Oakite 125 for 10 seconds, tap water rinsed and nickel-lead plated in a bath including 150 g/l NiCl₂. 6H₂O, 200 g/l sodium citrate, 20 g/l NH₄Cl, 10 ml lead acetate solution [pH 7.6, by NaOH] at 25 mA/cm² for 120 seconds. An excellent braze was formed.

### Example 9

The coupon was caustic cleaned for 45 seconds, tap water rinsed, deoxidized in Oakite 125 for 10 seconds, tap water rinsed and nickel-lead plated in a bath including 155 g/l NiCl₂. 6H₂O, 108.6 g/l sodium citrate, 100 g/l NH₄Cl, 140 ml NH₄OH [29% solution], 1 g/l lead acetate [pH 7.8] at 25 mA/cm² for 120 seconds. An excellent braze was observed.

### Example 10

The coupon was caustic cleaned for 45 seconds, tap water rinsed, deoxidized in Oakite 125 for 10 seconds, tap water rinsed and (a) nickel-bismuth plated in a bath including 155 g/l NiCl₂. 6H₂O, 120 g/l sodium citrate, 100 g/l NH₄Cl, 80 ml NH₄OH [29% solution], 1 g/l bismuth chloride [pH 7.4]. Not tested since bismuth precipitated. (b) nickel-bismuth plated in a bath including 155 g/l NiCl₂. 6H₂O, 120 g/l sodium citrate, 66 g/l sodium gluconate, 100 g/l NH₄Cl, 80 ml NH₄OH [29% solution], 1 g/l bismuth chloride [pH 7.5]. An excellent braze was formed.

### Example 11

The coupon was caustic cleaned for 45 seconds, tap water rinsed, deoxidized in Oakite 125 for 10 seconds, tap water rinsed and nickel-lead plated in a bath including 500 ml nickel sulfamate bath, 15 ml NH₄OH [29% solution], 15 ml lead acetate solution [pH 6] at 25 mA/cm² for 120 seconds. A fair braze was observed.

It has been shown that brazing can be accomplished on coupons which are plated at pH values as low as approximately pH=2.2 as observed in the following baths containing EDTA. Later examples will show nickel/citrate/ammonia bath formulations that can plate at pH values of approximately pH=4.

### Example 12

The coupon was caustic cleaned for 45 seconds, tap water rinsed, deoxidized in Oakite 125 for 10 seconds, tap water rinsed and (a) nickel-lead plated in a bath including 155 g/l NiCl₂. 6H₂O, 161 g/l EDTA, 100 g/l NaOH, 1 g/l lead acetate [pH 6.4] at 25 mA/cm² for 120 seconds. No nickel deposit was detected and no braze occurred. (b) nickel-lead plated in a bath including 155 g/l NiCl₂. 6H₂O, 155 g/l EDTA, 167 ml NH₄OH [29% solution], 1 g/l lead acetate [pH 6.5] at 25 mA/cm² for 120 seconds. A good braze was observed. (c) nickel-lead plated in a bath including 155 g/l NiCl₂. 6H₂O, 155 g/l EDTA, 136 ml NH₄OH [29% solution], 1 g/l lead acetate [pH 2.2] at 25 mA/ cm² for 120 seconds. A good braze was observed.

It is well known that the tenacious oxide on aluminum alloys prevents direct brazing without surface modification. Further it has been shown that coating with a traditional zincate bonding layer cannot alter the surface sufficiently to enable brazing as shown in the following example.

### Example 13

As a control, a brazing sheet coupon was immersed in 10 wt. % w/w Oakite 360 etch solution at ambient temperature for 45 seconds; tap water rinsed; deoxidized in 4% v/v Oakite Deox PD-60-FC 22 for 7 seconds; tap water rinsed; and immersed for 30 seconds in an alkaline zincate solution including 50% w/w sodium hydroxide and 100 g/l zinc oxide to form a uniform zinc coating of approximately 0.2 μm. The AA3003 tube was not treated prior to arrangement on the coupon. Upon heating, poor brazing (no braze) was observed. A similar test was carried out in relation to a coupon immersed in zincate solution for 60. Again, poor brazing (no braze) was observed, which substantiates the need for a braze-promoting layer.

As previously indicated, it is known to utilize the Watts bath to provide a decorative nickel coating on aluminum. Utilization of the conventional Watts bath would overcome the problem of ammonia release, since inter alia the Watts bath contains no ammonia. However, it is conventional to utilize copper as a preplate; zinc is also known as a possibility, but the Watts bath is known to be difficult to control in the context of a zinc-coated aluminum substrate, and moreover, is not amenable to the inclusion of lead, bismuth or thallium, which can reduce plating rate. These difficulties of the conventional Watts bath are demonstrated with reference to the following examples.

### Example 14

The coupon was immersed for 30 seconds in a zincating solution [ambient temperature] including 120 g/l sodium hydroxide, 20 g/l zinc oxide, 50 g/l Rochelle salt, 2 g/l ferric chloride hexahydrate and 1 g/l sodium nitrate to form a uniform zinc coating; tap water rinsed; and (a) nickel plated in a traditional Watts bath including 200 g/l NiSO₄.6H₂O, 40 g/l NiCl₂.6H₂O, 30 g/l H₃BO₃ [pH 4.8-5.2, ambient temperature] at 30 mA/cm² for 60-90 seconds. The tube was not treated prior to arrangement on the coupon. A poor to fair braze was observed. Black streaks and darkened edges were observed after 60 seconds and the nickel coating was non-uniform. (b) nickel-lead plated in the Watts bath with lead acetate added and plated at similar conditions, a fair to good braze was observed. The plating bath became cloudy.

Since it is desirable to produce a bath that does not release ammonia fumes, it is counter-intuitive to incorporate ammonia into a Watts bath. However, it is evident that the aforementioned discovery of the particular advantages provided by ammonium in nickel plating, and the preferable mole ratios to achieve equilibrium, have inherent application also in acidic conditions. Thus, the invention also comprises an improved Watts-type process that is robust for use with coated aluminum substrates and amenable to the incorporation into the plate of lead, bismuth or thallium, where said elements are not present in sufficient quantities in the coating to effectively serve as wetting agents in the braze. The improved process is characterized by an aqueous bath comprising nickel and ammonium in solution, and an acid sufficient to adjust the pH of such bath to acidic conditions, preferably, between about 3-7. Preferably, the acid is based on either or both of the anions of the nickel and ammonium in solution. A strong nickel chelating agent is also preferably provided, such as citrate and optionally edta. Advantageously, acetate and/or gluconate will be present to complex wetting agents such as bismuth and lead. The acidic conditions result in the predominance of ammonium ions in solution. The presentation of ammonium ions with soluble hydrated nickel can shift the equilibrium making ammoniacal nickel available to the cathodic surface and as shown in the alkaline baths, results in improved plating kinetics and bath life. Regardless of the presence of a highly acidic bulk solution, the buffering effect is enhanced at the cathode surface, reducing the propensity for hydroxide formation. Acid solutions can be prone to parasitic formation of hydrogen and the ammonia can effectively reduce the rate of hydrogen evolution by displacement from the surface of the cathode of the hydrogen proton and water. Citrate incrementally improves the nature of the nickel and/or nickel-lead deposit, even in small quantities, by stabilizing these species in the acidic environ. Particular embodiments are described in the following examples, the usefulness of which will be evident.

### Example 15

The coupon was immersed for 30 seconds in a zincating solution [ambient temperature] including 120 g/l sodium hydroxide, 20 g/l zinc oxide, 50 g/l Rochelle salt, 2 g/l ferric chloride hexahydrate and 1 g/l sodium nitrate to form a uniform zinc coating; tap water rinsed; and (a) nickel plated in a modified Watts bath including 150 g/l NiSO₄.6H₂O, 30 g/l NH₄Cl, 30 g/l H₃BO₃ [pH 4.8-5.2, by concentrated H₂SO₄, ambient temperature] at 50 mA/cm² for 60-90 seconds. The tube was not treated prior to arrangement on the coupon. A good braze was observed, (b) nickel-lead plated in the Watts bath with lead acetate added and plated at similar conditions, a good to excellent braze was observed. The plating bath became cloudy.

### Example 16

The coupon was immersed for 30 seconds in a zincating solution [ambient temperature] including 120 g/l sodium hydroxide, 20 g/l zinc oxide, 50 g/l Rochelle salt, 2 g/l ferric chloride hexahydrate and 1 g/l sodium nitrate to form a uniform zinc coating; tap water rinsed; and nickel-lead plated in a (a) modified Watts bath including 150 g/l NiSO₄.6H₂O, 30 g/l NH₄Cl, 30 g/l sodium citrate, 30 g/l H₃BO₃, 1.2 g/l lead acetate [pH 4.8-5.2, by concentrated H₂SO₄, ambient temperature] at 50 mA/cm² for 60-90 seconds. The tube was not treated prior to arrangement on the coupon. An excellent braze was observed, (b) modified Watts bath including 150 g/l NiSO₄.6H₂O, 30 g/l NH₄Cl, 30 g/l sodium gluconate, 30 g/l H₃BO₃, 1.2 g/l lead acetate [pH 4.8-5.2, by concentrated H₂SO₄, ambient temperature] at 50 mA/cm² for 60-90 seconds. The tube was not treated prior to arrangement on the coupon. An excellent braze was observed.

That is not to say that the traditional alkaline nickel or nickel-lead plating baths cannot also be utilized with the zincate bond layer as indicated by the following example.

### Example 17

The coupon was immersed for 30 seconds in a zincating solution [ambient temperature] including 120 g/l sodium hydroxide, 20 g/l zinc oxide, 50 g/l Rochelle salt, 2 g/l ferric chloride hexahydrate and 1 g/l sodium nitrate to form a uniform zinc coating; tap water rinsed; and (a) nickel plated in a bath including 70 g/l NiSO₄.6H₂O, 30 g/l NiCl₂. 6H₂O, 120 g/l sodium citrate, 20 g/l sodium acetate, 15 g/l (NH₄)₂SO₄ [pH 8.2, by 18 be NH₄OH] at 30 mA/cm² for 60 seconds. The tube was not treated prior to arrangement on the coupon. A good braze was observed, (b) nickel-lead plated in an alkaline bath including 70 g/l NiSO₄.6H₂O, 30 g/l NiCl₂.6H₂O, 120 g/l sodium citrate, 20 g/l sodium acetate, 15 g/l (NH₄)₂SO₄, 1.2 g/l lead acetate [pH 8.2, by 18 be NH₄OH] at 30 mA/cm² for 60 seconds. The tube was not treated prior to arrangement on the coupon. An excellent braze was observed.

As noted previously, nickel/citrate/ammonium plating formulations can effect a braze joint at moderately low pH values, even when the citrate composition drops to very low values.

### Example 18

The coupon was immersed for 30 seconds in a zincating solution [ambient temperature] including 120 g/l sodium hydroxide, 20 g/l zinc oxide, 50 g/l Rochelle salt, 2 g/l ferric chloride hexahydrate and 1 g/l sodium nitrate to form a uniform zinc coating; tap water rinsed; and (a) nickel plated in a bath including 100 g/l NiCl₂. 6H₂O, 70 g/l sodium citrate, 30 g/l NH₄Cl [pH 4, by HCl] at 50 mA/cm² for 60 seconds. The tube was not treated prior to arrangement on the coupon. A good braze was observed, (b) nickel-lead plated in an alkaline bath including 100 g/l NiCl₂.6H₂O, 70 g/l sodium citrate, 30 g/l NH₄Cl, 1.2 g/l lead acetate [pH 4, by HCl] at 50 mA/cm² for 70 seconds. The tube was not treated prior to arrangement on the coupon. An excellent braze was observed.

### Example 19

The coupon was immersed for 30 seconds in a zincating solution [ambient temperature] including 120 g/l sodium hydroxide, 20 g/l zinc oxide, 50 g/l Rochelle salt, 2 g/l ferric chloride hexahydrate and 1 g/l sodium nitrate to form a uniform zinc coating, tap water rinsed, and (a) nickel-lead plated in a bath including 100 g/l NiCl₂. 6H₂O, 5 g/l sodium citrate, 30 g/l NH₄Cl, 1.2 g/l lead acetate [pH 4, by HCl] at 50 mA/cm² for 60 seconds. The tube was not treated prior to arrangement on the coupon. A good braze was observed. (b) nickel-lead plated in a bath including 100 g/l NiCl₂.6H₂O, 150 g/l sodium citrate, 30 g/l NH₄Cl, 1.2 g/l lead acetate [pH 4, by HCl] at 50 mA/cm² for 60 seconds. The tube was not treated prior to arrangement on the coupon. An excellent braze was observed.

Similar test were carried out in relation to a coupons immersed in lead or bismuth solutions for 20 and 30 seconds, respectively.

### Example 20

The coupon was immersed for 30 seconds in a solution [ambient temperature] including 1.25% sodium hydroxide, 0.125% sodium gluconate and 1.0% lead acetate and nickel plated in a Watts bath [pH 3.8] including 262 g/l nickel sulfate, 45 g/l nickel chloride, 30 g/l boric acid at 25.5 mA/cm² for 2 minutes to a thickness of 0.82 μm. The tube was not treated prior to arrangement on the coupon. An excellent braze was observed.

### Example 21

The coupon was cleaned by immersion for 45 seconds in a solution containing 10% caustic, 1% sodium gluconate, tap water rinsed, immersed for 20 seconds in an ambient solution including 62.5 g/l sodium hydroxide, 1 g/l sodium gluconate, 0.6 g/l Bi₂O₃, tap water rinsed, nickel plated in a 35° C. alkaline bath including 70 g/l NiSO₄.6H₂O, 30 g/l NiCl₂.6H₂O, 120 g/l sodium citrate, 20 g/l sodium acetate, 15 g/l (NH₄)₂SO₄, [pH 8.2, by 18 be NH₄OH] at 25.5 mA/cm for 120 seconds. The tube was not treated prior to arrangement on the coupon. A good braze was observed.

### Example 22

The coupon was cleaned by immersion for 45 seconds in a solution containing 10% caustic,1% sodium gluconate, tap water rinsed, immersed for 20 seconds in an ambient solution including 250 g/l sodium hydroxide, 4 g/l sodium gluconate, 2.5 g/l Bi₂O₃, tap water rinsed, nickel plated in a 35° C. alkaline bath including 70 g/l NiSO₄.6H₂O, 30 g/l NiCl₂.6H₂O, 120 g/l sodium citrate, 20 g/l sodium acetate, 15 g/l (NH₄)₂SO₄, [pH 8.2, by 18 be NH₄OH] at 25.5 mA/cm² for 120 seconds. The tube was not treated prior to arrangement on the coupon. An excellent braze was observed.

It is further shown that stannate coatings offer excellent braze performance as a bonding layer for nickel plating.

### Example 23

The coupon was immersed for 2 minutes in a tinning solution [170° F.] including 45 g/l sodium stannate, 7.5 g/l sodium acetate then nickel-lead plated in an alkaline bath including 70 g/l NiSO₄.6H₂O, 30 g/l NiCl₂.6H₂O, 120 g/l sodium citrate, 20 g/l sodium acetate, 15 g/l (NH₄)₂SO₄, 1.2 g/l lead acetate [pH 8.2, by 18 be NH₄OH] at 30 mA/cm² for 2 minutes. The tube was not treated prior to arrangement on the coupon. An excellent braze was observed.

Of course, in circumstances wherein the bonding layer is lead, bismuth or thallium, the need for further lead in the braze-promoting layer is not present, such that lead can be omitted from the Dockus bath. As previously discussed, the bonding layer can consist entirely of zinc, tin, lead, bismuth, nickel, antimony and thallium, or combinations thereof. As such, the bonding layer can be a codeposit of, for example, zinc with lead, bismuth or thallium, or nickel with lead, bismuth or thallium, or zinc with nickel, or tin with nickel. Thus, as one aspect of the invention, it is contemplated that the bonding layer itself will contain by weight an amount up to 100%in total of one or more elements selected from bismuth, lead, thallium and antimony, balance zinc or tin. The following example is illustrative.

### Example 24

The coupon was etched in 10 wt. % Oakite 360 solution at ambient temperature for 45 seconds, tap water rinsed, deoxidized in 4% Oakite Deox PD-60-FC-22 for 7 seconds, tap water rinsed coated to a uniform zinc-lead coating by immersion for 10 seconds in a solution including 50 g/l ZnO, 10 g/l PbCO₃, 250 g/l NaOH, 3.5 g/l tartaric acid, 0.44 g/l FeCl₃ and approx. 10 g/l EDTA and nickel plated in an alkaline bath including 70 g/l NiSO₄.6H₂O, 30 g/l NiCl₂.6H₂O, 120 g/l sodium citrate, 20 g/l sodium acetate, 15 g/l (NH₄)₂SO₄, [pH 8.2, by 18 be NH₄OH] at 60 mA/cm² for 60 seconds at ambient temperature. The tube was not treated prior to arrangement on the coupon. An excellent braze was observed.

### Example 25

The coupon was immersed in (100 g/l sodium hydroxide, 50 g/l sodium potassium tartrate, 2 g/l iron chloride, 1 g/l sodium nitrate, 10 g/l ZnO, 2-3 g/l Bi₂O₃) for 10-20 s at ambient temperature. Followed by water rinsing, thence, nickel plating for 2 min at 25 mA/cm² using 70 g/l nickel sulfate, 30 g/l nickel chloride, 120 g/l sodium citrate, 20 g/l sodium acetate, 15 g/l ammonium sulfate and 30 ml ammonium hydroxide at pH 8.1. An excellent braze was observed.

This method can be embodied in various articles of manufacture, such as a brazing preform, ie a substrate of brazing alloy [aluminum having alloying agents so as to have a lower melting point than the aluminum components which are intended to be brazed]. Typical alloying agents include silicon, present at 2-18 wt. %, zinc, and magnesium, and combinations thereof, such as aluminum-magnesium-silicon, aluminum-zinc-silicon and aluminum-magnesium-silicon-zinc, formed in a wire, rod or sheet form and coated with the bonding layer and thence with braze-promoting layer, which may be interposed between aluminum parts formed of unclad aluminum, for subsequent brazing. Exemplary brazing preforms are shown schematically in FIG. 2, including a core layer, and in FIG. 3, in which no core layer is present.

The usefulness of such preforms is made evident with reference to the following examples:

### Example 26

An untreated .004″ substrate of 4047 alloy (12% silicon) was interposed between a coupon of AA3003 sheet and a tube of o-temper 3003 tube, and the arrangement was placed in a preheated furnace and heated in a nitrogen atmosphere to 110° F., dwell time of less than 1 minute. No braze was observed.

### Example 27

A substrate as per example 18 was immersed for 30 seconds in a zincating solution [ambient temperature] including 120 g/l sodium hydroxide, 20 g/l zinc oxide, 50 g/l Rochelle salt, 2 g/l ferric chloride hexahydrate and 1 g/l sodium nitrate, nickel-lead plated in a 35° C. alkaline bath including 70 g/l NiSO₄.6H₂O, 30 g/l NiCl₂.6H₂O, 120 g/l sodium citrate, 20 g/l sodium acetate, 15 g/l (NH₄)₂SO₄, 1.2 g/l lead acetate [pH 8.2, by 18 be NH₄OH] at 30 mA/cm² for 120 seconds. The tube was not treated prior to arrangement on the coupon. Good brazing was observed.

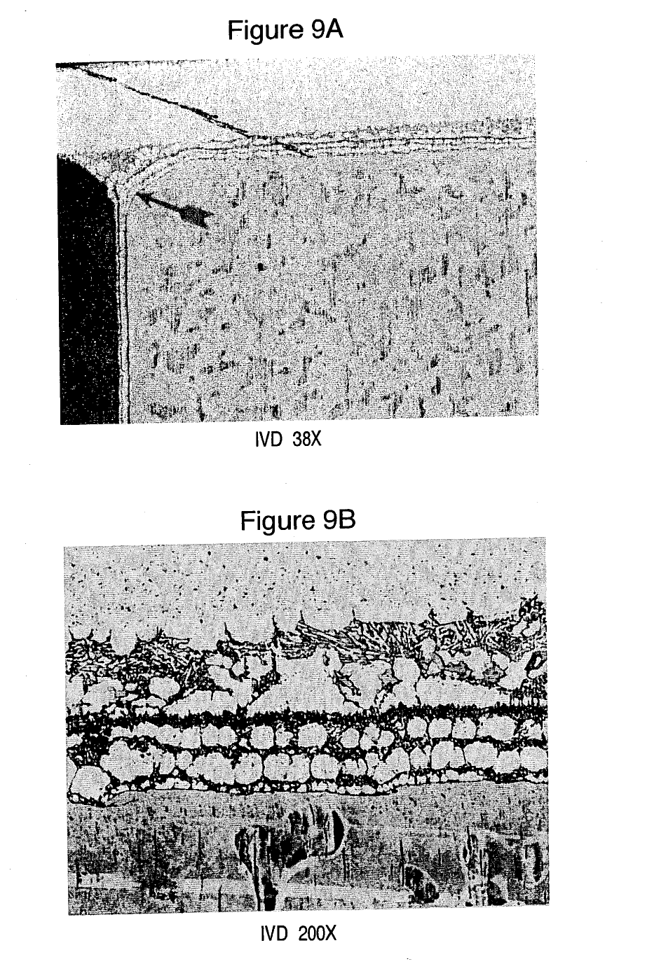

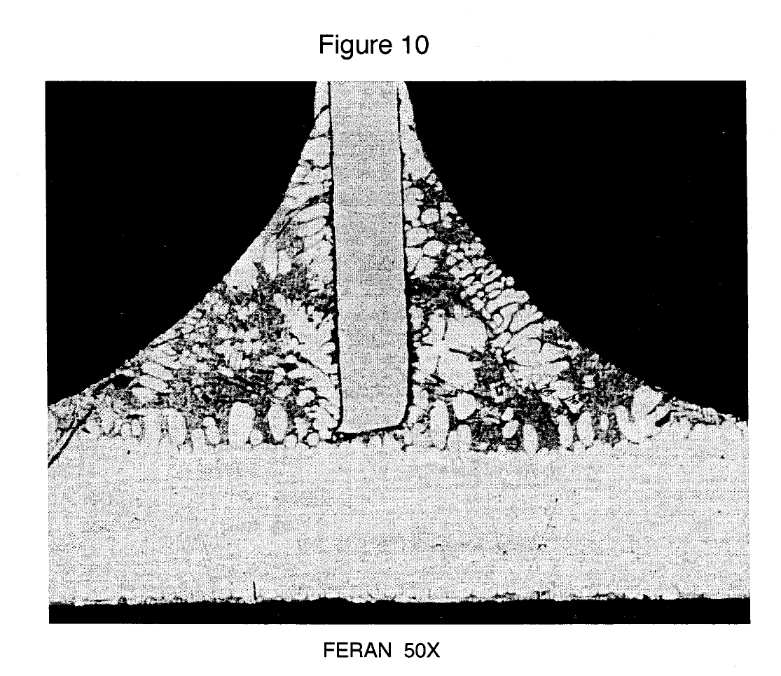

It has also unexpectedly been found that the brazing preform can be used to braze aluminum to aluminum or to any aluminized metal; nickel-coated titanium or steel or stainless steel to aluminum or to any aluminized metal; and nickel-coated titanium or steel or stainless steel to nickel-coated titanium or steel or stainless steel. Example braze joint structures on variously coated materials are shown in FIGS. 9-11.

### Example 28

A titanium plate sample was acid cleaned in a dilute HF solution for 20 seconds and nickel-lead plated in a bath including 70 g/l NiSO₄.6H₂O, 30 g/l NiCl₂.6H₂O, 120 g/l sodium citrate, 20 g/l sodium acetate, 15 g/l (NH₄)₂SO₄, 1.2 g/l lead acetate [pH 8.2, by 18 be NH₄OH] at 20 mA/cm² for 20 seconds, tap water rinsed and dried. The plate was sandwiched between two 0.006″ No 12 braze sheet coupons [clad with AA4343] nickel-lead plated in a bath including 155 g/l NiCl₂. 6H₂O, 108.6 g/l sodium citrate, 100 g/l NH₄Cl, 140 ml NH₄OH [29% solution], 1 g/l lead acetate [pH 7.8] at 25 mA/cm² for 120 seconds and brazed at 1120° F. An excellent braze was observed.

### Example 29

A titanium mesh sample was acid cleaned in a dilute HF solution for 20 seconds and nickel-lead plated in a bath including 70 g/l NiSO₄.6H₂O, 30 g/l NiCl₂.6H₂O, 120 g/l sodium citrate, 20 g/l sodium acetate, 15 g/l (NH₄)₂SO₄, 1.2 g/l lead acetate [pH 8.2, by 18 be NH₄OH] at 20 mA/cm² for 20 seconds, tap water rinse and dry. The mesh was sandwiched between two braze sheet coupons [Ravenswood K319 core, clad with AA4045+0.15% magnesium] nickel plated in a bath including 155 g/l NiCl₂. 6H₂O, 108.6 g/l sodium citrate, 100 g/l NH₄Cl, 140 ml NH₄OH [29% solution], 1 g/l lead acetate [pH 7.8] at 25 mA/cm² for 120 seconds and brazed at 1120° F. An excellent braze was observed. The titanium mesh acts as a reinforcement between the braze sheets, producing a strong, composite structure.

### Example 30

A roll bonded Feran™ sheet [Wickeder Westfalenstahl Ust3 steel core, 5% clad both sides with aluminum 0.8 silicon alloy] was cleaned and sandwiched between two No 12 braze sheet coupons [clad with M4343] which were nickel-lead plated in a bath including 70 g/l NiSO₄.6H₂O, 30 g/l NiCl₂.6H₂O, 120 g/l sodium citrate, 20 g/l sodium acetate, 15 g/l (NH₄)₂SO₄, 1.2 g/l lead acetate [pH 8.2, by 18 be NH₄OH] and brazed. An excellent braze joint was formed.

### Example 31

An Ivadized™ [IVD, ion vapour deposition] steel fitting was cleaned and mated to a No 12 braze sheet coupon [clad with AA4343] which was nickel-lead plated in a bath including 70 g/l NiSO₄.6H₂O, 30 g/l NiCl₂.6H₂O, 120 g/l sodium citrate, 20 g/l sodium acetate, 15 g/l (NH₄)₂SO₄, 1.2 g/l lead acetate [pH 8.2, by 18 be NH₄OH] and brazed. An excellent braze joint was formed.

However, more commonly, as schematically illustrated in FIG. 2, the method will be embodied in a brazing sheet product having a brazing sheet substrate, comprising an aluminum core 1 and a clad layer of brazing alloy 2; a bonding layer 3 on the clad layer 2, and a braze-promoting layer 4 on the bonding layer, which may be formed into a useful shape and brazed with similar objects. The usefulness of such brazing sheet products will be made evident with reference to the examples which follow.

### Example 32

For experimental convenience, plates for an engine oil cooler were initially stamped from .028″ #12 brazing sheet; immersed in a zincating solution [ambient temperature] including 120 g/l sodium hydroxide, 20 g/l zinc oxide, 50 g/l Rochelle salt, 2 g/l ferric chloride hexahydrate and 1 g/l sodium nitrate to form a uniform zinc coating; and nickel plated in a solution including 142 g/l nickel sulfate, 43 g/l ammonium sulfate, 30 g/l nickel chloride, 140 g/l sodium citrate and bismuth [Bi₂O₃ was dissolved in HCl and pipetted into bath—approximates 1-2 g/l of the soluble bismuth salt] at 65 mA/cm2 at for 90 s. Excellent brazing results were observed.

### Example 33

0.028″ brazing sheet [modified 3005, clad on both sides with 4045+0.2% Mg] was immersed for 45 seconds in heat bath ZA-3-9 commercial zincating solution; tap water rinsed; dried; recoiled; and nickel plated in a 35° C. alkaline bath including 70 g/l NiSO₄.6H₂O, 30 g/l NiCl₂.6H₂O, 120 g/l sodium citrate, 20 g/l sodium acetate, 15 g/l (NH₄)₂SO₄, 1.2 g/l lead acetate [pH 8.2, by 18 be NH₄OH] at 25 mA/cm² for 120 seconds. Components for a transmission oil cooler were stamped, assembled and brazed under production conditions which involved a braze cycle similar to that described in examples 1-11. An excellent braze was observed. Experimental testing established that, once zinc plated, the coil could be stored for a reasonable time period and then nickel plated without adverse effect.

While it is possible that substrates of a type suitable for direct deposition of the braze-promoting layer, that is, including core, clad and bonding layers, is now or will at some point be made commercially available, the method, of course, encompasses the preliminary step of applying the bonding layer on a “target” surface of a substrate, such as the surface of a conventional brazing sheet.

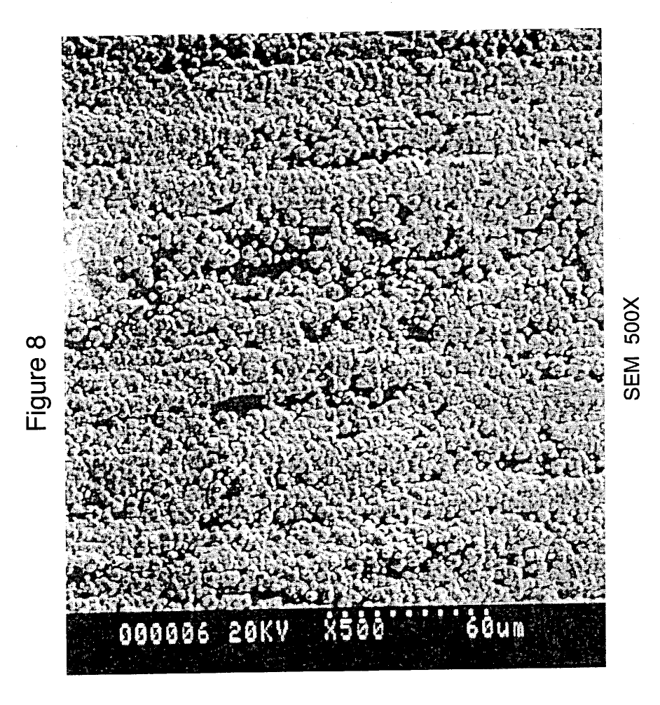

The bonding layer may be applied in any one (or more) of a variety of conventional application steps which are obvious to persons of ordinary skill in the plating arts. However, it has been unexpectedly found that if the method is extended such that the application of the bonding layer is preceded by a mechanical abrasion of the substrate, preferably, by brush cleaning the surface using commercially available flap brushes comprising nylon fibres impregnated with suitable ceramic particulates, or stainless steel brushes, such that the target surface defines a plurality of reentrant edges, it is possible to significantly increase the plating rate, as evidenced by the examples which follow. The sem micrograph of a mechanically brushed surface and nickel plated surface of brazing sheet alloy in FIG. 8 shows the excellent coverage and conformance to brush striations.

### Example 34

A coupon was mechanically abraded using a stainless steel brush, immersed in a zincating solution [ambient temperature] including 120 g/l sodium hydroxide, 20 g/l zinc oxide, 50 g/l Rochelle salt, 2 g/l ferric chloride hexahydrate and 1 g/l sodium nitrate for 15-20 seconds to form a uniform zinc coating and nickel plated in a 35° C. alkaline bath including 70 g/l NiSO₄.6H₂O, 30 g/l NiCl₂.6H₂O, 120 g/l sodium citrate, 20 g/l sodium acetate, 15 g/l (NH₄)₂SO₄, 1.2 g/l lead acetate [pH 8.2, by 18 be NH₄OH] at 25 mA/cm² for 60 seconds. An excellent brazing joint was observed.

### Example 35

A series of coupons as per example 22 were zincated as per example 22 in the absence of a mechanical abrasion or any other surface treatment, to determine the equivalent time needed to achieve the same uniform zinc coverage. A uniform zinc coating was not observed until 30 seconds had elapsed.

In another aspect of the invention, it has also been unexpectedly found that the aforementioned mechanical abrasion step conditions the surface of an aluminum substrate so as to improve its ability to directly receive a braze-promoting layer of a metal such as nickel or cobalt as deposited, inter alia, through the process described in U.S. Pat. No. 4,028,200.

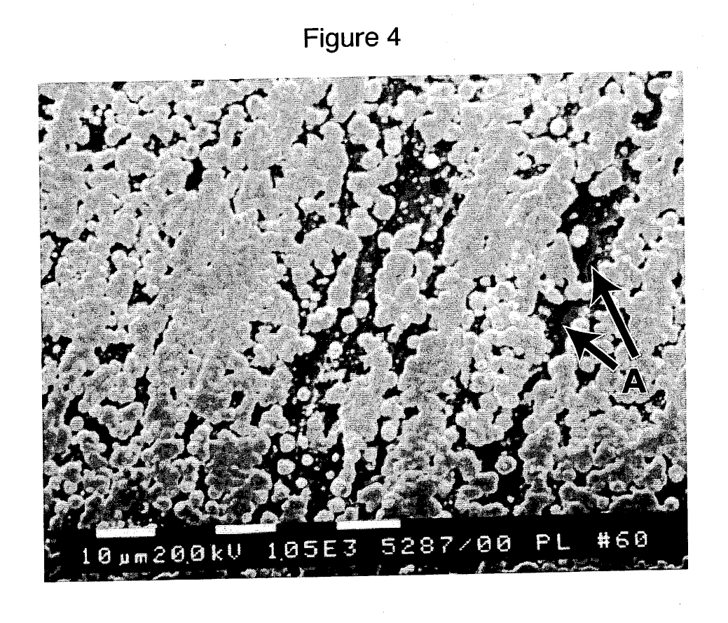

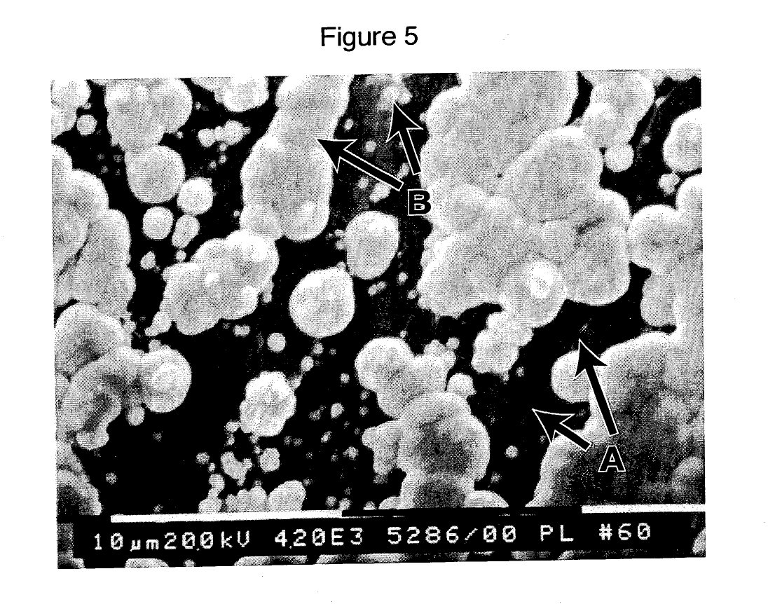

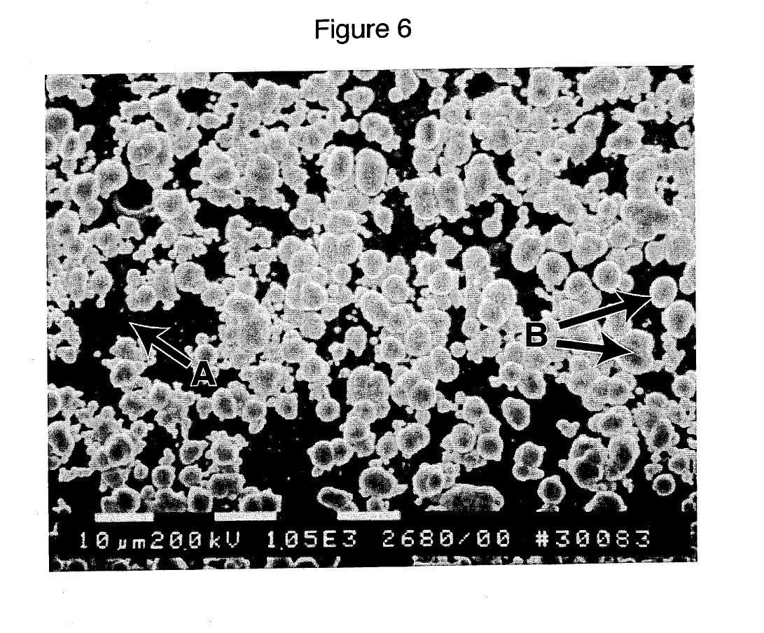

This increased ability is evident upon a comparison of FIGS. 4 and 6, which show, respectively, nickel deposits following brush cleaning, and in the absence of brush cleaning. The nickel deposits in the absence of brush cleaning, indicated by arrow b in FIG. 6, are clearly distributed in an irregular pattern across the surface of the substrate, indicated by arrow a, which pattern mirrors the location of silicon particles at or near the surface, which tend to promote nucleation of nickel. Complete coverage of the aluminum surface by the nickel is somewhat limited, in that nucleation of new ni nodules in the bare aluminum surface regions is more difficult in comparison to preferential nucleation on the silicon particles. In contrast, the pattern of nickel deposit following brush cleaning is in an even, striated pattern, which follows the bristle direction. This striated surface fosters improved nucleation of the plated deposit, leading to improved coverage as well as increased nucleation rate. In FIG. 5, for example, it is observed that fine ni nodules continue to grow in the striation regions even as larger nodules continue to grow. It is speculated that this more even distribution is resultant both from the presence of the reentrant edges, indicated by arrows a in FIGS. 4 and 5, which serve to lessen the likelihood that nucleated metals, indicated by arrow b in FIG. 5, will be dislodged, to reenter the solution, and, particularly in the case of nickel, from a tendency of the bristles to mottle the aluminum substrate but not substantially expose silicon particles, thereby lessening the likelihood that they will preferentially attract nickel. In the context of nickel-lead deposition, it is believed that this phenomena is even more pronounced, having regard to the ability of lead to plate preferentially as compared to nickel. Particularly, it has been established by auger surface analysis that, upon immersion of uncoated aluminum into a plating bath of the type described in U.S. Pat. No. 4,028,200, the initial deposit has a relatively high concentration of lead or bismuth. That is, to a certain extent, the U.S. Pat. No. 4,028,200 process plates as well as it does because it provides for its own “lead preplate” during the initial stages of plating. It therefore follows that a mechanical abrasion should improve plating speed of nickel-lead deposition, given that the initial, difficult nucleation step, that is, the “lead preplate” step, is itself expedited by mechanical abrasion.

In circumstances wherein the nickel is not intended to be plated directly on the aluminum substrate, it has been found that utilization of the plating process described in U.S. Pat. No. 4,208,200, which incorporates a generally alkaline bath, remains a viable option. The usefulness of this process in applying, on a zinc (tin, lead, etc.) Coated aluminum substrate, a nickel-lead layer that is amenable to fluxless brazing, is evidenced by the following:

### Example 36

A coupon was caustic cleaned for 45 seconds; tap water rinsed; and deoxidized in Oakite 125 for 10 seconds; tap water rinsed; and then immersed in a zinc displacement solution including 25% sodium hydroxide, 5% zinc oxide, for 10 seconds, at ambient temperatures, to achieve a uniform zinc coating and nickel plated in a 35° C. solution including 70 g/l NiSO₄.6H₂O, 30 g/l NiCl₂.6H₂O, 120 g/l sodium citrate, 20 g/l sodium acetate, 15 g/l (NH₄)₂SO₄ [pH 8.2, by 18 be NH₄OH] at 25 mA/cm² for 120 seconds. The tube was not treated prior to arrangement on the coupon. A fair braze was observed.

### Example 37

A coupon was caustic cleaned for 45 seconds; tap water rinsed; and deoxidized in Oakite 125 for 10 seconds; tap water rinsed; immersed in a zinc displacement solution including 25% sodium hydroxide, 5% zinc oxide, for 10 seconds, at ambient temperatures, to a uniform zinc coating; and nickel plated in a 35° C. solution including 70 g/l NiSO₄.6H₂O, 30 g/l NiCl₂.6H₂O, 120 g/l sodium citrate, 20 g/l sodium acetate, 15 g/l (NH₄)₂SO₄ and 1.2 g/l lead acetate [pH 8.2, by 18 be NH₄OH] at 25 mA/cm² for 120 seconds. The tube was not treated prior to arrangement on the coupon. An excellent braze was observed.

### Example 38

A coupon was etched in a 10% caustic, 1% sodium gluconate solution for 45 seconds; tap water rinsed; and immersed in a solution including 250 g/l sodium hydroxide, 4 g/l sodium gluconate, 2.5 g/l Bi₂O₃ for 20 seconds, at ambient temperatures, to a uniform bismuth coating; and nickel plated in a 35° C. solution including 70 g/l NiSO₄.6H₂O, 30 g/l NiCl₂.6H₂O, 120 g/l sodium citrate, 20 g/l sodium acetate, 15 g/l (NH₄)₂SO₄ [pH 8.2, by 18 be NH₄OH] at 25 mA/cm² for 120 seconds. The tube was not treated prior to arrangement on the coupon. An excellent braze was observed.sdf

### Example 39

Table 1 indicates how various combinations of braze filler metal can reduce melting temperatures as aluminum concentrations decrease and zinc concentrations increase, with a sharp temperature decrease occurring at the eutectic at 4% aluminum-96% zinc.

TABLE 1

| Al (%) | Zn (%) | Si (%) | Pb (%) | Ta (%) | Bi (%) | ° F. |
|---|---|---|---|---|---|---|
| 0.0 | 100.0 | — | — | — | — | 786 |
| 4.0 | 96.0 | — | — | — | — | 720 |
| 3.5 | 95.0 | — | 1.5 | — | — | 752 |
| 13.0 | 85.3 | 1.2 | — | 0.5 | — | 800 |
| 20.5 | 76.0 | 2.0 | — | — | 1.5 | 850 |
| 29.0 | 66.0 | 3.0 | 2.0 | — | — | 885 |
| 38.2 | 57.0 | 4.8 | — | — | — | 910 |
| 46.5 | 47.5 | 6.0 | — | — | — | 950 |
| 54.8 | 38.0 | 7.2 | — | — | — | 985 |
| 63.1 | 28.5 | 8.4 | — | — | — | 1015 |
| 88.2 | — | 11.8 | — | — | — | 1100 |

The alloys shown in Table 1 were prepared experimentally by casting, rolled into sheet, and then used to determine a successful melting range and also wetting and spreading characteristics. These experiments showed that the introduction of an increasing percentage of zinc to the traditional eutectic aluminum-silicon filler alloy, reduced the melting temperature of the new brazing alloy. The wetting and spreading tests also proved that the zinc-aluminum-silicon systems according to the invention yield alloys feasible for the fluxless brazing of die castings and other components in the neighborhood of 730 to 1130° F., more preferably 750 to 1050° F., as compared to 1080 to 1175° F. for the presently used commercial aluminum-silicon filler metals.

In addition to the aforementioned alloying elements, the brazing composition of the alloys shown in the table may include minor elements and impurities amounts of up to 1.0% iron, 0.25% titanium, 0.25% manganese, 0.2% copper, 0.3% magnesium, etc.

### Example 40

Several tensile strength measurements were made with brazed lap specimens, using zinc alone and zinc with nickel-lead plated zinc as filler materials (table 2) to bond type 3003 aluminum to 3003 aluminum.

With respect to the various tests, nos. 1 through 5 uses aluminum type 3003 and zinc foil that is 0.38 mm. thick and nos. 6 through 11 utilize zinc foil which is 0.10 mm. thick. The braze tests were run with type 3003 aluminum as a lap joint with a small sheet of zinc placed between the 3003 aluminum pieces. As shown in table 2, the electroplated nickel-lead on zinc greatly improved the braze quality and strength and made it possible to lower the braze temperature to 900° F.

TABLE 2

| | Filler | Zinc Thickness | Braze | Braze Temp. | Braze | Tensile |
|---|---|---|---|---|---|---|
| No. | Material | (mm) | Promoter | (° F.) | Quality | Strength (lb) |
| 1 | Zinc | 0.38 | — | 1120 | Good | 455 |
| 2 | Zinc | 0.38 | Ni—Pb | 950 | Good | 490 |
| 3 | Zinc | 0.38 | — | 950 | Poor | 90 |
| 4 | Zinc | 0.38 | Ni—Pb | 900 | Good | 548 |
| 5 | Zinc | 0.38 | — | 900 | Poor | 80 |
| 6 | Zinc | 0.10 | — | 900 | No Braze | — |
| 7 | Zinc | 0.10 | Ni—Pb | 900 | Good | 536 |
| 8 | Zinc | 0.10 | — | 950 | No Braze | — |
| 9 | Zinc | 0.10 | — | 1000 | No Braze | — |
| 10 | Zinc | 0.10 | — | 1050 | No Braze | — |
| 11 | Zinc | 0.10 | — | 1100 | Poor | <100 |

### Example 41

A second group of tests were conducted as in Example 2 but with a shorter lap joint in the order of 0.25 inches using 3003 aluminum specimens. For all tests, a small piece of zinc metal was placed between the aluminum specimens and, as shown in table 3, the braze temperature was lowered to 800° F. when nickels lead was electroplated on the zinc spacer.

TABLE 3

| | Filler | Braze | Braze Temp. | | Tensile |
|---|---|---|---|---|---|
| No. | Material | Promoter | (° F.) | Braze Quality | Strength (lb) |
| 1 | Zinc | Ni—Pb | 850 | Good | 648 |
| 2 | Zinc | Ni—Pb | 800 | Good | 580 |
| 3 | Zinc | — | 1100 | Poor | 136 |
| 4 | Zinc | Ni—Pb | 900 | Good | 516 |
| 5 | Zinc | — | 1000 | No Braze | — |

### Example 42

In additional testing, small samples of zinc alloys were prepared in a tube furnace and in an arc-melting chamber. The alloys were then roll milled to form thin sheets and braze tests were run with the thin alloy sheet placed between a 3003 aluminum tube and plate. Results of these tests are shown in table 4 and show some variations in braze quality.

TABLE 4

| | | Filler Material % Comp. | | | Braze | Thickness | Braze Tem. | Braze |
|---|---|---|---|---|---|---|---|---|
| No. | Alloy | Zn | Al | Si | Promoter | (mils) | (° F.) | Quality |
| 1 | I | 100 | — | — | Ni—Pb | 9 | 820 | Excel. |
| 2 | I | 100 | — | — | — | 9 | 900 | Poor |
| 3 | VI | 100 | — | — | Ni—Pb | 15 | 820 | Good |
| 4 | III | 90 | 8.8 | 1.2 | Ni—Pb | 10 | 1000 | Good |
| 5 | V | 90 | 8.8 | 1.2 | Ni—Pb | 14 | 1000 | Excel. |
| 6 | V | 90 | 8.8 | 1.2 | Ni—Pb | 14 | 900 | Excel. |
| 7 | V | 90 | 8.8 | 1.2 | Ni—Pb | 14 | 850 | Good |

With respect to the alloys listed in table 4, alloys I & III were arc melted, and alloys V & VI were cast in air and the center (non oxidized) section was used. It appears from the above cited results and from additional testing to be disclosed that the braze quality is good to excellent even with the zinc-aluminum-silicon alloy if the nickel-lead promoter is added.

Further test results of zinc-aluminum-silicon-alloy braze joints are listed in table 5.

TABLE 5

| | | Filler Material | | | | | | |
|---|---|---|---|---|---|---|---|---|
| | | % Composition | | | Thickness | Braze | Braze | Braze |
| No. | Alloy | Zn | Al | Si | (mils) | Promoter | Temp. (° F.) | Quality |
| 1 | VII | 100 | — | — | 5 | Ni—Pb | 900 | Good |
| 2 | VII | 100 | — | — | 5 | — | 900 | Poor |
| 3 | VIII | 100 | — | — | 5 | Ni—Pb | 900 | Good |
| 4 | IX | 100 | — | — | 6 | Ni—Pb | 900 | Good |
| 5 | XI | 98 | 2 | — | 5 | Ni—Pb | 900 | Excellent |
| 6 | XI | 98 | 2 | — | 5 | — | 900 | No braze |
| 7 | VIII & XII | 90 | 8.8 | 1.2 | 4 | Ni—Pb | 900 | Good |
| 8 | VIII & XII | 90 | 8.8 | 1.2 | 7 | Ni—Pb | 900 | Fair |
| 9 | VIII & XII | 90 | 8.8 | 1.2 | 7 | — | 900 | No Braze |

With respect to the alloys shown in column 2, alloy VII is zinc received from Alpha Co.; alloy VIII is Alpha Co. zinc melted in a nitrogen furnace at 900° F. and roll milled to a thin sheet; alloy IX is zinc wire from Tafa Co. melted in a furnace with a nitrogen atmosphere at 900° F. followed by rolling to a thin sheet; alloy XI is a metal strip 0.022 inches thick containing 98% zinc and 2% aluminum; and alloy XII is a cast alloy consisting of 88% aluminum and 12% silicon, again roll milled into a thin sheet.

### Example 43

Braze tests were also conducted using a type 3003 aluminum tube on aluminum sheet with pure zinc, 98 zinc -2 aluminum, and 90 zinc -8.8 aluminum-1.2 silicon shim stock as a filler material. Good braze joints were obtained from nickel-lead plating the filler material, while a poor joint was obtained without the nickel plate.

### Example 44

To determine whether any differences exist, between nickel plate on zinc and nickel-lead plate on zinc, another series of braze and tensile tests were conducted using aluminum alloys AA2024, 3003, 5052 and 7075. The aluminum thickness of the tensile bars was increased to 0.090 inch make the break more likely occur at the braze joint than in the aluminum price. A small section (0.75×0.20×0.045 inch) was cut out of the aluminum bar (2.0×0.75×0.090 inch) for placing the zinc between the two mating tensile bars. The samples were brazed at 800 or 825° f. As shown in tables 6-13 the tensile strength increased in all tests when the zinc was electroplated with nickel and lead.

TABLE 6
Tensile Strength Measurements with Zinc* and Aluminum 2024** Brazed
at 800° F.

| | | | | Tensile | |
|---|---|---|---|---|---|
| Test | Aluminum | Metal Plated on | Braze | Strength | Break |
| No. | Cleaning | Zinc | Quality | (pounds) | Point*** |
| 24-1 | Acetone | — | No braze | — | — |
| 24-2 | Acetone | — | No braze | — | — |
| 24-3 | Acetone | Nickel | Good | 210 | BJ |
| 24-4 | Acetone | Nickel | Good | 288 | BJ |
| 24-5 | Acetone | Ni—Pb | Good | 456 | BJ |
| 24-6 | Acetone | Ni—Pb | Good | 590 | Al Alloy |
| 24-7 | Caustic | — | Good | 32 | BJ |
| 24-8 | Caustic | — | Good | 168 | BJ |
| 24-9 | Caustic | Nickel | Good | 568 | BJ |
| 24-10 | Caustic | Nickel | Good | 800+ | Al Alloy |
| 24-11 | Caustic | Ni—Pb | Good | 616 | BJ |

*Zinc Shim Stock Size (in) = 0.2 × 0.75 × 0.015
**Aluminum Specimen Size (in) = 2 × 0.75 × 0.09 with cut-out of 0.2 × 0.75 × 0.045
***BJ-break occurred at the braze joint

TABLE 7
Tensile Strength Measurements with Zinc* and Aluminum 2024** Brazed
at 825° F.

| | | | | Tensile | |
|---|---|---|---|---|---|
| Test | Aluminum | Metal Plated on | Braze | Strength | Break |
| No. | Cleaning | Zinc | Quality | (pounds) | Point*** |
| 31-1 | Acetone | — | No braze | — | |
| 31-2 | Acetone | — | No braze | — | |
| 31-3 | Acetone | Nickel | Good | 280 | BJ |
| 31-4 | Acetone | Nickel | Good | 200 | BJ |
| 31-5 | Acetone | Ni—Pb | Fair | 570 | Al Alloy |
| 31-6 | Acetone | Ni—Pb | Good | 570 | Al Alloy |
| 31-7 | Caustic | — | Poor | 80 | BJ |
| 31-8 | Caustic | — | Poor | 60 | BJ |
| 31-9 | Caustic | Nickel | Good | 350 | BJ |
| 31-10 | Caustic | Nickel | Good | 370 | BJ |
| 31-11 | Caustic | Ni—Pb | Good | 620 | Al Alloy |
| 31-12 | Caustic | Ni—Pb | Good | 660 | Al Alloy |

*Zinc Shim Stock Size (in) = 0.2 × 0.75 × 0.015
**Aluminum Specimen Size (in) = 2 × 0.75 × 0.09 with cut-out of 0.2 × 0.75 × 0.045
***BJ-break occurred at the braze joint

TABLE 8
Tensile Strength Measurements with Zinc* and Aluminum 3003** Brazed
at 800° F.

| | | | | Tensile | |
|---|---|---|---|---|---|
| Test | Aluminum | Metal Plated on | Braze | Strength | Break |
| No. | Cleaning | Zinc | Quality | (pounds) | Point*** |
| 25-1 | Acetone | — | No braze | — | — |
| 25-2 | Acetone | — | No braze | — | — |
| 25-3 | Acetone | Nickel | Good | 280 | BJ |
| 25-4 | Acetone | Nickel | Good | 40 | BJ |
| 25-5 | Acetone | Ni—Pb | Good | 445 | Al Alloy |
| 25-6 | Acetone | Ni—Pb | Good | 430 | Al Alloy |
| 25-7 | Caustic | — | Good | 75 | BJ |
| 25-8 | Caustic | — | Good | 300 | BJ |
| 25-9 | Caustic | Nickel | Good | 370 | BJ |
| 25-10 | Caustic | Nickel | Good | 365 | BJ |
| 25-11 | Caustic | Ni—Pb | Good | 510 | Al Alloy |

*Zinc Shim Stock Size (in) = 0.2 × 0.75 × 0.015
**Aluminum Specimen Size (in) = 2 × 0.75 × 0.09 with cut-out of 0.2 × 0.75 × 0.045
***BJ-break occurred at the braze joint

TABLE 9
Tensile Strength Measurements with Zinc* and Aluminum 3003** Brazed
at 825° F.

| | | | | Tensile | |
|---|---|---|---|---|---|
| Test | Aluminum | Metal Plated on | Braze | Strength | Break |
| No. | Cleaning | Zinc | Quality | (pounds) | Point*** |
| 30-1 | Acetone | — | No braze | — | — |
| 30-2 | Acetone | — | No braze | — | — |
| 30-3 | Acetone | Nickel | Good | 430 | BJ |
| 30-4 | Acetone | Nickel | Good | 250 | BJ |
| 30-5 | Acetone | Ni—Pb | Good | 460 | Al Alloy |
| 30-6 | Acetone | Ni—Pb | Good | 470 | Al Alloy |
| 30-7 | Caustic | — | No braze | — | — |
| 30-8 | Caustic | — | No braze | — | — |
| 30-9 | Caustic | Nickel | Good | 310 | BJ |
| 30-10 | Caustic | Nickel | Good | 150 | BJ |
| 30-11 | Caustic | Ni—Pb | Good | 480 | Al Alloy |
| 30-12 | Caustic | Ni—Pb | Good | 470 | Al Alloy |

*Zinc Shim Stock Size (in) = 0.2 × 0.75 × 0.015
**Aluminum Specimen Size (in) = 2 × 0.75 × 0.09 with cut-out of 0.2 × 0.75 × 0.045
***BJ-break occurred at the braze joint

TABLE 10
Tensile Strength Measurements with Zinc* and Aluminum 5052** Brazed
at 800° F.

| | | | | Tensile | |
|---|---|---|---|---|---|
| Test | Aluminum | Metal Plated on | Braze | Strength | Break |
| No. | Cleaning | Zinc | Quality | (pounds) | Point*** |
| 27-1 | Acetone | — | Poor | 55 | BJ |
| 27-2 | Acetone | — | No braze | — | — |
| 27-3 | Acetone | Nickel | Good | 385 | BJ |
| 27-4 | Acetone | Nickel | Good | 380 | BJ |
| 27-5 | Acetone | Ni—Pb | Good | 665 | BJ |
| 27-6 | Acetone | Ni—Pb | Good | 575 | BJ |
| 27-7 | Caustic | — | Fair | 90 | BJ |
| 27-8 | Caustic | — | Fair | 60 | BJ |
| 27-9 | Caustic | Nickel | Good | 420 | BJ |
| 27-10 | Caustic | Nickel | Good | 210 | BJ |
| 27-11 | Caustic | Ni—Pb | Good | 640 | BJ |
| 27-12 | Caustic | Ni—Pb | Good | 510 | BJ |

*Zinc Shim Stock Size (in) = 0.2 × 0.75 × 0.015
**Aluminum Specimen Size (in) = 2 × 0.75 × 0.09 with cut-out of 0.2 × 0.75 × 0.045
***BJ-break occurred at the braze joint

TABLE 11
Tensile Strength Measurements with Zinc* and Aluminum 5052** Brazed
at 825° F.

| | | | | Tensile | |
|---|---|---|---|---|---|
| Test | Aluminum | Metal Plated on | Braze | Strength | Break |
| No. | Cleaning | Zinc | Quality | (pounds) | Point*** |
| 32-1 | Acetone | — | Good | 110 | BJ |
| 32-2 | Acetone | — | Good | 80 | BJ |
| 32-3 | Acetone | Nickel | Good | 50 | BJ |
| 32-4 | Acetone | Nickel | Good | 180 | BJ |
| 32-5 | Acetone | Ni—Pb | Good | 800 | BJ |
| 32-6 | Acetone | Ni—Pb | Good | 630 | BJ |
| 32-7 | Caustic | — | Good | 240 | BJ |
| 32-8 | Caustic | — | No braze | — | — |
| 32-9 | Caustic | Nickel | | | |
| 32-10 | Caustic | Nickel | Good | 360 | BJ |
| 32-11 | Caustic | Ni—Pb | Good | 880 | Al Alloy |
| 32-12 | Caustic | Ni—Pb | Good | 680 | BJ |

*Zinc Shim Stock Size (in) = 0.2 × 0.75 × 0.015
**Aluminum Specimen Size (in) = 2 × 0.75 × 0.09 with cut-out of 0.2 × 0.75 × 0.045
***BJ-break occurred at the braze joint

TABLE 12
Tensile Strength Measurements with Zinc* and Aluminum 7075** Brazed
at 800° F.

| | | | | Tensile | |
|---|---|---|---|---|---|
| Test | Aluminum | Metal Plated on | Braze | Strength | Break |
| No. | Cleaning | Zinc | Quality | (pounds) | Point*** |
| 34-1 | Acetone | — | No braze | — | — |
| 34-2 | Acetone | — | No braze | — | — |
| 34-3 | Acetone | Nickel | Good | 360 | BJ |
| 34-4 | Acetone | Nickel | Good | 40 | BJ |
| 34-5 | Acetone | Ni—Pb | Good | 680 | BJ |
| 34-6 | Acetone | Ni—Pb | Good | 680 | BJ |
| 34-7 | Caustic | — | No braze | — | — |
| 34-8 | Caustic | — | No braze | — | — |
| 34-9 | Caustic | Nickel | Good | 390 | BJ |
| 34-10 | Caustic | Nickel | Good | 430 | BJ |
| 34-11 | Caustic | Ni—Pb | Good | 700 | BJ |
| 34-12 | Caustic | Ni—Pb | Good | 770 | BJ |

*Zinc Shim Stock Size (in) = 0.2 × 0.75 × 0.015
**Aluminum Specimen Size (in) = 2 × 0.75 × 0.09 with cut-out of 0.2 × 0.75 × 0.045
***BJ-break occurred at the braze joint

TABLE 13
Tensile Strength Measurements with Zinc* and Aluminum 7075** Brazed
at 825° F.

| | | | | Tensile | |
|---|---|---|---|---|---|
| Test | Aluminum | Metal Plated on | Braze | Strength | Break |
| No. | Cleaning | Zinc | Quality | (pounds) | Point*** |
| 33-1 | Acetone | — | No braze | — | — |
| 33-2 | Acetone | — | Good | 20 | BJ |
| 33-3 | Acetone | Nickel | Good | 20 | BJ |
| 33-4 | Acetone | Nickel | Good | 460 | BJ |
| 33-5 | Acetone | Ni—Pb | Good | 610 | Al Alloy |
| 33-6 | Acetone | Ni—Pb | Good | 600 | Al Alloy |
| 33-7 | Caustic | — | Good | 180 | BJ |
| 33-8 | Caustic | — | Good | 30 | BJ |
| 33-9 | Caustic | Nickel | Good | 480 | BJ |
| 33-10 | Caustic | Nickel | Good | 650 | BJ |
| 33-11 | Caustic | Ni—Pb | Good | 715 | Al Alloy |
| 33-12 | Caustic | Ni—Pb | Good | 770 | BJ |

*Zinc Shim Stock Size (in) = 0.2 × 0.75 × 0.015
**Aluminum Specimen Size (in) = 2 × 0.75 × 0.09 with cut-out of 0.2 × 0.75 × 0.045
***BJ-break occurred at the braze joint

### Example 45

Additional tests were performed on AA6061 and AA6262 aluminum transmission oil cooler fittings for brazing to non-clad type 3003 aluminum, using zinc filler metal. (Table 14). The zinc was plated with standard Long Manufacturing nickel plating solution and all samples were brazed at 800° F. in a laboratory furnace. The two samples that were not nickel-plated did not braze well, indicating that nickel-lead plating on zinc was needed for an acceptable braze joint as shown in Table 14.

TABLE 14

| | Fitting Size | Filler | Braze | |
|---|---|---|---|---|
| Test No. | OD × ID × HT | Material | Promoter | Braze Quality |
| 1 | 1.22 × 0.43 × 0.43 | Zinc | Ni—Pb | Good |
| 3 | 1.22 × 0.50 × 1.58 | Zinc | Ni—Pb | Excellent |
| 5 | 1.22 × 0.43 × 0.43 | Zinc | — | No Braze |
| 6 | 1.30 × 0.57 × 0.72 | Zinc | Ni—Pb | Excellent |
| 7 | 1.30 × 0.57 × 0.72 | Zinc | — | Fair |
| 8 | 1.22 × 0.50 × 1.58 | Zinc | Ni—Pb | Good |

The zinc was in the form of a 0.38 mm. (0.15 inch) thick foil from BDH Chemicals.

### Example 46

Also tested were two thermal spray techniques for applying metallic coatings, flame spray and electric arc spray. The metals, (zinc and aluminum12% silicon, in wire form) were vaporized or melted and atomized to form coatings on AA3003 aluminum using the electric-arc process in a nitrogen atmosphere. They were sprayed from a distance of 8 inches with the electric power controlled at approximately 22 to 25 volts and 100+ amps. Braze tests were run using 3003 aluminum tubes placed on top of the thermal spray coated coupons. The best results were obtained with thermal sprayed zinc, or aluminum-12% silicon alloy subsequently electroplated with a nickel-lead coating and brazed at 900° f. (see table 15). However, the braze quality was poorer than that obtained using nickel-plated zinc shim stock.

TABLE 15

| | | |
|---|---|---|
| Thermal Spray | | |
| Metal Coating | Braze | Braze |

| Test No. | First Layer | Top Layer | Promoter | Quality |
|---|---|---|---|---|
| 1 | Zinc | — | — | Poor |
| 2 | Zinc | — | Ni—Pb | Fair |
| 3 | Zinc | Al-12% | — | Poor |
| 4 | Zinc | Al-12% | Ni—Pb | Fair |

### Example 47

Braze tests were run with aluminum tubing sections on top of 3003 aluminum sheet with powder metal at the tubing sheet joint.

With zinc and nickel powder metals the best braze quality was obtained with a powder metal composition of 3 to 4% nickel and 96-97% zinc. The inner diameter braze joint showed excellent fillet formation compared with the outer diameter. Without zinc, using mixtures of aluminum, silicon and nickel powder, it was found necessary to increase the temperature and time to obtain good braze joints. The best braze joints were obtained with powder compositions of 50 to 70% aluminum, 11 to 17% silicon and 13 to 33% nickel. When silicon powder was omitted from the aluminum-silicon-nickel mix, no brazing occurred.

### Example 48

Braze tests were run with copper and copper alloy substrates, using zinc and zinc-aluminum filler materials. This included limited trials of copper plating as a transient barrier coating for zinc diffusion, to limit formation of brittle compounds.

TABLE 16
Results of braze test on copper and copper alloy substrates

| | | Filler Metal | Braze | | |
|---|---|---|---|---|---|
| | | (0.38 mm thick | Promoter | Braze | |
| Test No | Substrate | Shim Washer) | Coating | Temperature | Braze Quality |
| 1 | C24000 Brass | Zn | None | 850 F. | Fair |
| 2 | ″ | ″ | ″ | 800 F. | Good |
| 3 | ″ | Zn | Ni—Pb | 850 F. | Good |
| 4 | ″ | ″ | ″ | 800 F. | Excellent |
| 5 | C26000 Brass | Zn | None | 850 F. | Fair |
| 6 | ″ | ″ | Ni—Pb | 800 F. | Excellent |

Braze time was 4-5 minutes up to temperature

TABLE 17
More Copper Alloy Substrate Results

| | | | | | Braze Quality at |
|---|---|---|---|---|---|
| Test No | Tube | Plate | Filler Metal | Braze Promoter | 825 F. |
| 67-1 & 2 | C11000 | C11000 | Zn Foil | None | Poor |
| 67-3 & 4 | ″ | ″ | ″ | Ni | Poor |
| 67-5 & 6 | ″ | ″ | ″ | Ni—Pb | Good |
| 69-1 & 2 | ″ | C26000 | ″ | None | Poor |
| 69-3 & 4 | ″ | ″ | ″ | Ni | Poor |
| 69-5 & 6 | ″ | ″ | ″ | Ni—Pb | Good |

Note;
Zn foil 0.10″ thick, 1″ × 1″ shim

TABLE 18
Tensile Results for C26000 Brass Brazed with Zinc Filler Metal, at 850 F.

| | Substrate | Braze Promoter | | Tensile Strength | |
|---|---|---|---|---|---|
| Test No | Thickness | Coating | Braze Quality | (lbs) | Break Point |
| 47-1 | 0.093 in | None | Good | 465 | BJ |
| -2 | ″ | ″ | ″ | 340 | ″ |
| -3 | ″ | Ni | ″ | 445 | ″ |
| -4 | ″ | ″ | ″ | 415 | ″ |
| -5 | ″ | Ni—Pb | ″ | 410 | ″ |
| -6 | ″ | ″ | ″ | 390 | ″ |
| 47-7 | ″ | Cu | ″ | 405 | ″ |
| 47-9 | ″ | Cu/Ni | ″ | 380 | ″ |
| -10 | ″ | ″ | ″ | 510 | ″ |
| -11 | ″ | Cu/Ni—Pb | ″ | 510 | ″ |
| 47-12 | ″ | ″ | ″ | 560 | ″ |

While 850 F. is not necessarily the best discriminating temperature, these examples show: zinc alone can braze copper in nitrogen, at temperatures of 850° F. and above, addition of Ni coating does not appear to significantly help, in this particular case (ie pure zinc, and copper substrate), addition of Ni—Pb coating significantly improves wetting and braze quality at low temperature tested, for zinc alloy filler metals, for example Zn 2% aluminum, and for copper alloy substrates such as C260 brass, in case of brass substrates, zinc alone has somewhat degraded braze quality vs copper; increasing zinc content in brass causes decrease in strength or increased brittleness; especially going to C260, and then C360 leaded brass fittings (not shown). Use of Cu barrier coating in combination with Ni or Ni—Pb coating, seems to significantly increase strength, when brazed at 850 F. Presumably this is because the Cu plating acts as a barrier to delay formation of Zn-rich intermetallics. In this example, the copper barrier coatings were applied to the zinc shim filler metal by electroplating copper from a copper pyrophosphate plating bath; and, in some tests, by subsequently applying a Ni—Pb electroplate on top of the copper.

### Example 49

Braze tests were run with aluminum eutectic casting, alloy A 413.1. The casting was machined into elongated pieces and configured as a lap joint for brazing. Brazing was in nitrogen, with approximately 5 minutes at braze temperature. In all cases, Ni—Pb was plated with a standard Long Manufacturing plating bath composition.

The results of these braze tests are shown below in Table 19.

TABLE 19

| Sample | | | | |
|---|---|---|---|---|
| Particulars | 71-5 | 71-6 | 71-7 | 74-6 |
| Substrate | Ni/Pb plated | None | Ni/Pb plated | Ni/Pb plated |
| Treatment | | | | |
| Filler Metal | Zn | Zn 2% Al | Zn 2% Al | Zn 2% Al |
| Alloy | | | | |
| Filler Metal | Ni/Pb plated | Ni/Pb plated | Ni/Pb plated | Ni/Pb plated |
| Treatment | | | | |
| Braze Temp | 900 F. | 900 F. | 900 F. | 950 F. |

### Example 50

A coupon of #12 brazing sheet (clad with 4343 alloy) was treated by zincating, and then applying an electroplated Ni—Pb bonding layer [20 sec plating time, Ref P1]; immediately following this, the coupon was electroplated for 1-3 minutes in a Zinc Plating bath [Ref P3]; and then plated with Ni—Pb , for an additional 1 minute. The plated coupon was assembled against the cut end of an AA3003 tube (untreated), and fluxless brazed in flowing nitrogen at 1110 f. An excellent braze joint was obtained.

### Example 51

Samples of a HydroGalv™ zinc coated aluminum tube extrusion (without preflux) were obtained from Hydro Aluminum Co (extrusion as-supplied was arc-sprayed with zinc to a thickness of approximately 4-6 microns). Sample pieces of these tubes were place in overlapping contact with a) each other, ie mating faces were zinc coated, b) untreated #12 brazing sheet, and c) a brazing sheet clad with 4045+0.2% Mg, and plated with Ni—Pb [2 minute electroplate, Ref P1] the test specimens were then subjected to a braze cycle to 1120 F. in flowing nitrogen, without flux. In the case of test sample a) a fair to good bond was obtained, with some surface oxidation. Test sample b) showed a poor braze quality, and weak bond strength. Test sample c) showed excellent braze response, and the highest bond strength of this test series.

### Example 52

An AA3003 coupon was zincated [Ref p2] and then electroplated for 3 minutes with Zinc, using a zinc sulfate bath [Ref P3]; a short length of untreated AA3003 tube was placed on the coupon (ring on plate configuration) and subjected to a fluxless braze cycle at 1120 F., in flowing nitrogen. No braze was obtained, and the zinc plated surface was oxidized [Sample 0-1]. A second identical coupon was prepared, however after Zinc plating, this coupon was also Ni—Pb plated for 2 minutes [Ref P1]. Brazing at 1120 .F resulted in a good braze.[Sample FL 21-1]. A third identical sample was prepared, except that #12 brazing sheet (clad with AA4343 Al—Si alloy) was used as the substrate material. Again, the zinc plated coupon was plated with Ni—Pb, and again a good braze was obtained under the same conditions without the use of a flux.[Sample FL 21-2].

### Example 53

An identically zincated and zinc-plated coupon (as in the first test in Example 52) was next used to braze to an untreated AA3003 tube, however in this instance a zinc shim, smaller in size than the coupon face, and plated both sides with Ni—Pb (Ref P1) was inserted between the coupon face and the tube end. A fluxless brazing test was then run at 430 C. In comparison to the first test in Example 14, the zinc shim was observed to melt and initiate wetting of the coupon surface, and also to form fillets at the tube/coupon interface. [Sample 1]

### Example 54

In the same fashion as example 15, an AA3003 coupon was zincated, plated for 2-4 minutes with Ni—Pb [Ref P1]; and then assembled against an untreated cut AA3003 tube, with an intermediate untreated zinc shim. A fluxless braze test was run at 430 C. In comparison to Example 20, the zinc shim melted and showed excellent wetting on the Ni-plated coupon, and good but discontinuous fillets against the tube wall. A repeat test run exactly the same way, except with the coupon plated for only 1 minute, and the AA3003 tube also 1 minute Ni—Pb plated, resulted in complete wetting and filleting of both the coupon and tube surfaces. [Samples 29/30, and 31].

### Example 55

Example 54 was repeated using an AA4343 clad #12 brazing sheet coupon, Ni—Pb plated for 2 minutes, with the Zinc shim also plated with Ni—Pb for 2 minutes, but with the AA3003 tube untreated. Fluxless brazing at 430 C. resulted in complete melting of the shim, very good wetting of the coupon face, and large although somewhat discontinuous braze fillets against the tube wall. [Sample IV-C]

### Example 56

An AA3003 coupon was prepared by zincating [Ref P2], followed by deposition of a 10 sec Cu electroplated barrier coating [Ref P4]. A Zinc shim Ni—Pb plated for 2 minutes was placed between the prepared 3003 coupon, and an untreated 3003 tube, and fluxless brazed in nitrogen at 430 C. The zinc shim melted and wet the copper plated coupon surface, and a continuous fillet was formed against the untreated tube.[Sample FL1119]

### Example 57

An AA3003 coupon was prepared by zincating, 2 minute Ni—Pb plating [Ref P1], Copper plating [20 sec]; a zinc shim was 2 minute Ni—Pb plated on both sides, and place between the prepared coupon and untreated 3003 tube. This assembly was fluxless brazed at 480 C. in nitrogen. Excellent wetting of the coupon, and complete braze fillets against the tube wall, resulted.[Sample FL 1120]

### Example 58

An AA3003 coupon was zincated, and the following sequence of electroplated coatings applied: 1 minute Ni—Pb flash plating, 12 minutes of Zinc electroplating [Ref P3], 1 minute plating of Ni—Pb, and finally 10 sec copper plating [Ref P4 ]. This coupon was assembled against an untreated AA3003 tube, with no additional filler metal supplied, and fluxless brazed at 480 C. The zinc, copper and nickel were found to completely inter-alloy and melt, to create a well-wetted coupon surface, but only fair fillets against the tube wall.[Sample ZnCuO2]

References:

[P1]—Ni—Pb plating bath

70 g/l NiSO4.6H2O

30 g/l NiCl2. 6H2O

Z120 g/l sodium citrate dihydrate

50 g/l NH4Cl

20 g/l sodium acetate trihydrate

30 ml NH4OH(29% solution)

1 g/l lead acetate trihydrate

pH˜8.2

Temperature 35° c.

[P2]—Zincate

120 g/l NaOH

20 g/l ZnO

50 g/l Rochelle Salt

2 g/l FeCl3.6H2O

1 g/l NaNO3

Ambient Temperature

[P3]—Zinc Sulfate plating bath

360 g/l ZnSO4.6H2O

30 g/l NH4Cl

15 g/l sodium acetate trihydrate

pH˜5

Ambient Temperature

[P4]—Copper Sulfate plating bath

200 g/l cuso4.5h2o

50 g/l H2SO4

100 ppm Cl—as CuCl2

Ambient Temperature

Zinc shims were 100% Zinc, 0.38 mm thick.

### Example 59

This relates to low temperature fluxless brazing of A413.1 aluminum die-castings. Type A 413.1 die castings were obtained from US Reduction Co., these are a eutectic composition, and so are not brazeable by normal Al—Si filler metals. The received castings were machined into elongated test pieces, which were then overlapped to form braze joints. The cast pieces were treated after machining by immersion caustic etch, acid desmutting and rinsing; and were preferably immediately plated with Ni—Pb [Ref P1]. The filler metal was provided as zinc (0.023″) and zinc-2% aluminum (0.015″) shimstock. The Zinc or Zinc alloy filler metal was plated with Ni—Pb, and used for test brazing of the die-castings at 900 and 950 F. Braze quality was evaluated visually and by metallographic examination. Braze quality was found to be excellent using the Ni—Pb plated zinc filler metal, and good using the plated Zn 2% Al alloy. Brazing at 900 F. resulted in decreased porosity in the braze joints vs 950 F.; porosity from dissolved gases in die castings traditionally restricts the brazeability of these materials, and the demonstrated ability to fluxless braze these castings at temperatures at 900 F. or lower is a significant benefit.

Finally, it is to be understood that while a limited number of preferred embodiments, in the nature of articles of manufacture, have been herein shown and described, many variants in, inter alia, size and shape of parts may be made within departing from the spirit or scope of the invention. Similarly, while it is to be understood that while but nine embodiments of the plating baths of the present invention have been herein shown and described, many variants in, inter alia, process characteristics may be made without departing from the spirit or scope of the invention. As well, while the disclosure is directed primarily to heat exchanger construction, it will be evident that the teachings of the present invention have broader application, and may be usefully practised, for example, in the construction of many structures and devices. Accordingly, the scope of the invention is limited only by the claims appended hereto, purposively construed.

1. An aluminium brazing product comprising: a base substrate (1) of an aluminium alloy comprising silicon in an amount in the range of 2 to 18% by weight, a layer (2) comprising nickel on at least one outer surface of the base substrate (1), and a separately deposited layer (3) on one side of said layer (2) comprising nickel, said separately deposited layer (3) comprising a metal such that taken together said aluminium base substrate (1) and all layers of said aluminium brazing product exterior to said aluminium base substrate (1) form a metal filler having a liquidus temperature in the range of 490 to 570° C.

2. An aluminium brazing product according to claim 1, wherein the aluminium base substrate (1) is selected from a member of the group consisting of an aluminium alloy sheet, an aluminium alloy wire, and an aluminium alloy rod.

3. An aluminium brazing product according to claim 1, wherein the aluminium base substrate is made of an AA4000-series aluminium alloy.

4. An aluminium brazing product according to claim 1, wherein said separately deposited layer (3) is between said substrate (1) and said layer (2) comprising nickel.

5. An aluminium brazing product according to claim 1, wherein said separately deposited layer (3) comprises copper or copper-based alloy.

6. An aluminium brazing product according to claim 5, wherein said separately deposited layer (3) comprises at least 60% by weight copper.

7. An aluminium brazing product according to claim 1, wherein said separately deposited layer (3) has a thickness of not more than 10 micron.

8. An aluminium brazing product according to claim 1, wherein said aluminium base substrate (1) further comprises magnesium in a range of at most 8%.

9. An aluminium brazing product according to claim 1, wherein said layer (2) comprising nickel further comprises bismuth in a range of at most 5% by weight.

10. An aluminium brazing product according to claim 1, wherein said layer (2) comprising nickel is essentially lead-free.

11. An aluminium brazing product according to claim 1, wherein said layer (2) comprising nickel has a thickness of not more than 2 micron.

12. An aluminium brazing product according to claim 1, wherein said layer (2) comprising nickel is applied by means of electroplating.

13. An aluminium brazing product according to claim 1, further comprising a layer (5) comprising zinc or tin as a bonding layer between said outer surface of said aluminium base substrate (1) and said layer comprising nickel (2).

14. An aluminium brazing product according to claim 13, wherein said bonding layer (5) has a thickness of not more than 1 micron.

15. An aluminium brazing product according to claim 1, wherein taken together said aluminium base substrate and all layers exterior thereto, have a composition comprising at least, by weight percent: Si in the range of 5 to 10%, Cu in the range of 12 to 25%, Bi in the range of at most 0.25%, Ni in the range of 0.05 to 4%, Zn in the range of at most 20%, Sn in the range of at most 5%, Mg in the range of at most 5%, balance aluminium and impurities.

16. An aluminium brazing product according to claim 1, wherein taken together said aluminium base substrate and all layers exterior thereto, have a composition comprising at least, by weight percent: Si in the range of 7 to 10%, Cu in the range of 12 to 25%, Bi in the range of at most 0.25%, Ni in the range of 0.05 to 4%, Zn in the range of at most 0.25%, balance aluminium and impurities.

17. An aluminium brazing product according to claim 1, wherein taken together said aluminium base substrate and all layers exterior thereto, have a composition comprising at least, by weight percent: Si in the range of 7 to 10%, Cu in the range of 12 to 18%, Bi in the range of at most 0.25%, Ni in the range of 0.05 to 3%, Zn in the range of at most 0.15%, balance aluminium and impurities.

18. An aluminium brazing product according to claim 1, wherein taken together said aluminium base substrate (1) and all layers exterior to said aluminium base substrate (1) form said metal filler and said metal filler liquidus temperature is in the range of 510 to 550° C.

19. An aluminium brazing product according to claim 1, wherein said aluminium base substrate (1) contacts said layer (2) comprising nickel.

20. An aluminium brazing product according to claim 1, wherein said layer (2) comprising nickel has a thickness of not more than 1.0 micron.

21. An aluminium brazing product according to claim 13, wherein said bonding layer (5) has a thickness of not more than 0.3 micron.

22. An aluminium brazing product according to claim 1, wherein the aluminium base substrate comprises, in weight percent:
8 Si 2 to 18 Mg at most 8 Zn at most 5.0 Cu at most 5.0 Mn at most 0.5 In at most 0.3 Fe at most 0.8 Sr at most 0.2
optionally one or more elements selected from the group consisting of:
9 Bi 0.01 to 1.0 Pb 0.01 to 1.0 Li 0.01 to 1.0 Sb 0.01 to 1.0
impurities each of at most 0.05, total at most 0.20 balance aluminium.

23. An aluminium brazing product according to claim 1, wherein the aluminium base substrate comprises, in weight percent:
10 Si 5 to 14 Mg at most 5 Zn at most 5.0 Cu at most 5.0 Mn at most 0.5 In at most 0.3 Fe at most 0.8 Sr at most 0.2
optionally one or more elements selected from the group consisting of:
11 Bi 0.01 to 1.0 Pb 0.01 to 1.0 Li 0.01 to 1.0 Sb 0.01 to 1.0
impurities each of at most 0.05, total at most 0.20 balance aluminium.

24. An aluminium brazing sheet comprising: said aluminium brazing product according to claim 1 and a core sheet (4) made of an aluminium alloy, wherein on at least one surface of said core sheet (4) is coupled the aluminium brazing product, said aluminium base substrate (1) being an aluminium clad layer, and said aluminium substrate (1) being made of said aluminium alloy comprising silicon in the amount in the range of 2 to 18% by weight, said layer (2) comprising nickel being on an outer surface of said aluminium clad layer, said clad layer (1) being between said core sheet (4) and said layer (2) comprising nickel, said separately deposited layer (3) being on one side of said layer (2) comprising nickel, and said separately deposited layer (3) comprising said metal such that taken together said aluminium clad layer (1) and all layers of the aluminium brazing product exterior to the aluminium clad layer (1) form a metal filler having a liquidus temperature in the range of 490 to 570° C.

25. An aluminium brazing sheet according to claim 24, wherein said separately deposited layer (3) comprises copper or copper-based alloy.

26. An aluminium brazing sheet according to claim 24, wherein said separately deposited layer (3) comprises at least 60% by weight copper.

27. An aluminium brazing sheet according to claim 24, wherein said separately deposited layer (3) has a thickness of not more than 10 micron.

28. An aluminium brazing sheet according to claim 24, wherein said aluminium base substrate (1) further comprises magnesium in a range of at most 8%.

29. An aluminium brazing sheet according to claim 24, wherein said layer (2) comprising nickel further comprises bismuth in a range at most 5% by weight.

30. An aluminium brazing sheet according to claim 24, wherein said layer (2) comprising nickel is essentially lead-free.

31. An aluminium brazing sheet according to claim 24, wherein said layer (2) comprising nickel has a thickness of not more than 2 micron.

32. An aluminium brazing sheet according to claim 24, wherein said layer (2) comprising nickel is applied by means of electroplating.

33. An aluminium brazing sheet according to claim 24, further comprising a layer (5) comprising zinc or tin as a bonding layer between said outer surface of said aluminium base substrate (1) and said layer comprising nickel (2).

34. An aluminium brazing sheet according to claim 33, wherein said bonding layer (5) has a thickness of not more than 0.5 micron.

35. An aluminium brazing sheet according to claim 24, wherein taken together said aluminium base substrate and all layers exterior thereto, have a composition comprising at least, by weight percent: Si in the range of 5 to 10%, Cu in the range of 12 to 25%, Bi in the range of at most 0.25%, Ni in the range of 0.05 to 4%, Zn in the range of at most 20%, Sn in the range of at most 5%, Mg in the range of at most 5%, balance aluminium and impurities.

36. An aluminium brazing sheet according to claim 24, wherein taken together said aluminium base substrate and all layers exterior thereto, have a composition comprising at least, by weight percent: Si in the range of 7 to 10%, Cu in the range of 12 to 25%, Bi in the range of at most 0.25%, Ni in the range of 0.05 to 4%, Zn in the range of at most 0.25%, balance aluminium and impurities.

37. An aluminium brazing sheet according to claim 24, wherein taken together said aluminium base substrate and all layers exterior thereto, have a composition comprising at least, by weight percent: Si in the range of 7 to 10%, Cu in the range of 12 to 18%, Bi in the range of at most 0.25%, Ni in the range of 0.05 to 3%, Zn in the range of at most 0.15%, balance aluminium and impurities.

38. An aluminium brazing sheet according to claim 24, wherein taken together said aluminium base substrate (1) and all layers exterior to said aluminium base substrate (1) form said metal filler and said metal filler liquidus temperature is in the range of 510 to 550° C.

39. An aluminium brazing sheet according to claim 24, wherein said aluminium base substrate (1) contacts said layer (2) comprising nickel.

40. An aluminium brazing sheet according to claim 24, wherein said layer (2) comprising nickel has a thickness of not more than 1.0 micron.

41. An aluminium brazing product according to claim 33, wherein said bonding layer (5) has a thickness of not more than 0.3 micron.

42. An aluminium brazing sheet according to claim 24, wherein the aluminium clad layer of the brazing sheet product comprises, in weight percent:
12 Si 2 to 18 Mg of at most 8 Zn of at most 5.0 Cu of at most 5.0 Mn of at most 0.5 In of at most 0.3 Fe of at most 0.8 Sr of at most 0.2
optionally one or more elements selected from the group consisting of:
13 Bi 0.01 to 1.0 Pb 0.01 to 1.0 Li 0.01 to 1.0 Sb 0.01 to 1.0
impurities each of at most 0.05, total of at most 0.20 balance aluminium.

43. An aluminium brazing sheet according to claim 24, wherein the aluminium clad layer of the brazing sheet product comprises, in weight percent:
14 Si 5 to 14 Mg of at most 5 Zn of at most 5.0 Cu of at most 5.0 Mn of at most 0.5 In of at most 0.3 Fe of at most 0.8 Sr of at most 0.2
optionally one or more elements selected from the group consisting of:
15 Bi 0.01 to 1.0 Pb 0.01 to 1.0 Li 0.01 to 1.0 Sb 0.01 to 1.0
impurities each of at most 0.05, total of at most 0.20 balance aluminium.

44. A method of manufacturing the aluminium brazing product according to claim 1, comprising depositing said layer (2) comprising nickel by electroplating both nickel and bismuth using an aqueous bath comprising a nickel-ion concentration in a range of 10 to 100 g/l and a bismuth-ion concentration in the range of 0.01 to 10 g/l.

45. A method according to claim 44, wherein said layer (2) comprising nickel is deposited by plating both nickel and bismuth using an aqueous bath having a pH in the range of 2.5 to 10, and comprising: a nickel-ion concentration in a range of 10 to 100 g/l, a bismuth-ion concentration in the range of 0.01 to 10 g/l, a citrate-ion concentration in the range of 40 to 150 g/l, a gluconate-ion concentration in the range of 2 to 80 g/l, and a chloride- or fluoride-ion concentration in the range of 1 to 50 g/l.

46. Method according to claim 44, wherein said separately deposited layer (3) is applied by means of electroplating.

47. Method according to claim 46, wherein said separately deposited layer (3) comprising copper or copper-based alloy is deposited by electroplating using an alkaline cyanide plating bath.

48. A method of manufacturing the brazing product according to claim 13, comprising applying said bonding layer (5) comprising zinc or tin by a zincate treatment or a stannate treatment.

49. A method according to claim 48, wherein said separately deposited layer (3) is applied by means of electroplating.

50. A method according to claim 49, wherein said separately deposited layer (3) comprising copper or copper-based alloy is deposited by electroplating using an alkaline cyanide plating bath.

51. A method of manufacturing the aluminium brazing sheet according to claim 24, comprising depositing said layer (2) comprising nickel by electroplating both nickel and bismuth using an aqueous bath comprising a nickel-ion concentration in a range of 10 to 100 g/l and a bismuth-ion concentration in the range of 0.01 to 10 g/l.

52. A method according to claim 51, wherein said layer (2) comprising nickel is deposited by plating both nickel and bismuth using an aqueous bath having a pH in the range of 2.5 to 10, and comprising: a nickel-ion concentration in a range of 10 to 100 g/l, a bismuth-ion concentration in the range of 0.01 to 10 g/l, a citrate-ion concentration in the range of 40 to 150 g/l, a gluconate-ion concentration in the range of 2 to 80 g/l, and a chloride- or fluoride-ion concentration in the range of 1 to 50 g/l.

53. Method according to claim 52, wherein said separately deposited layer (3) is applied by means of electroplating.

54. Method according to claim 53, wherein said separately deposited layer (3) comprising copper or copper-based alloy is deposited by electroplating using an alkaline cyanide plating bath.

55. A method of manufacturing the brazing sheet according to claim 33, comprising applying said bonding layer (5) comprising zinc or tin by a zincate treatment or a stannate treatment.

56. A method according to claim 55, wherein said separately deposited layer (3) is applied by means of electroplating.

57. A method according to claim 56, wherein said separately deposited layer (3) comprising copper or copper-based alloy is deposited by electroplating using an alkaline cyanide plating bath.

58. A method of manufacturing an assembly of brazed components, comprising the steps of: (a) shaping parts of which at least one is made from said brazing sheet according to claim 24; (b) assembling the parts into the assembly; (c) brazing the assembly under a vacuum or in an inert atmosphere in the absence of a brazing-flux at elevated temperature for a period long enough for melting and spreading of the molten filler; (d) cooling the brazed assembly.

59. A method of manufacturing the assembly of brazed components of claim 58, wherein in step (a) at least one of the parts to be brazed is made of said brazing sheet, and at least one other part is selected from the group consisting of titanium, plated or coated titanium, bronze, brass, stainless steel, plated or coated stainless steel, nickel, nickel-alloy, low-carbon steel, plated or coated low-carbon steel, high-strength steel, and plated or coated high-strength steel.

60. A method of manufacturing an assembly of brazed components, comprising the steps of: (a) shaping parts of which at least one is made from brazing sheet obtained by the method according to claim 51; (b) assembling the parts into the assembly; (c) brazing the assembly under a vacuum or in an inert atmosphere in the absence of a brazing-flux at elevated temperature for a period long enough for melting and spreading of the molten filler; (d) cooling the brazed assembly.

61. A method of manufacturing the assembly of brazed components of claim 60, wherein in step (a) at least one of the parts to be joined by brazing is made of said brazing sheet, and at least one other part is selected from the group consisting of titanium, plated or coated titanium, bronze, brass, stainless steel, plated or coated stainless steel, nickel, nickel-alloy, low-carbon steel, plated or coated low-carbon steel, high-strength steel, and plated or coated high-strength steel.

62. A method of manufacturing an assembly of brazed components, comprising the steps of: (a) shaping parts of which at least one is made from brazing sheet obtained by the method according to claim 55; (b) assembling the parts into the assembly; (c) brazing the assembly under a vacuum or in an inert atmosphere in the absence of a brazing-flux at elevated temperature for a period long enough for melting and spreading of the molten filler; (d) cooling the brazed assembly.

63. A method of manufacturing the brazed assembly of claim 62, wherein in step (a) at least one of the parts to be brazed is made of said brazing sheet, and at least one other part is selected from the group consisting of titanium, plated or coated titanium, bronze, brass, stainless steel, plated or coated stainless steel, nickel, nickel-alloy, low-carbon steel, plated or coated low-carbon steel, high-strength steel, and plated or coated high-strength steel.

64. A brazed assembly manufactured in accordance with claim 58.

65. A brazed assembly of claim 64, wherein said brazed assembly is a heat-exchanger.

66. A brazed assembly of claim 64, wherein said brazed assembly is an electrochemical fuel cell.

67. A brazed assembly manufactured in accordance with claim 60.

68. A brazed assembly manufactured in accordance with claim 62.

69. A brazed assembly comprising a brazing sheet of claim 24 brazed to a metal part.

70. A method of joining two structural elements comprising contacting the two structural elements, welding together the two structural elements in a welding operation to form a weld joint, and melting aluminium brazing product according to claim 1 in the form of an aluminium alloy wire or an aluminium alloy rod as filler metal at the weld joint during the welding operation.

71. A rigid composite metal panel comprising at least two parallel metal members, selected from the group consisting of metal plate and metal sheet, secured to the peaks and troughs of a corrugated aluminium stiffener sheet arranged between said parallel metal members, wherein the corrugated aluminium stiffener sheet is made from an aluminium brazing sheet product comprising a core sheet made of an aluminium alloy having on at least one surface of said core sheet clad an aluminium alloy clad layer, the aluminium alloy clad layer being made of an aluminium alloy comprising silicon in an amount in the range of 2 to 18% by weight, and a layer comprising nickel on an outer surface of said aluminium alloy clad layer, wherein the corrugated aluminium stiffener sheet is made from said aluminium brazing sheet product and said aluminium brazing sheet product comprises: said core sheet made of said aluminium alloy having on at least one surface of said core sheet clad said aluminium alloy clad layer, said aluminium alloy clad layer being made of said aluminium alloy comprising silicon in an amount in the range of 2 to 18% by weight, said layer comprising nickel on the outer surface of said aluminium alloy clad layer, and a separately deposited metal layer on one side of said layer comprising nickel, wherein said separately deposited metal layer comprises a metal such that taken together said aluminium alloy clad layer and all layers of the aluminium brazing sheet product exterior thereto form a metal filler having a liquidus temperature in the range of 490 to 570° C.

72. A composite metal panel according to claim 71, wherein said layer comprises copper or copper-based alloy.

73. A composite metal panel according to claim 72, wherein said layer comprises at least 60% by weight copper.

74. A composite metal panel according to claim 71, wherein said layer has a thickness of not more than 10 micron.

75. A composite metal panel according to claim 71, wherein both sides of said core sheet are respectively clad by the aluminium alloy clad layer and the layer comprising nickel on the outer surface of said aluminium alloy clad layer.

76. A composite metal panel according to claim 71, wherein the aluminium alloy of the aluminium alloy clad layer comprises silicon in an amount in the range of 5 to 14% by weight.

77. A composite metal panel according to claim 71, wherein said separately deposited metal layer comprises a metal such that taken together said aluminium alloy clad layer and all layers of the aluminium brazing sheet product exterior thereto form a metal filler having a liquidus temperature in the range of 510 to 550° C.

78. A method of manufacturing a rigid composite metal panel, comprising the steps of: (a) providing parts, the parts comprising at least two parallel metal members selected from the group consisting of metal plate and metal sheet, and a corrugated aluminium stiffener sheet, wherein the corrugated aluminium stiffener sheet is made from an aluminium brazing sheet product comprising a core sheet made of an aluminium alloy having on at least one surface of said core sheet clad an aluminium alloy clad layer, the aluminium alloy clad layer being made of an aluminium alloy comprising silicon in an amount in the range of 2 to 18% by weight, and a layer comprising nickel on an outer surface of said aluminium alloy clad layer; (b) assembling the parts into an assembly such that the aluminium stiffener sheet is arranged between the parallel metal members; (c) joining the assembly into a rigid composite metal panel by heating the assembly under a vacuum or in an inert atmosphere in the absence of a brazing-flux material at elevated temperature of less than 600° C. for a period long enough for melting and spreading of the molten filler to form a joint between each parallel metal member and the corrugated aluminium stiffener sheet; (d) cooling of the joined composite metal panel.

79. A method of manufacturing a rigid composite metal panel, comprising the steps of: (a) providing parts, the parts comprising at least two parallel metal members selected from the group consisting of metal plate and metal sheet, and an aluminium stiffener sheet having a honeycomb structure arranged between said parallel metal members, wherein the aluminium stiffener sheet is made from an aluminium brazing sheet product comprising a core sheet made of an aluminium alloy having on at least one surface of said core sheet clad an aluminium alloy clad layer, the aluminium alloy clad layer being made of an aluminium alloy comprising silicon in an amount in the range of 2 to 18% by weight and a layer comprising nickel on an outer surface of said aluminium alloy clad layer; (b) assembling the parts into an assembly such that the aluminium stiffener sheet is arranged between the parallel metal members; (c) joining the assembly into a rigid composite metal panel by heating the assembly under a vacuum or in an inert atmosphere in the absence of a brazing-flux material at elevated temperature of less than 600° C. for a period long enough for melting and spreading of the molten filler to form a joint between each parallel metal member and the corrugated aluminium stiffener sheet; (d) cooling of the joined composite metal panel.

80. A method of manufacturing a rigid composite metal panel, comprising the steps of: (a) providing parts, the parts comprising at least two parallel metal members selected from the group consisting of metal plate and metal sheet, and a corrugated aluminium stiffener sheet, wherein the corrugated aluminium stiffener sheet is made from an aluminium brazing sheet product and said aluminium brazing sheet product comprises: a core sheet made of an aluminium alloy having on at least one surface of said core sheet clad an aluminium alloy clad layer, said aluminium alloy clad layer being made of an aluminium alloy comprising silicon in an amount in the range of 2 to 18% by weight, a layer comprising nickel on an outer surface of said aluminium alloy clad layer, and a separately deposited metal layer on one side of said layer comprising nickel, wherein said separately deposited metal layer comprises a metal such that taken together said aluminium alloy clad layer and all layers of the aluminium brazing sheet product exterior thereto form a metal filler having a liquidus temperature in the range of 490 to 570° C.; (b) assembling the parts into an assembly such that the aluminium stiffener sheet is arranged between the parallel metal members; (c) joining the assembly into a rigid composite metal panel by heating the assembly under a vacuum or in an inert atmosphere in the absence of a brazing-flux material at elevated temperature of less than 600° C. for a period long enough for melting and spreading of the molten filler to form a joint between each parallel metal member and the corrugated aluminium stiffener sheet; (d) cooling of the joined composite metal panel.

81. Method of manufacturing an aluminium or aluminium alloy joined product, comprising the sequential steps of: (a) providing two parts made of aluminium or aluminium alloy, each part having a peripheral flange; (b) positioning the two parts such that the peripheral flange of one part faces the peripheral flange of the other part to form an assembly, and then joining the facing flanges of the two parts by heating, wherein, during step (b) the faces of the peripheral flanges of the two parts are coupled to each other via a separate aluminium joining product having a base substrate of an aluminium alloy comprising silicon in an amount in the range of 2 to 18% by weight, and on the outer surface of said base a deposited layer comprising nickel and a further separately deposited layer on one side of the layer comprising nickel, and the separately deposited layer comprising a metal such that taken together the aluminium base substrate and all layers exterior thereto form a metal filler having a liquidus temperature in the range of 400 to 570° C.

82. Method according to claim 81, wherein during step (b) the heating is applied locally by heating at elevated temperature for a period long enough for melting and spreading of the molten filler to form a joint between the facing flanges of the two facing parts.

83. Method according to claim 82, wherein during step (b) the local heating is applied by means of a welding operation.

84. Method according to claim 83, wherein during step (b) the local heating is applied by means of a seam welding operation.

85. Method according to claim 82, wherein during step (b) the local heating is applied by means of a brazing operation.

86. Method according to claim 85, wherein during step (b) the local heating is applied by means of a fluxless CAB brazing operation.

87. Method according to claim 81, wherein said further deposited metal layer comprises at least 60% by weight copper.

88. Method according to claim 81, wherein taken together said aluminium base substrate and all layers exterior thereto, have a composition comprising, in weight percent: Si in a range of 7 to 11%, Cu in a range of 12 to 25%, Bi in a range up to 0.25%, Ni in a range of 0.5 to 4%, Mg in a range up to 4%, Sn in a range up to 8%, Zn in a range up to 20%, Fe in a range up to 0.8%, impurities each<0.05%, total<0.25%, balance aluminium.

89. Method according to claim 81, wherein taken together said aluminium base substrate and all layers exterior thereto, have a composition comprising, in weight percent: Si in a range of 7 to 11%, Cu in a range of 12 to 18%, Bi in a range up to 0.25%, Ni in a range of 0.5 to 4%, Mg in a range up to 4%, Sn in a range up to 8%, Zn in a range up to 20%, Fe in a range up to 0.8%, impurities each<0.05%, total<0.25%, balance aluminium.

90. Method according to claim 81, wherein the aluminium alloy joined product is a shaped and hollow member.

91. A joined aluminium product manufactured from a method according to claim 81, wherein the aluminium alloy is selected from the group consisting of AA2000, AA3000, AA5000, M6000, and AA7000-series aluminium alloys.

92. Product according to claim 91, wherein the aluminium alloy joined product is a shaped and hollow member.

93. A fluid or gas container manufactured from a method according to claim 81.

94. A fuel tank manufactured from a method according to claim 81.

95. A brazing product having an aluminium layer (1) made of an aluminium alloy comprising silicon in an amount in the range of 2 to 18% by weight, and a layer (2) comprising nickel on the outer surface of said aluminium layer (1), wherein taken together said aluminium layer (1) and all layers exterior thereto form the filler metal for a brazing operation, wherein the filler metal has a composition containing at least one element having an electro-chemical potential such that the electro-chemical potential difference between Ni-aluminides particles and the aluminium alloy matrix of the filler composition is reduced relative to an aluminium alloy matrix from a composition which is the same as the filler composition except for lacking said at least one element, and wherein the mol-ratio of Ni to the total of said at least one element is in the range of 10:(0.3 to 30), wherein there is provided a separately applied layer (4) comprising copper in an amount such that in the filler metal the mol-ratio of Ni:Cu is in the range of 10:(0.5 to 9).

96. A brazing product according to claim 95, wherein the separately applied layer (4) is a plated layer or a thermal sprayed layer.
